(19) United States
(12) Patent Application Publication
(10) Pub. No.: US 2026/0031938 A1
(43) Pub. Date: Jan. 29, 2026

(54) REFERENCE-SIGNAL (RS) CONFIGURATIONS FOR WIDEBAND FREQUENCY-HOPPING REDUCED CAPABILITY (REDCAP) TRANSMITTERS AND RECEIVERS

(71) Applicant: Huawei Technologies Co., Ltd., Shenzhen (CN)

(72) Inventors: Anthony Lo, Schaumburg, IL (US); Vipul Desai, Palatine, IL (US); Brian Classon, St. Pete Beach, FL (US)

(21) Appl. No.: 19/345,526

(22) Filed: Sep. 30, 2025

Related U.S. Application Data
(63) Continuation of application No. PCT/US2024/022469, filed on Apr. 1, 2024.
(60) Provisional application No. 63/494,690, filed on Apr. 6, 2023.
(60) Provisional application No. 63/518,723, filed on Aug. 10, 2023.

(51) Int. Cl. H04L 5/00; H04W 72/51

(52) U.S. Cl. CPC H04L 5/001; H04L 5/0051; H04W 72/51

(57) ABSTRACT

A method for wireless communications includes receiving a configuration for frequency-hopping outside of an active bandwidth part of a user equipment (UE) of reduced capability (RedCap) UE type, wherein the configuration comprises an indication of a number of frequency hops within a bandwidth for positioning, timing information associated with the frequency hops, and frequency information associated with the frequency hops; and transmitting, based on the configuration, a plurality of reference signal transmissions, each at a frequency location and a time location of a respective one of the frequency hops and spanning a frequency less than or equal to the active bandwidth part.

### CROSS-REFERENCE TO RELATED APPLICATIONS

This patent application is a continuation of International Patent Application No. PCT/US2024/022469, filed on Apr. 1, 2024 which claims the benefit of U.S. Provisional Patent Application No. 63/494,690, filed on Apr. 6, 2023, U.S. Provisional Patent Application No. 63/518,723, filed on Aug. 10, 2023, all of which are hereby incorporated by reference in their entireties.

### TECHNICAL FIELD

The present disclosure is generally related to methods and apparatus for wireless communications, and, in particular embodiments, to reference-signal (RS) configurations for wideband frequency-hopping reduced capability (RedCap) transmitters and receivers.

### BACKGROUND

A reduced capability (RedCap) device is a fifth generation (5G) New-Radio (NR) User Equipment (UE), which was introduced in 3rd Generation Partnership Project (3GPP) Release 17 to support emerging use cases such as industrial wireless sensors and video surveillance. In comparison with non-RedCap 5G devices, RedCap devices may support a narrower bandwidth and a fewer number of transceivers. In addition, for full duplex bands, with an optional capability, a RedCap device is not required to receive in the downlink frequency while transmitting in the uplink frequency, and vice versa, resulting in Half-Duplex Frequency-Division Duplexing (HD-FDD) operations.

### SUMMARY

The disclosed aspects/embodiments provide techniques for configuring a reduced capability (RedCap) user equipment (UE) (e.g., supporting a reduced maximum bandwidth) to frequency-hop outside of an active bandwidth part (BWP) of the RedCap UE for wideband positioning. The configuration may include a hopping configuration for frequency-hopping across a wideband (e.g., having a bandwidth wider than the maximum bandwidth supported by the RedCap UE) for positioning, a sounding reference signal (SRS) resource configuration for SRS transmissions, and a positioning reference signal (PRS) measurement gap configuration for PRS measurements. Configuring the RedCap UE to frequency-hop outside of the active BWP and across the wideband can improve positioning accuracy without increasing the cost and complexity of the RedCap UE.

A first aspect relates to a method for wireless communications, the method comprising receiving a configuration for frequency-hopping outside of an active bandwidth part of a user equipment (UE) of reduced capability (RedCap) UE type, wherein the configuration comprises an indication of a number of frequency hops within a bandwidth for positioning, timing information associated with the frequency hops, and frequency information associated with the frequency hops; and transmitting, based on the configuration, a plurality of reference signal transmissions, each at a frequency location and a time location of a respective one of the frequency hops and spanning a frequency less than or equal to the active bandwidth part.

Optionally, in any of the preceding aspects, another implementation of the aspect provides receiving an indication of a reference signal resource to be used for the plurality of reference signal transmissions, wherein a frequency span of the reference signal resource spans: a bandwidth of an individual frequency hop of the frequency hops, or the bandwidth for positioning.

Optionally, in any of the preceding aspects, another implementation of the aspect provides that the configuration comprises at least one of an indication of a common hop bandwidth for each of the frequency hops; an index to a lookup table (LUT) having a plurality of entries, each indicating a number of physical resource blocks in a hop bandwidth of an individual frequency hop based on a respective one of a plurality of subcarrier spacings and a respective one of a plurality of channel bandwidths; an indication of a starting physical resource block for an earliest frequency hop of the frequency hops in time; or an indication of a number of overlapping resource blocks between adjacent frequency hops of the frequency hops.

Optionally, in any of the preceding aspects, another implementation of the aspect provides that the configuration comprises an indication of a starting slot offset and a starting symbol for an earliest frequency hop of the frequency hops in time; and a number of orthogonal frequency-division multiplexing (OFDM) symbols for an individual frequency hop of the frequency hops.

Optionally, in any of the preceding aspects, another implementation of the aspect provides that a frequency location of a current frequency hop of the frequency hops is higher than a frequency location of a previous adjacent frequency hop of the frequency hops in time.

Optionally, in any of the preceding aspects, another implementation of the aspect provides that a frequency location of a highest-frequency frequency hop of the frequency hops is adjacent and prior, in time, to a lowest-frequency frequency hop of the frequency hops.

Optionally, in any of the preceding aspects, another implementation of the aspect provides receiving a configuration for a time window, wherein a duration of the time window is based on an individual reference signal transmission and the number of frequency hops within the bandwidth for positioning, wherein the plurality of reference signal transmissions are transmitted within the duration of the time window.

A second aspect relates to a method for wireless communications, the method comprising receiving a configuration for a measurement gap, wherein a duration of the measurement gap is based on a duration of an individual reference signal transmission and a number of frequency hops spanning a frequency corresponding to a bandwidth for positioning, and wherein the measurement gap is configured for a user equipment (UE) of reduced capability (RedCap) UE type; receiving, within the duration of the measurement gap, a plurality of reference signal transmissions based on the duration of the individual reference signal transmission and the number of hops, wherein each of the plurality of reference signal transmissions is received at a respective one of the frequency hops; and transmitting, based on the plurality of reference signal transmissions, a measurement report.

Optionally, in any of the preceding aspects, another implementation of the aspect provides that the receiving the plurality of reference signal transmissions comprises receiving a positioning reference signal (PRS) at a frequency location of a respective one of the frequency hops.

Optionally, in any of the preceding aspects, another implementation of the aspect provides receiving a hopping configuration indicating information associated with frequency locations of the frequency hops.

Optionally, in any of the preceding aspects, another implementation of the aspect provides that the hopping configuration comprises at least one of an indication of a common hop bandwidth for each of the frequency hops; an index to a lookup table (LUT) having a plurality of entries, each indicating a number of resource blocks in a hop bandwidth of an individual frequency hop based on a respective one of a plurality of subcarrier spacings and a respective one of a plurality of channel bandwidths; an indication of a number of overlapping resource blocks between adjacent frequency hops of the frequency hops; or an indication of the number of frequency hops within the bandwidth for positioning.

A third aspect relates to a method for wireless communications, the method comprising transmitting a configuration for frequency-hopping outside of an active bandwidth part of a user equipment (UE) of reduced capability (RedCap) UE type, wherein the configuration comprises an indication of a number of frequency hops within a bandwidth for positioning, timing information associated with the frequency hops, and frequency information associated with the frequency hops; and receiving based on the configuration, a plurality of reference signal transmissions, each at a frequency location and a time location of a respective one of the frequency hops and spanning a frequency less than or equal to the active bandwidth part.

Optionally, in any of the preceding aspects, another implementation of the aspect provides transmitting an indication of a reference signal resource to be used for the plurality of reference signal transmissions, wherein a frequency span of the reference signal resource spans a bandwidth of an individual frequency hop of the frequency hops, or the bandwidth for positioning.

Optionally, in any of the preceding aspects, another implementation of the aspect provides that the configuration further comprises at least one of an indication of a common hop bandwidth for each of the frequency hops; an index to a lookup table (LUT) having a plurality of entries, each indicating a number of physical resource blocks in a hop bandwidth of an individual frequency hop based on a respective one of a plurality of subcarrier spacings and a respective one of a plurality of channel bandwidths; an indication of a starting physical resource block for an earliest frequency hop of the frequency hops in time; or an indication of a number of overlapping resource blocks between adjacent frequency hops of the frequency hops.

Optionally, in any of the preceding aspects, another implementation of the aspect provides that the configuration further comprises an indication of a starting slot offset and a starting symbol for an earliest frequency hop of the frequency hops in time; and a number of orthogonal frequency-division multiplexing (OFDM) symbols for an individual frequency hop of the frequency hops.

Optionally, in any of the preceding aspects, another implementation of the aspect provides that a frequency location of a current frequency hop of the frequency hops is higher than a frequency location of a previous adjacent frequency hop of the frequency hops in time.

Optionally, in any of the preceding aspects, another implementation of the aspect provides that a frequency location of a highest-frequency frequency hop of the frequency hops is adjacent and prior, in time, to a lowest-frequency frequency hop of the frequency hops.

Optionally, in any of the preceding aspects, another implementation of the aspect provides transmitting a configuration for a time window, wherein a duration of the time window is based on an individual reference signal transmission and the number of frequency hops within the bandwidth for positioning, wherein the plurality of reference signal transmissions are received within the duration of the time window.

A fourth aspect relates to a method for wireless communications, the method comprising transmitting a configuration for a measurement gap, wherein a duration of the measurement gap is based on a time gap for frequency-hopping from one frequency location to another frequency location within a bandwidth for positioning, a duration of an individual reference signal transmission, and a number of frequency hops within the bandwidth for positioning, and wherein the measurement gap is configured for a user equipment (UE) of reduced capability (RedCap) UE type; transmitting, within the duration of the measurement gap, a plurality of reference signal transmissions based on the time gap, the duration of the individual reference signal transmission, and the number of frequency hops, wherein a frequency span of each of the plurality of reference signal transmissions spans the bandwidth for positioning; and receiving, based on the plurality of reference signal transmissions, a measurement report.

Optionally, in any of the preceding aspects, another implementation of the aspect provides that the transmitting the plurality of reference signal transmissions comprises transmitting a positioning reference signal (PRS).

Optionally, in any of the preceding aspects, another implementation of the aspect provides transmitting a hopping configuration indicating information associated with frequency locations of the frequency hops.

Optionally, in any of the preceding aspects, another implementation of the aspect provides that the hopping configuration comprises at least one of an indication of a common hop bandwidth for each of the frequency hops; an index to a lookup table (LUT) having a plurality of entries, each indicating a number of resource blocks in a hop bandwidth of an individual frequency hop based on a respective one of a plurality of subcarrier spacings and a respective one of a plurality of channel bandwidths; an indication of a number of overlapping resource blocks between adjacent frequency hops of the frequency hops; or an indication of the number of frequency hops within the bandwidth for positioning.

A fifth aspect relates to an apparatus comprising a processor, and a memory storing program instructions that, when executed by the processor, cause the apparatus to perform the method of any of the disclosed embodiments.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example communication system.

FIG. 2 illustrates an example bandwidth configuration for a reduced capability (RedCap) device in comparison to a non-RedCap device.

FIG. 3 illustrates an example channelization configuration for wideband frequency-hopping in RedCap devices according to an embodiment of the present disclosure.

FIG. 4 illustrates an example configuration for two adjacent hops in a partial overlapping frequency-hopping pattern according to an embodiment of the present disclosure.

FIG. 5 illustrates an example sounding reference signal (SRS) resource configuration for wideband frequency-hopping according to an embodiment of the present disclosure.

FIG. 6 illustrates an example SRS resource configuration for wideband frequency-hopping according to an embodiment of the present disclosure.

FIG. 7 illustrates an example SRS resource configuration for wideband frequency-hopping according to an embodiment of the present disclosure.

FIG. 8 is a signaling diagram of an example method for transmitting SRSs with wideband frequency-hopping according to an embodiment of the present disclosure.

FIG. 9 illustrates an example positioning reference signal (PRS) measurement configuration for wideband frequency-hopping according to an embodiment of the present disclosure.

FIG. 10 is a signaling diagram of an example method for measuring PRSs with wideband frequency-hopping according to an embodiment of the present disclosure.

FIG. 11 illustrates an example multi-user configuration for non-overlapping staircase wideband frequency-hopping according to an embodiment of the present disclosure.

FIG. 12 illustrates an example multi-user configuration for non-overlapping staircase wideband frequency-hopping according to an embodiment of the present disclosure.

FIG. 13 illustrates an example multi-user configuration for non-overlapping staircase wideband frequency-hopping according to an embodiment of the present disclosure.

FIG. 14 illustrates an example configuration for aligning a RedCap device's channel bandwidth to a wideband frequency-hopping bandwidth according to an embodiment of the present disclosure.

FIG. 15 illustrates an example configuration for aligning a RedCap device's channel bandwidth to a wideband frequency-hopping bandwidth according to an embodiment of the present disclosure.

FIG. 16 illustrates an example configuration for aligning a RedCap device's channel bandwidth to a wideband frequency-hopping bandwidth according to an embodiment of the present disclosure.

FIG. 17 illustrates an example intra-slot wideband frequency-hopping configuration for a RedCap device according to an embodiment of the present disclosure.

FIG. 18 illustrates an example multi-slot wideband frequency-hopping configuration for a RedCap device according to an embodiment of the present disclosure.

FIG. 19 illustrates an example slots and symbols configuration for a Time-Division Duplex (TDD) deployment according to an embodiment of the present disclosure.

FIG. 20 illustrates an example TDD configuration for non-overlapping wideband frequency-hopping according to an embodiment of the present disclosure.

FIG. 21 illustrates an example multi-user configuration for partial overlapping staircase wideband frequency-hopping according to an embodiment of the present disclosure.

FIG. 22 illustrates an example multi-user configuration for partial overlapping staircase wideband frequency-hopping according to an embodiment of the present disclosure.

FIG. 23 illustrates an example multi-user configuration for partial overlapping staircase wideband frequency-hopping according to an embodiment of the present disclosure.

FIG. 24 illustrates an example transmission bandwidth configuration for wideband frequency-hopping according to an embodiment of the present disclosure.

FIG. 25 illustrates an example transmission bandwidth configuration for wideband frequency-hopping according to an embodiment of the present disclosure.

FIG. 26 illustrates an example transmission bandwidth configuration for wideband frequency-hopping according to an embodiment of the present disclosure.

FIG. 27 illustrates an example TDD configuration for partial overlapping wideband frequency-hopping according to an embodiment of the present disclosure.

FIG. 28 is a flowchart of an example method for performing wideband positioning with frequency-hopping according to an embodiment of the present disclosure.

FIG. 29 is a flowchart of an example method for performing wideband positioning with frequency-hopping according to an embodiment of the present disclosure.

FIG. 30 is a flowchart of an example reference signal transmission method with wideband frequency-hopping for positioning according to an embodiment of the present disclosure.

FIG. 31 is a flowchart of an example reference signal transmission method with wideband frequency-hopping for positioning according to an embodiment of the present disclosure.

FIG. 32 is a flowchart of an example reference signal measurement method with wideband frequency-hopping for positioning according to an embodiment of the present disclosure.

FIG. 33 is a flowchart of an example reference signal measurement method with wideband frequency-hopping for positioning according to an embodiment of the present disclosure.

FIG. 34 is a diagram of an example communication system.

FIG. 35A is a diagram of an example electronic device (ED).

FIG. 35B is a diagram of an example base station.

FIG. 36 is a block diagram of an example computer apparatus according to an embodiment of the present disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following terms are defined as follows unless used in a contrary context herein. Specifically, the following definitions are intended to provide additional clarity to the present disclosure. However, terms may be described differently in different contexts. Accordingly, the following definitions should be considered as a supplement and should not be considered to limit any other definitions of descriptions provided for such terms herein.

Frequency-hopping is a communication technique where a transmitter or a receiver may hop from one carrier frequency to another carrier frequency over a wide frequency band for transmissions or receptions, respectively. A frequency-hopping cycle may include a number of hops across the wide frequency band over a certain time period, where consecutive or adjacent hops in time are at different frequency locations within the wide frequency band. In the frequency domain, each hop may span a certain frequency bandwidth, which may be referred to as an instantaneous bandwidth (IBW). In the time domain, each hop may span a certain time period, which may be referred to as a hop dwell time. Furthermore, adjacent hops in time may be separated by a time gap, which may be referred to as a hop switching time. In an example, the time gap may be for frequency-hopping from one frequency location to another frequency location. A total frequency span of the hops within the frequency-hopping cycle may correspond to the wide frequency band, which may also be referred to as a total frequency-hopping bandwidth.

A reference signal may refer to a signal generated from sequence(s) and/or parameter(s) that are known to (or pre-configured at) a transmitter and a corresponding receiver. The reference signal may be transmitted by the transmitter in resources (e.g., time and/or frequency resources) that are known to (or pre-configured at) the receiver.

Positioning is a technique that enables mobile network operators to provide high-accuracy location services to subscribers of the mobile network operators. Reference signals may be transmitted by a base station or a user equipment (UE) (of a subscriber) to facilitate measurements for positioning (e.g., to determine a geographical location of the UE). A bandwidth for positioning may refer to a total frequency span of reference signal(s) transmitted to assist measurements for positioning.

A bandwidth part (BWP) may refer to a designated portion of a full carrier bandwidth. In new radio (NR), a network may configure a UE with up to four BWPs and configure one of the BWPs as an active BWP for the UE to communicate with the network.

A RedCap UE may refer to a UE that has reduced capabilities in comparison with a non-RedCap UE. The reduced capabilities may include a reduction in maximum supported bandwidth, a fewer number of transceivers, and/or a reduced duplexing operation mode (e.g., no simultaneous uplink transmission and downlink reception is supported, resulting in Half-Duplex Frequency-Division Duplexing (HD-FDD) operations), as discussed above.

A channel of a RedCap UE may be referred to as a RedCap channel. A channel of a non-RedCap UE may be referred to as a non-RedCap channel.

The terms “UE” and “devices” may be used interchangeably herein, such that a description referring to one of the terms shall be treated as though the description also referred to the other term.

The terms “frequency hop”, “hop”, and “hopping occasion” may be used interchangeably herein, such that a description referring to one of the terms shall be treated as though the description also referred to the other term.

The terms “total frequency-hopping bandwidth”, “wideband frequency-hopping bandwidth”, and “full carrier bandwidth” may be used interchangeably herein, such that a description referring to one of the terms shall be treated as though the description also referred to the other term.

The terms “IBW”, “hop bandwidth”, and “RedCap channel bandwidth” may be used interchangeably herein, such that a description referring to one of the terms shall be treated as though the description also referred to the other term.

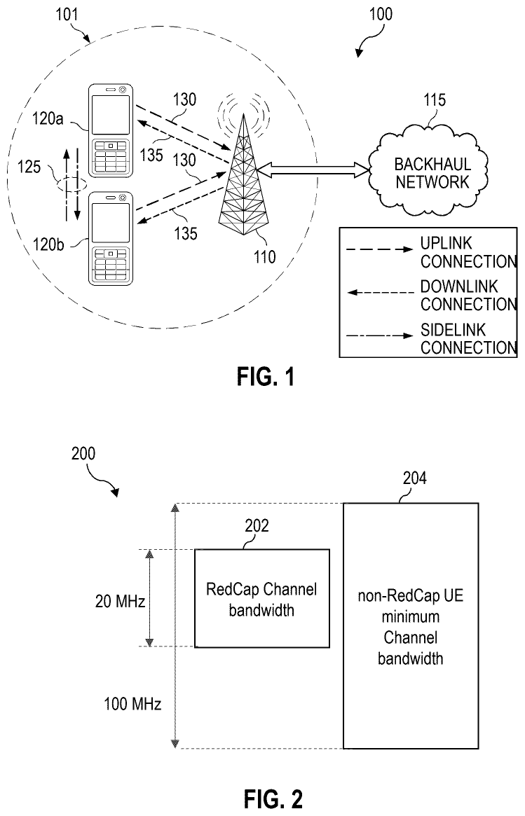

FIG. 1 is a schematic diagram of an example communications system 100. Communications system 100 includes an access node (AN) 110 within a coverage area 101 that serves user equipments (UEs), such as UEs 120 (individually shown as 120a and 120b). In a first operating mode, communications to and from a UE 120 passes through the AN 110 within the coverage area 101. The AN 110 is connected to a backhaul network 115 for connecting to the Internet, operations and management, and so forth. In a second operating mode, communications to and from a UE 120 do not pass through the AN 110, however, the AN 110 typically allocates resources used by the UE 120 to communicate when specific conditions are met. Communications between a pair of UEs 120 can use a sidelink connection (shown as two separate one-way connections 125). In FIG. 1, the sidelink communication is between two UEs 120 (UEs 120a and 120b) operating inside of the coverage area 101. However, sidelink communications, in general, can occur when the two UEs 120 are both outside the coverage area 101, both inside the coverage area 101, or one UE (one of the UE 120a or UE 120b) is inside the coverage area 101 and the other UE (the other one of the UE 120a or UE 120b) is outside the coverage arca 101. Communication between a UE and AN pair occur over unidirectional communication links, where communication links from the UE 120 to the AN 110 are referred to as uplinks 130, and communication links from the AN 110 to the UE 120 are referred to as downlinks 135.

Access nodes may also be referred to as access points, Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be referred to as mobile stations, mobiles, terminals, terminal devices, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple ANs capable of communicating with a number of UEs, only one AN and two UEs are illustrated in FIG. 1 for simplicity.

Signals are communicated in time and frequency resources. A time and frequency resource may be allocated in a unit of a physical resource block (PRB). For NR mobile broadband (MBB) communication, in a slot, each PRB in the resource grid is defined as a span of 14 consecutive orthogonal frequency-division multiplexed (OFDM) symbols in the time domain and 12 consecutive subcarriers in the frequency domain, i.e., each PRB includes 12×14 resource elements (REs). Each RE is located on one OFDM symbol in the time domain and one subcarrier in the frequency domain. When used as a frequency-domain unit, a PRB is 12 consecutive subcarriers. There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kilohertz (kHz) SCS, the duration of a slot is {1, 0.5, 0.25, 0.125} milliseconds (ms), respectively. Each PRB may be allocated to a control channel, a shared channel, a feedback channel, reference signals, and/or any combination thereof. In addition, some REs of a PRB may be reserved. A similar structure may be used on the sidelink as well. A communication resource may be a PRB, a set of PRBs, a code (if code division multiple access (CDMA) is used, similarly as for the physical uplink control channel (PUCCH)), a physical sequence, a set of REs, and so on.

In an example, the UE 120a is a RedCap UE and the UE 120b is a non-RedCap UE. In comparison with the non-RedCap UE 120b, the RedCap UE 120a may have reduced capabilities. The reduced capabilities may, for example, include but are not limited to, a reduction in the maximum supported bandwidth, a fewer number of transceivers, and/or a reduced duplexing operation mode as discussed above. With respect to a reduction in the maximum supported bandwidth, the bandwidth of 3GPP Release-17 RedCap devices (e.g., the RedCap UE 120a) is capped at 20 megahertz (MHz) and 100 MHz for FR1 (<˜7 GHz) and FR2 (>˜24 GHz), respectively. Tables 1 and 2 illustrate transmission bandwidth configurations, denoted as N_{RB}, for each of the specified channel bandwidths up to 20 MHz for FR1 RedCap devices (e.g., as specified in 3GPP document Technical Specification (TS) 38.101-1) and up to 100 MHz for FR2 RedCap devices (e.g., as specified in 3GPP document TS 38.101-2), respectively. N_{RB} is defined in terms of the number of PRBs.

TABLE 1
Maximum transmission bandwidth configuration
for FR1 RedCap devices

| | 5 MHz | 10 MHz | 15 MHz | 20 MHz |
|---|---|---|---|---|
| SCS (kHz) | N_{RB} | N_{RB} | N_{RB} | N_{RB} |
| 15 | 25 | 52 | 79 | 106 |
| 30 | 11 | 24 | 38 | 51 |
| 60 | N/A | 11 | 18 | 24 |

TABLE 2
Maximum transmission bandwidth configuration
for FR2 RedCap Devices

| | 50 MHz | 100 MHz |
|---|---|---|
| SCS (kHz) | N_{RB} | N_{RB} |
| 60 | 66 | 132 |
| 120 | 32 | 66 |

With respect to a fewer number of transceivers, a RedCap device may support a single transmit radio-frequency (RF) chain or branch and a single receive RF chain for FR1, with two chains being optional, and two receive RF chains for FR2. With respect to a reduced duplexing mode, a RedCap device may not receive in the downlink frequency while transmitting in the uplink frequency, and vice versa, resulting in HD-FDD operations.

In an example, the communication system 100 may utilize a BWP framework for transmissions and receptions, for example, as specified in NR. The BWP framework may indicate resources available for transmissions and receptions. A BWP may not be larger (or wider) than the maximum bandwidth of a device (e.g., a UE 120) or network configured limits (configured by the AN 110) within an operating frequency band. For example, for FR1, the AN 110 may configure a BWP of 100 MHz for the non-RedCap UE 120b while configuring a BWP of 20 MHz for the RedCap UE 120a. More specifically, the AN 110 may configure the RedCap UE 120a with a BWP (e.g., an active BWP) having a frequency span less than or equal to a maximum bandwidth supported by the RedCap UE 120a. Stated differently, the maximum bandwidth supported by the RedCap UE 120a is greater than or equal to the BWP. Within the BWP framework, the network may configure a UE 120 with up to four BWPs (e.g., each spanning different frequencies), where support of more than one UE-specific BWP is an optional feature of the UE 120. For instance, the AN 110 may configure the RedCap UE 120a with four BWPs and configure one of the BWPs as an active BWP (for the RedCap UE 120a to communicate with the AN 110). Subsequently, the AN 110 can configure the RedCap UE 120a to switch to a different one of the BWPs for communication.

FIG. 2 illustrates an example bandwidth configuration 200 for a RedCap device (e.g., the RedCap UE 120a) in comparison to a non-RedCap device (e.g., the RedCap UE 120b). In FIG. 2, the vertical axis represents frequency in some arbitrary units. As shown in FIG. 2, the non-RedCap UE 120b may support a minimum channel bandwidth of 100 MHz while the RedCap UE 120a may support a maximum channel bandwidth of 20 MHz, for example, when operating in FR1.

The communication system 100 may support positioning of the UEs 120. In an example, downlink positioning reference signals (PRSs) and uplink sounding reference signals (SRSs) may be used for determining a position of a UE 120. To that end, the AN 110 may transmit PRSs to a UE 120 and may configure the UE 120 to transmit SRSs for positioning. The PRSs may be used by a UE 120 to perform measurements for positioning. For instance, the UE 120 may measure the time of arrival (ToA) and angle of arrival (AoA) based on a reception of the PRSs. The UE 120 may report those measurements (e.g., the ToA and AoA) back to the AN 110. The AN 110 may calculate a position (e.g., geographical location) of the UE 120 based on those measurements, for example, using trilateration or triangulation techniques or any suitable techniques known in the art. In a similar way, the UE 120 may transmit SRSs and the AN 110 may determine a location of the UE 120 based on measurements (e.g., ToA and AoA) performed on the SRSs. In general, the AN 110 may calculate a position of a UE 120 based on PRS measurements reported by the UE 120, the AN 110′s measurements of the SRSs, or a combination thereof.

The aforementioned reduced capabilities of the RedCap UE 120a can degrade the positioning accuracy that can be achieved by the non-RedCap UE 120b. In particular, the narrower bandwidth supported by the RedCap UE 120a can reduce the positioning accuracy. While the AN 110 can request the RedCap UE 120a to switch from one BWP to another BWP (e.g., when using the BWP framework discussed above), each switch of a BWP can take several slots. As such, there may be a delay between measurements from one frequency location to another location, causing a delay in obtaining measurements across all frequencies of a desired wide frequency band. The long delay can affect the positioning accuracy. Furthermore, with a 100 MHz channel, a 20 MHz RedCap UE without four configured BWPs is unable to hop over all 100 MHz, which may also affect the positioning accuracy.

One way to improve positioning accuracy without increasing the cost and/or complexity (e.g., without increasing the number of transmit and receive RF chains) of the RedCap UE 120a is to utilize frequency-hopping. Frequency-hopping enables the transmitter and/or receiver of the RedCap UE 120a to hop from one carrier frequency to another carrier frequency over a wide frequency spectrum, while the IBW per hop can be less than or equal to the maximum bandwidth supported by the RedCap UE 120a.

Disclosed herein are techniques for configuring a RedCap UE (e.g., supporting a reduced maximum bandwidth) to frequency-hop outside of an active BWP of the RedCap UE for wideband positioning. The configuration may include a hopping configuration for frequency-hopping across a wideband (e.g., having a bandwidth wider than the maximum bandwidth supported by the RedCap UE) for positioning, an SRS resource configuration for SRS transmissions, and a PRS measurement gap configuration for PRS measurements. Configuring the RedCap UE to frequency-hop outside of the active BWP and across the wideband can improve positioning accuracy without increasing the cost and/or complexity of the RedCap UE.

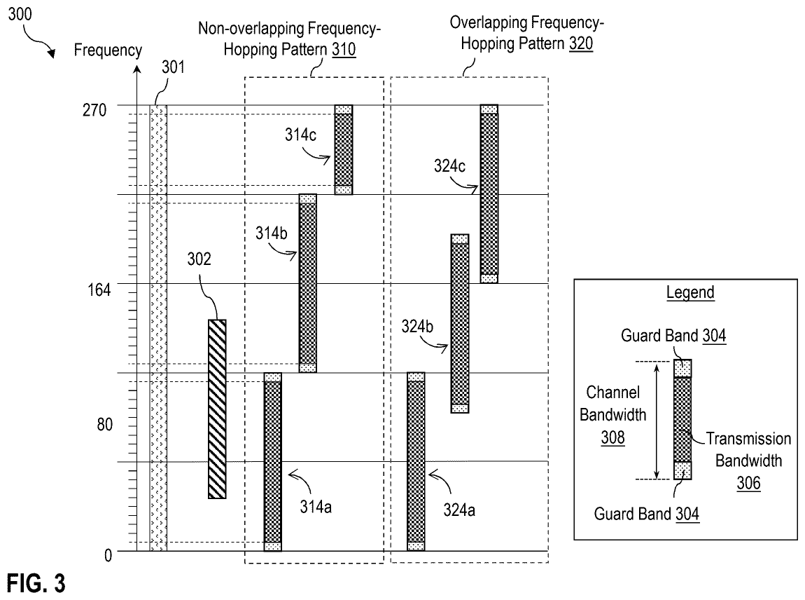

FIG. 3 illustrates an example channelization configuration 300 for wideband frequency-hopping in RedCap devices (e.g., the UE 120a) according to an embodiment of the present disclosure. In FIG. 3, the vertical axis represents frequency in units of PRBs.

In embodiments, the AN 110 (or the network) may configure the RedCap UE 120a to perform frequency-hopping over a wideband frequency-hopping channel 301 for SRS transmissions or PRS receptions. In one example, the AN 110 may configure the RedCap UE 120a with a frequency-hopping pattern 310. As will be discussed more fully below, the frequency-hopping pattern 310 is a non-overlapping frequency-hopping pattern including three hops 314 (individually shown as 314a, 314b, and 314c). In another example, the AN 110 may configure the RedCap UE 120a with a frequency-hopping pattern 320. As will be discussed more fully below, the frequency-hopping pattern 320 is a partial overlapping frequency-hopping pattern including three hops 324 (individually shown as 324a, 324b, and 324c).

Each of the hops 314a-314c and 324a-324c shown in the frequency-hopping patterns 310 and 320, respectively, is a channel. A channel, denoted by C, may include a transmission band 306 and guard bands 304, denoted by G. At each hop 314 or 324, the RedCap UE 120a may transmit or receive a signal in the transmission band 306 but may not transmit any signal in the guard bands 304 and may not expect to receive any signal in the guard bands 304. The guard bands 304 situated on either side of the channel edges may act as buffer zones, ensuring the RedCap UE 120a's out-of-band emissions satisfy regulatory requirements. While not shown in FIG. 3, the wideband frequency-hopping channel 301 may have the aforementioned channel structure. Further, in some instances, for the non-overlapping frequency-hopping pattern 310, the guard band 304 of one hop, e.g., the hop 314a, can overlap with at least a portion of the guard band 304 and/or a portion of the transmission band 306 of an adjacent hop, e.g., the hop 314b.

The channel bandwidth 308, denoted by BW_{channel}, may be formulated as BW_{channel}=2×G+SCS×(12×N_{RB}+1), where SCS is the subcarrier spacing and N_{RB} is the number of PRBs in the transmission band. Since the channel bandwidth 308 may not be a multiple of 5 MHz and the bandwidth of each PRB is a multiple of 180 kHz, the guard bands 304 may not be an integer number of PRBs. In examples, the 3GPP standards may set the transmission bandwidth 306 as 90% of the channel bandwidth 308. As such, the bandwidth of the guard bands 304 generally increases as the channel bandwidth 308 increases. The guard bands 304 in kilohertz for each of the RedCap device's channel bandwidth specified in Table 1 for FR1 and Table 2 for FR2 are shown in Table 3 for FR1 (e.g., as specified in 3GPP document TS 38.101-1) and Table 4 for FR2 (e.g., as specified in 3GPP document TS 38.101-2), respectively.

TABLE 3
Minimum guard band for FR1 RedCap devices

| | RedCap Channel Bandwidth | | | |
|---|---|---|---|---|
| SCS (kHz) | 5 MHz | 10 MHz | 15 MHz | 20 MHz |
| 15 | 242.5 kHz | 312.5 kHz | 382.5 kHz | 452.5 kHz |
| 30 | 505 kHz | 665 kHz | 645 kHz | 805 kHz |
| 60 | N/A | 1010 kHz | 990 kHz | 1330 kHz |

TABLE 4
Minimum guard band for FR2 RedCap devices

RedCap Channel Bandwidth

| SCS (kHz) | 50 MHz | 100 MHz |
|---|---|---|
| 60 | 1210 kHz | 2450 kHz |
| 120 | 1900 kHz | 2420 kHz |

In the illustrated example of FIG. 3, the SCS is 15 kHz and the bandwidth of the wideband frequency-hopping channel 301 is 50 MHz. A 50 MHz channel may include 273 PRBs at an SCS of 15 kHz. The AN 110 may configure the RedCap UE 120a to operate (e.g., frequency-hop) anywhere within the 50 MHz channel. However, the RedCap UE 120a may be unaware of the wideband frequency-hopping channel 301 bandwidth.

In general, there is a Common Resource Block (CRB) grid (e.g., CRB #0 to CRB #272 in the vertical axis) for a UE to align the UE's channel, where the symbol # may represent the location, the number, or the index of a CRB or PRB. For example, with a 20 MHz maximum bandwidth, the maximum number of PRBs is 106 for an SCS of 15 kHz, where the PRBs in the channel may be numbered or indexed from 0 to 105. The center of the 20 MHz channel is at PRB #53. On the CRB grid, PRB #53 may correspond to CRB #103. The following describes an example of the RedCap UE 120a supporting a maximum bandwidth of 20 MHz.

When the 20 MHz RedCap UE 120a hops from a first carrier frequency to a second carrier frequency, the RedCap UE 120a may align to the CRB grid. For example, the guard band for a 50 MHz channel with 15 kHz SCS is 692.5 kHz while the guard band for a 20 MHz channel is 452.5 kHz. The first PRB (a lowest-frequency PRB) for the 50 MHz channel (e.g., the channel 301) starts at 692.5 kHz from the lower channel edge. When the RedCap UE 120a hops to use this first PRB, the RedCap UE 120's channel begins at 240 kHz (=692.5 kHz−452.5 kHz) from the channel edge, allowing the first resource block (RB) of the RedCap UE 120a's 20 MHz channel to align with the first RB of the 50 MHz channel. The RedCap UE 120a may receive 106 PRBs or fewer PRBs from that starting location (at 240 kHz). For transmission, the AN 110 (e.g., cellular base station) may configure the RedCap UE 120a to transmit 106 PRBs or fewer PRBs.

For the non-overlapping frequency-hopping pattern 310, the RedCap UE 120a hops from the RedCap UE 120a's serving cell location 302 (e.g., an active BWP configured by the AN 110) in the frequency domain to the first (or earliest) hop 314a of the non-overlapping frequency-hopping pattern 310 (near the start of the wideband frequency-hopping channel 301). The RedCap UE 120a may be configured with a starting location (e.g., a first PRB of the wideband frequency-hopping channel 301) for the hop 314a. On the next hop 314b, the RedCap UE 120a hops to the frequency location of the hop 314b. As shown, no PRBs of the transmission bandwidth 306 for the 20 MHz channel of the hop 314a overlap with the transmission bandwidth 306 for the 20 MHz channel of the hop 314b. The hop 314b may be configured based on a PRB alignment (e.g., the RedCap UE 120a is configured with a first PRB of the hop 314b). The first PRB of the hop 314b may correspond to CRB location 108 (as an example). The RedCap UE 120a may receive 106 PRBs or fewer PRBs from the starting location of the hop 314b. For transmission, the AN 110 may configure the RedCap UE 120a to transmit 106 PRBs or fewer PRBs. On the next hop 314c, the RedCap UE 120a hops to the frequency location of the hop 314c. Similarly, no PRBs of the transmission bandwidth for the 20 MHz channel of the hop 314b overlap with the transmission bandwidth for the 20 MHz channel of the hop 314c. The hop 314c may be configured based on PRB alignment (e.g., the RedCap UE 120a is configured with a first PRB of the hop 314c). The first PRB of the hop 314c may correspond to CRB location 216 (as an example). Because the channel is about 10 MHz for the hop 314c, the RedCap UE 120a may adjust filters (at the RedCap UE 120a's transceivers) to operate at 10 MHz. On the final hop, the RedCap UE 120a may hop back to the RedCap UE 120a's serving cell frequency location 302 (the original active BWP).

For the partial overlapping frequency-hopping pattern 320, the RedCap UE 120a hops from RedCap UE 120a's serving cell frequency location 302 to the beginning hop 324a (near the start of the wideband frequency-hopping channel 301). The RedCap UE 120a may be configured with a starting location (e.g., the first PRB of the wideband frequency-hopping channel 301) for the hop 324a. On the next hop 324b, the RedCap UE 120a hops to a frequency location of the hop 324b. As shown, one or more PRBs of the transmission bandwidth 306 for the 20 MHz channel of the hop 324a overlap with the transmission bandwidth 306 for the 20 MHz channel of the hop 324b. The hop 324b may be configured based on a PRB alignment (e.g., the RedCap UE 120a is configured with a first PRB of the hop 324b). The first PRB of the hop 324b may correspond to CRB location 80 (as an example). The RedCap UE 120a may receive 106 PRBs or fewer PRBs from the starting location of the hop 324b. For transmission, the AN 110 may configure the RedCap UE 120a to transmit 106 or fewer PRBs. On the next hop 324c, the RedCap UE 120a hops to the frequency location of the hop 324c. Similarly, one of more PRBs of the transmission bandwidth 306 for the 20 MHz channel at the hop 324b overlap with the transmission bandwidth 306 for the 20 MHz channel at the hop 324c. The hop 324c may be configured based on a PRB alignment (e.g., the RedCap UE is configured with a first PRB of the hop 324c). The first PRB of the hop 324c may correspond to CRB location 164 (as an example). Because the channels are 20 MHz, the RedCap UE 120a may not adjust filters at the transceivers of the RedCap UE 120a. On the final hop, the RedCap UE 120a may hop back to the RedCap UE 120a's serving cell frequency location 302.

For the frequency-hopping pattern 310 or 320, the RedCap UE 120a may be configured with a starting location in the frequency domain and optionally a bandwidth for each hop 314 or 324, respectively. In some instances, the network may assume that the RedCap UE 120a uses the RedCap UE 120a's channel bandwidth for each hop 314 or 324. In an example, the RedCap UE 120a may be configured with three hops starting at CRB locations 0, 80, and 164. The RedCap UE 120a may determine the amount of overlap (between adjacent hops) based on the starting frequency locations and the corresponding bandwidths. For example, based on a channel bandwidth of 106 PRBs, the second hop may overlap with the first hop by 26 PRBs (0+106−80=26 PRBs), and the third hop may overlap with the second hop by 22 PRBs (80+106−164=22PRBs).

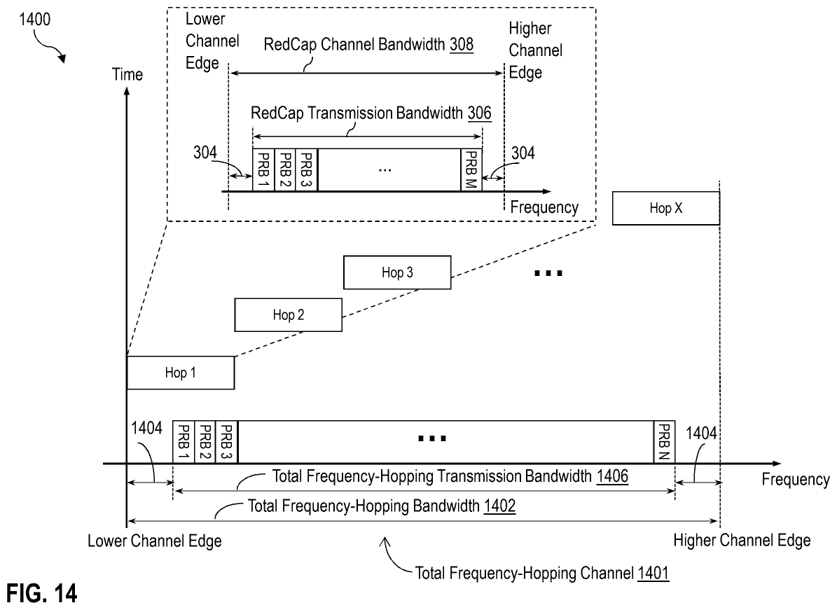

For the non-overlapping frequency-hopping pattern 310, the notion of intra-cell guard bands for wideband operation in Table 5.3.3-2 of 3GPP document TS 38.101-1 and in clause 7 of 3GPP document TS 38.214 can be considered for indicating frequency-hopping information for a RedCap UE such as the RedCap UE 120a. For example, a 100 MHz channel with 30-kHz SCS may include 273 PRBs and may be divided into five 20 MHz channels (or hops). The five channels may be represented in the following format: 50-6-50-6-49-6-50-6-50 (e.g., in an increasing frequency order), where the values 50 and 49 in the channel representation may represent the number of PRBs in a transmission bandwidth 306 and the value 6 in the channel representation may represent the number of PRBs in a guard band 304 between two adjacent channels (in frequency). That is, in the first hop, the first 50 PRBs are used for reference signal transmission (e.g., PRS or SRS). In the second hop, 50 PRBs are used for reference signal transmission, starting from CRB #56 (=50+6). In the third hop, 49 PRBs are used for reference signal transmission, starting from CRB #112 (=50+6+50+6). In the fourth hop, 50 PRBs are used for reference signal transmission, starting from CRB #167 (=50+6+50+6+49+6). In the fifth hop, 50 PRBs are used for reference signal transmission, starting from CRB #223 (=50+6+50+6+49+6+50+6). Various mechanisms for aligning frequency-hopping channels to a CRB grid and/or a wideband channel will be discussed more fully below with reference to FIGS. 14-16 and FIGS. 24-26.

Non-overlapping frequency-hopping can cause a number of problems in wideband positioning measurements, which may include 1) unknown or random phase rotation due to RF retuning at the transmitter or receiver; 2) a phase shift discontinuity when time and/or frequency change; and/or 3) no positioning measurements can be carried out in the guard band. As a consequence of the first two problems, the AN 110 may be unable to coherently combine the SRS resource received at each hop to form a wideband positioning measurement. The partial overlapping frequency-hopping pattern 320 can alleviate the aforementioned problems.

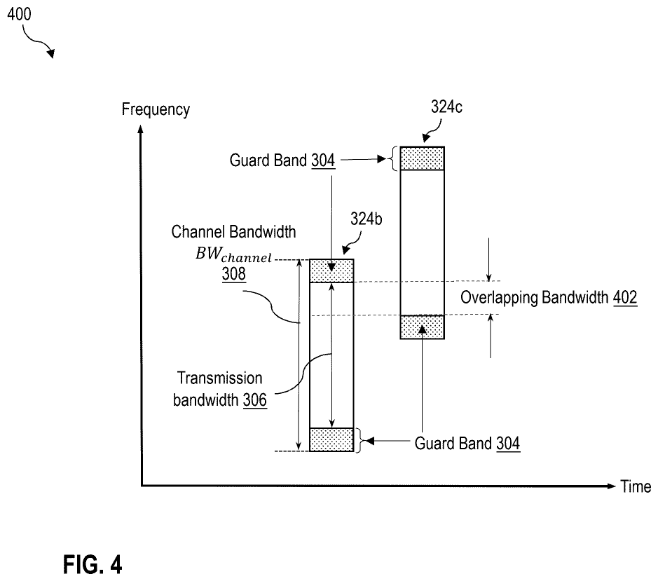

FIG. 4 illustrates an example configuration 400 for two adjacent hops in a partial overlapping frequency-hopping pattern according to an embodiment of the present disclosure. In the illustrated example of FIG. 4, the two adjacent hops correspond to the hops 324b and 324c in the partial overlapping frequency-hopping pattern 320 of FIG. 3. However, the adjacent hops 324a and 324b the partial overlapping frequency-hopping pattern 320 may have a substantially similar configuration. In FIG. 4, the vertical axis may represent frequency in some arbitrary units, and the horizontal axis may represent time in some arbitrary units. For simplicity, FIG. 4 may use the same reference labels as FIG. 3 to refer to the same elements.

As shown in FIG. 4, the transmission bandwidth 306 of the hop 324b covers (or overlaps with) the guard bands 304 of the hop 324c. In a similar way, the transmission bandwidth 306 of the hop 324c covers (or overlaps with) the guard bands 304 of the hop 324b. In this way, the PRBs located in the guard bands 304 can be measured on different hops 324b and 324c. The amount of frequency overlap or the overlapping transmission bandwidth 402, denoted by BWₒᵥₑᵣₗₐₚ, can include an integer multiple of PRBs (e.g., two PRBs) or a fraction of PRBs (e.g., half a PRB) as shown below:

$${BW}_{overlap} = {f}_{start} ( n ) + {BW}_{channel} - {f}_{start} ( n + 1 ) - 2 G , \qquad ( 1 )$$

where fₛₜₐᵣₜ(n) is the frequency start location of hop n, fₛₜₐᵣₜ(n+1) is the frequency start location of hop n+1, and G is the guard band.

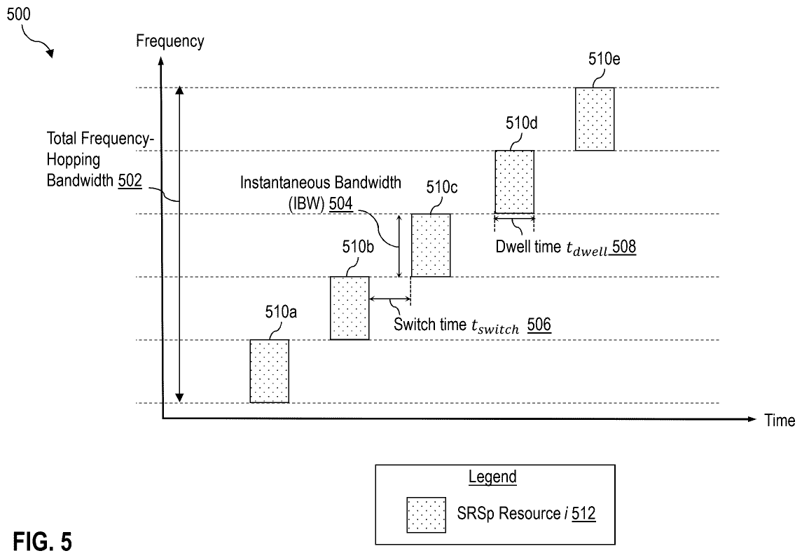

In embodiments, the AN 110 may configure the RedCap UE 120a's transmitter with SRS resources (which may be referred to as SRSp resources) for wideband positioning as shown in FIGS. 5-7. In the time domain, an SRS resource may occupy one or more OFDM symbols. In the frequency domain, an SRS resource may occupy one or more PRBs, where one PRB may represent 12 consecutive REs in the frequency domain as discussed above. The RedCap UE 120a may transmit SRSs in the configured SRS resources to assist wideband positioning.

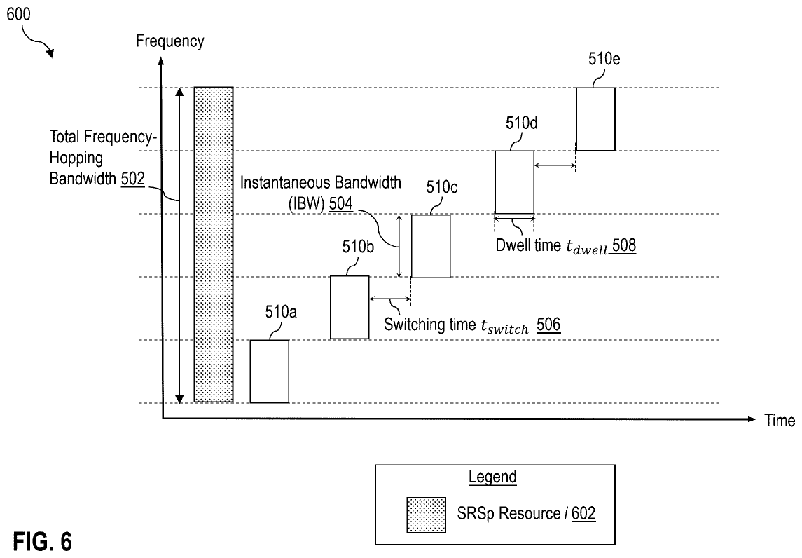

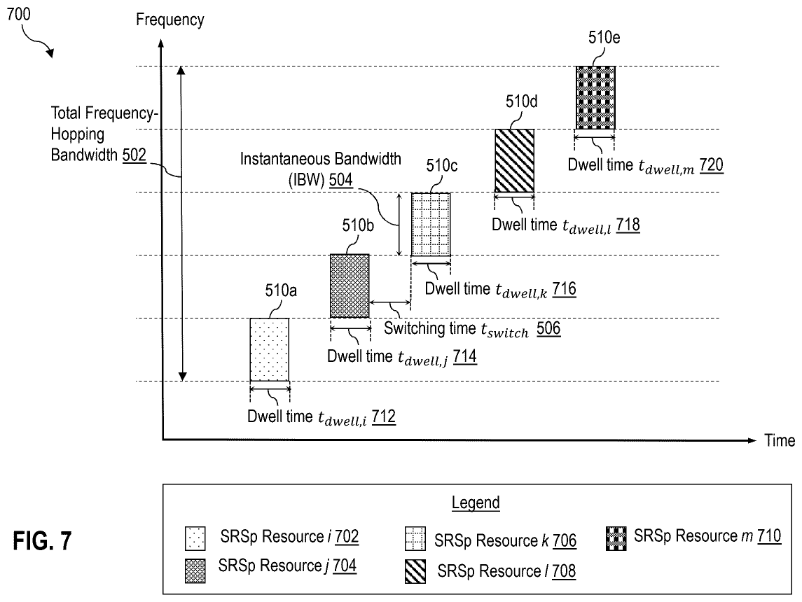

FIG. 5 illustrates an example SRS resource configuration 500 with one SRS resource spanning a hop bandwidth for wideband frequency-hopping according to an embodiment of the present disclosure. FIG. 6 illustrates an example SRS resource configuration 600 with one SRS resource spanning a wideband bandwidth for wideband frequency-hopping according to an embodiment of the present disclosure. FIG. 7 illustrates an example SRS resource configuration 700 with multiple SRS resources for wideband frequency-hopping according to an embodiment of the present disclosure. In FIGS. 5-7, the vertical axes may represent frequency in some arbitrary units, and the horizontal axes may represent time in some arbitrary units. Additionally, FIGS. 5-7 are discussed using the same channel structure as FIG. 3 and may use the same reference numerals as in FIG. 3 to refer to the same elements. While FIGS. 5-7 illustrate the non-overlapping frequency-hopping approach (e.g., the frequency-hopping pattern 310), the configurations 500-700 are applicable to the partial overlapping frequency-hopping approach (e.g., the frequency-hopping pattern 320).

As shown in FIG. 5, the configuration 500 configures one SRSp resources i 512 for the RedCap UE 120a's transmitter to transmit SRSs over five consecutive hops 510 (individually shown as 510a, 510b, 510c, 510d, and 510c) over a total frequency-hopping bandwidth 502, denoted by BWₜₒₜₐₗ, for positioning. Each hop 510 may span an IBW 504 (a hop bandwidth). For case of illustration, FIG. 5 only shows the reference numeral 504 for the IBW of the hop 510c. The IBW 504 may be similar to the channel bandwidth 308, and the hops 510 may be similar to the hops 314 and 324. In an example, for FR1 , the total frequency-hopping bandwidth 502 may be 100 MHz and the IBW 504 for each hop 510 may be 20 MHz. The SRSp resources i 512 may refer to an ith configuration of an SRSp resource spanning a hop bandwidth. In other words, the SRS resource configuration is the same at each hop 510 (each hopping occasion).

As further shown in FIG. 5, each hop 510 may have a dwell time (an instantaneous dwell time) spanning a time duration 508, denoted as t_{dwell}. In other words, the instantaneous dwell time 508 t_{dwell} refers to the amount of time for the RedCap UE 120a to transmit an SRSp resource per hopping occasion. The dwell time 508 may be defined in terms of the number of symbols for a given numerology (or SCS). For ease of illustration, FIG. 5 only shows the reference numeral 508 for the dwell time of the hop 510d.

As further shown in FIG. 5, consecutive or adjacent hops 510 may be separated in time by a hop switching time 506, denoted as t_{switch}. The hop switching time 506 t_{switch} may correspond to a RF retuning delay for the RedCap UE 120a's transmitter to change from one carrier frequency to another carrier frequency. In an example, as part of RF retuning, the RedCap UE 120a may reconfigure the RF frontend (e.g., including local oscillator(s) and filter(s)) of the RedCap UE 120a according to the carrier frequency for the next hop. For ease of illustration, FIG. 5 only shows the reference numeral 506 for the switching time between the hops 510b and 510c.

In an example, the AN 110 may configure the RedCap UE 120a with the configuration 500 by reusing 3GPP SRS positioning resource information element (IE). For instance, in 3GPP Release 16, dedicated SRS resources were introduced to support positioning in legacy NR devices. According to 3GPP document TS 38.331, an SRS resource used for positioning is configured by an SRS-posResource-r16 IE as shown below:

| | |
|---|---|
| SRS-PosResource-r16:: = | SEQUENCE { |
| srs-PosResourceId-r16 | SRS-PosResourceId-r16, |
| transmissionComb-r16 | CHOICE { |
| n2-r16 | SEQUENCE { |
| combOffset-n2-r16 | INTEGER (0..1), |
| cyclicShift-n2-r16 | INTEGER (0..7) |

},

| | |
|---|---|
| n4-r16 | SEQUENCE { |
| combOffset-n4-r16 | INTEGER (0..3), |
| cyclicShift-n4-r16 | INTEGER (0..11) |

},

| | |
|---|---|
| n8-r16 | SEQUENCE { |
| combOffset-n8-r16 | INTEGER (0..7), |
| cyclicShift-n8-r16 | INTEGER (0..5) |

```
    },
  ...
  },
```

| | |
|---|---|
| resourceMapping-r16 | SEQUENCE { |
| startPosition-r16 | INTEGER (0..13), |
| nrofSymbols-r16 | ENUMERATED {n1, n2, n4, n8, n12} |

},

| | |
|---|---|
| freqDomainShift-r16 | INTEGER (0..268), |
| freqHopping-r16 | SEQUENCE { |
| c-SRS-r16 | INTEGER (0..63), |

```
    ...
  },
  groupOrSequenceHopping-r16 ENUMERATED { neither, groupHopping, sequenceHopping
},
```

| resourceType-r16 | CHOICE { | |
|---|---|---|
| aperiodic-r16 | SEQUENCE { | |
| slotOffset-r16 | INTEGER (1..32) | OPTIONAL, -- Need S |

```
      ...
    },
```

| | |
|---|---|
| semi-persistent-r16 | SEQUENCE { |
| periodicityAndOffset-sp-r16 | SRS-PeriodicityAndOffset-r16, |

```
      ...,
      [[
```

| | |
|---|---|
| periodicityAndOffset-sp-Ext-r16 | SRS-PeriodicityAndOffsetExt-r16 |

```
OPTIONAL -- Need R
      ]]
    },
```

| | |
|---|---|
| periodic-r16 | SEQUENCE { |
| periodicityAndOffset-p-r16 | SRS-PeriodicityAndOffset-r16, |

```
      ...,
      [[
```

| | |
|---|---|
| periodicityAndOffset-p-Ext-r16 | SRS-PeriodicityAndOffsetExt-r16 |

```
OPTIONAL -- Need R
      ]]
    }
  },
```

| sequenceId-r16 | INTEGER (0..65535), | |
|---|---|---|
| spatialRelationInfoPos-r16 | SRS-SpatialRelationInfoPos-r16 | OPTIONAL, -- Need R |

...
}

The key parameters to configure a time domain SRS positioning resource are included in the resourceMapping-r16 parameter structure, which are startPosition-r16 and nrofSymbols-r16. Referring to the definition of the nrofSymbols-r16 field, an SRS resource can occupy one, two, four, eight or twelve consecutive OFDM symbols and the starting OFDM symbol is indicated by the startPosition-r16 field. This means, transmission of an SRS resource simply takes place within one slot.

The key parameter used to configure a frequency domain SRS positioning resource is included within the freqHopping-r16 parameter structure, that is, c-SRS-r16. The c-SRS-r16 parameter makes a reference to a 64-entry table specified in 3GPP document TS 38.211, providing the bandwidth allocated to the SRS resource for positioning. Table 5 is excerpted from 3GPP document TS 38.211. The column shown for B_{SRS}=0 in Table 5 is applicable to the configuration of SRS resource for positioning. Within this column, the value of m_{SRS,0} determines the bandwidth of the configured SRS resource in terms of the number of PRBs.

TABLE 5
SRS bandwidth configuration

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |

While 3GPP Release 16 includes the c-SRS-r16 parameter for specifying a SRS resource configuration for positioning, there is no parameter defined in SRS-posResource-r16 to support positioning with wideband frequency-hopping. Accordingly, the present disclosure provides techniques for configuring SRS resources (e.g., leveraging the parameter c-SRS-r16 in SRS-posResource-r16 structure) in the frequency domain to support positioning with wideband frequency-hopping as will be discussed more fully below. Furthermore, while 3GPP Release 16 includes the nrofSymbols-r16 field for specifying a duration of SRS resources, there is no configuration to support SRS transmission spanning multiple slots. However, wideband frequency-hopping of RedCap devices may span multiple slots due to delay incurred as a result of RF retuning. Accordingly, the present disclosure also provides techniques for configuring SRS resources in one or more slots (in the time domain) for positioning with wideband frequency-hopping as will be discussed more fully below.

FIG. 6 is illustrated using the same frequency-hopping pattern as FIG. 5 and may use the same reference numerals as in FIG. 5 to refer to the same elements. As shown in FIG. 6, the configuration 600 configures one SRSp resources i 602 spanning the total frequency-hopping bandwidth 502. Each hop 510 may include a portion of the SRSp resources i 602 in the corresponding hop bandwidth (the IBW 504). That is, the RedCap UE 120a may transmit an SRS at each hop 510 using a portion of the SRSp resources i 602 in the corresponding hop bandwidth.

FIG. 7 is illustrated using the same frequency-hopping pattern as FIG. 5 and may use the same reference numerals as in FIG. 5 to refer to the same elements. Unlike the configurations 500 and 600, the configuration 700 configures multiple SRSp resources for positioning. As shown, the hop 510a, 510b, 510c, 510d, and 510e may be configured with SRSp resource i 702, SRSp resource j 704, SRSp resource k 706, SRSp resource/708, and SRSp resource m 710, respectively. The SRSp resources 702, 704, 706, 708, and 710 may correspond to different configurations of SRSp resources. For instance, each of the SRSp resources 702, 704, 706, 708, and 710 may be configured with a different attribute (e.g., a different parameter value in the SRS-posResource-r16 structure). While FIG. 7 illustrates different SRS configurations for different hops 510, in other examples, an SRS configuration for positioning can configure at least two hops 510 (e.g., the first two hops 510a and 510b) with the same SRSp resources 702 (e.g., SRSp resource i 702).

As further shown in FIG. 7, each of SRSp resources 702-710 may be configured with a different dwell time. That is, each hop 510 may have a different dwell time. For instance, the hop 510a may have a dwell time 712, denoted as t_{dwell,i}, the hop 510b may have a dwell time 714, denoted as t_{dwell,j}, the hop 510c may have a dwell time 716, denoted as t_{dwell,k}, the hop 510d may have a dwell time 718, denoted as t_{dwell,l}, and the hop 510e may have a dwell time 720, denoted as t_{dwell,m}. In other examples, at least two of the hops 510 may have the same dwell time.

In any of the configurations 500 and/or 600, the AN 110 may combine the SRSp resources received at each hop 510 to form a wideband positioning measurement. Further, while FIGS. 5-7 illustrate five hops 510 over the total frequency-hopping bandwidth 502, the AN 110 may configure the RedCap UE 120a with more than five hops (over the total frequency-hopping bandwidth 502), where each hop 510 may have a smaller IBW (e.g., 5 MHz, 15 MHz, etc.). However, with a greater number of hops, the positioning measurement delay may increase.

The IBW 504 determines the number of hops 510 to sound a wide bandwidth (e.g., the total frequency-hopping bandwidth 502). If the IBW 504 is equal to a given channel bandwidth of a corresponding RedCap UE (e.g., the RedCap UE 120a), then the number of hops to sound the wide bandwidth is minimum as shown below:

$${N}_{min} = ⌊ \frac{{BW}_{t o t a l}}{{BW}_{c h a n n e l}} ⌋ \qquad ( 2 )$$

where BWₜₒₜₐₗ represents the total frequency-hopping bandwidth (e.g., the total frequency-hopping bandwidth 502) and BW_{channel} represents the channel bandwidth of the RedCap UE 120a (given in Tables 1 and 2).

In the case of partial overlapping frequency-hopping, an additional of Nₒᵥₑᵣₗₐₚ number hops 510 are added to Equation (2), which is calculated as shown below:

$${N}_{overlap} = ⌈ \frac{( {N}_{min} - 1 ) \times {BW}_{overlap}}{{m}_{SRSp , 0}} ⌉ \qquad ( 3 )$$

where Nₘᵢₙ defined in Equation (2), BWₒᵥₑᵣₗₐₚ is defined in Equation (1), and m_{SRSp,0} is the maximum transmission bandwidth (specified above in Table 4).

In embodiments, the frequency-domain configuration of SRSp resources (e.g., the SRSp resources 512, 612, 702, 704, 706, 708, 710) may be specified by defining a lookup table (LUT) including an IBW for each given SCS and channel bandwidth BW_{channel} of a RedCap UE (e.g., the RedCap UE 120a). An example of such a lookup table is shown below in Table 6. In Table 6, IBW=BW_{channel} and the m_{SRSp,0} parameter defines the maximum transmission bandwidth (in the number of PRBs) used for SRS transmission at each hopping occasion (e.g., each hop 510), where the m_{SRSp,0} parameter corresponds to N_{RB} for a given channel bandwidth as shown in Tables 1 and 2 above. For instance, if C_{SRSp}=4, then the IBW=m_{SRSp,0}=106 PRBs.

TABLE 6
IBW configurations for wideband frequency-hopping
RedCap devices

| | | | B_{SRSp} = 0 | |
|---|---|---|---|---|
| C_{SRSp} | SCS | BW_{channel} | m_{SRSp,0} | N |
| 1 | 15 kHz | 5 MHZ | 25 | ${N}_{m i n} = ⌊ \frac{B {W}_{total}}{B {W}_{channel}} ⌋ + {N}_{overlap}$ |
| 2 | | 10 MHz | 52 | where |
| 3 | | 15 MHZ | 79 | Nₒᵥₑᵣₗₐₚ is defined in |
| 4 | | 20 MHZ | 106 | Equation (3). |
| 5 | 30 kHz | 5 MHZ | 11 | |
| 6 | | 10 MHZ | 24 | |
| 7 | | 15 MHZ | 38 | |
| 8 | | 20 MHZ | 51 | |
| 9 | 60 kHz | 10 MHZ | 11 | |
| 10 | | 15 MHZ | 18 | |
| 11 | | 20 MHZ | 24 | |
| 12 | | 50 MHZ | 66 | |
| 13 | | 100 MHZ | 132 | |
| 14 | 120 kHz | 50 MHZ | 32 | |
| 15 | | 100 MHZ | 66 | |

If a smaller IBW is desired, then an additional column may be added to Table 6. Such an example is shown below in Table 7 in which a smaller IBW configuration is defined. In Table 7, the additional column is shown for B_{SRSp}=1 with IBW equals to m_{SRSp,1}, which is half of M_{SRSp,0}. The number of hops is equal to Nₘᵢₙ×N₁ if the maximum transmission bandwidth m_{SRSp,0} is not divisible by 2, then m_{SRSp,1} is down converted to the next even number, for example, as shown in the rows for C_{SRSp}=1, C_{SRSp}=3, C_{SRSp}=5, C_{SRSp}=8, and C_{SRSp}=9 of Table 7. In such a case, an additional hop may be added to utilize the unused one PRB. In the case of partial frequency-hopping, the unused PRBs can be added to BWₒᵥₑᵣₗₐₚ before Nₒᵥₑᵣₗₐₚ is computed as shown below:

$${N}_{overlap} = ⌈ \frac{( {N}_{min} \times {N}_{1} - 1 ) \times B {W}_{overlap} + B {W}_{unused}}{{m}_{SRSp , 1}} ⌉ \qquad ( 4 )$$

where Nₘᵢₙ defined in Equation (2), N and m_{SRSp,1} are given in Table 7, BWₒᵥₑᵣₗₐₚ is defined in Equation (1), and BW_{unused} is the unused bandwidth in PRBs.

TABLE 7
Flexible IBW configurations for wideband frequency-
hopping RedCap devices

| | | | B_{SRSp} = 0 | | B_{SRSp} = 1 | |
|---|---|---|---|---|---|---|
| C_{SRSp} | SCS | BW_{channel} | m_{SRSp,0} | Nₘᵢₙ = N₀ | m_{SRSp,1} | N₁ |
| 1 | 15 kHz | 5 MHz | 25 → 24 | ${N}_{min} = ⌊ \frac{B {W}_{t o t a l}}{B {W}_{c h a n n e l}} ⌋ N\_overlap ,$ | 12 | 2 |
| 2 | | 10 MHZ | 52 | where Nₒᵥₑᵣₗₐₚ is | 26 | 2 |
| 3 | | 15 MHz | 79 → 78 | defined in Equation (3). | 39 | 2 |
| 4 | | 20 MHZ | 106 | | 53 | 2 |
| 5 | 30 kHz | 5 MHz | 11 → 10 | | 5 | 2 |
| 6 | | 10 MHZ | 24 | | 12 | 2 |
| 7 | | 15 MHZ | 38 | | 14 | 2 |
| 8 | | 20 MHZ | 51 → 50 | | 25 | 2 |
| 9 | 60 kHz | 10 MHZ | 11 → 10 | | 5 | 2 |
| 10 | | 15 MHZ | 18 | | 9 | 2 |
| 11 | | 20 MHZ | 24 | | 12 | 2 |
| 12 | | 50 MHZ | 66 | | 33 | 2 |
| 13 | | 100 MHZ | 132 | | 66 | 2 |
| 14 | | 50 MHZ | 32 | | 16 | 2 |
| 15 | 120 kHz | 100 MHz | 66 | | 33 | 2 |

While the AN 110 may configure the RedCap UE 120a to utilize a smaller or narrower IBW configuration (from the column B_{SRSp}=1 of Table 7), the smaller IBW configuration may lead to an increase in the number of hops, and consequently a longer wideband positioning measurement duration. Thus, it may be desirable for the AN 110 to configure the BW_{channel} (e.g., is equal to 20 MHz) and the minimum number of hops Nₘᵢₙ for selecting other configurations (e.g., BWₒᵥₑᵣₗₐₚ).

If BWₜₒₜₐₗ is not an integer multiple of BW_{channel}, then Nₘᵢₙ in Tables 5 and 6 is incremented by one frequency hop in order to sound the remainder of the total bandwidth. The remainder of the total bandwidth is equal to the IBW of the additional hop, where the IBW is smaller than the BW_{channel}. The IBW of the additional hop is calculated as shown below:

$$IBW = {BW}_{total} - ⌊ \frac{{BW}_{total}}{{BW}_{channel}} ⌋ \times {BW}_{channel} . \qquad ( 5 )$$

As an example, BWₜₒₜₐₗ is set to 100 MHz and BW_{channel} is set to 15 MHz. Because BWₜₒₜₐₗ is not an integer multiple of BW_{channel},

$${N}_{min} = ⌊ \frac{100 MHz}{15 MHz} ⌋ + 1 = 7$$

and Nₒᵥₑᵣₗₐₚ=0, the IBW of the additional hop (e.g., the last hop) is computed as

$$IBW = 100 MHz - ⌊ \frac{100 MHz}{15 MHz} ⌋ \times 15 MHz = 10 MHz$$

according to Equation (5). Alternatively, the hop bandwidth for the additional hop may be the same as the other hops but may overlap with the previous hop (e.g., the next to the last hop). In this case, the total sounded bandwidth is the same (e.g., 100 MHz), but 5 MHz of BWₜₒₜₐₗ is sounded twice. In the case of partial frequency-hopping, the remainder of the total bandwidth can be added to Bₒᵥₑᵣₗₐₚ before Nₒᵥₑᵣₗₐₚ is computed as defined in Equation (4).

As another example, the minimum number of hops can be calculated as shown below:

$${N}_{min} = ⌈ \frac{{BW}_{total}}{{BW}_{channel}} ⌉ . \qquad ( 6 )$$

In this example, it is not necessary to increment Nₘᵢₙ by one. If BWₜₒₜₐₗ is not an integer multiple of BW_{channel}, the IBW for one of the Nₘᵢₙps is computed using Equation (5). In the case of partial overlapping frequency-hopping, an additional Nₒᵥₑᵣₗₐₚ hops are added to Equation (6).

As another example, BWₜₒₜₐₗ is set to 100 MHz and BW_{channel} is set to 20 MHz. For this example, BWₜₒₜₐₗ is an integer multiple of BW_{channel}, the minimum number of hops Nₘᵢₙ

$${N}_{min} = ⌊ \frac{100 MHz}{20 MHz} ⌋ = ⌊ \frac{100 MHz}{20 MHz} ⌋ = 5$$

and Nₒᵥₑᵣₗₐₚ=0. In the case of partial overlapping frequency-hopping with BWₒᵥₑᵣₗₐₚ=1 PRB and SCS=15 kHz, an additional number of hops can be computed according to Equation (3) as

$${N}_{overlap} = ⌈ \frac{( 5 - 1 ) \times {BW}_{overlap} = 1}{{m}_{SRSp , 0} = 25} ⌉ = 1 .$$

Therefore, the number of hops N is N=(Nₘᵢₙ=5)+(Nₒᵥₑᵣₗₐₚ=1)=6 hops.

While Tables 6 and 7 illustrate a complete IBW configuration of SRS resources for positioning, in other examples, not all the configuration parameters (such as BW_{channel} and SCS) may be specified in the specification of the instantaneous SRS bandwidth configuration. In one embodiment, it may be sufficient to specify the maximum transmission bandwidth m_{SRSp,0} for wideband frequency-hopping RedCap transmitters. Further, while the IBW configuration is discussed in the context of uplink SRS, such a configuration is applicable for downlink PRS measurements.

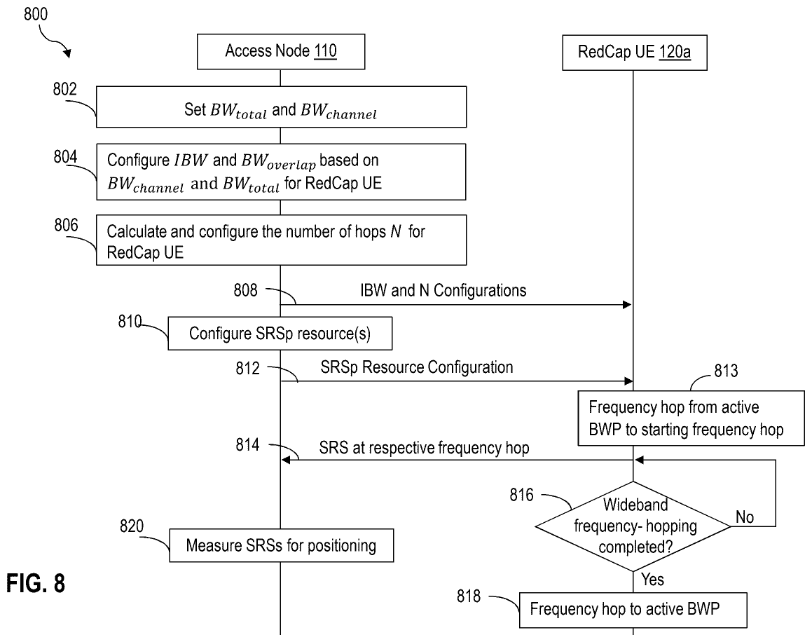

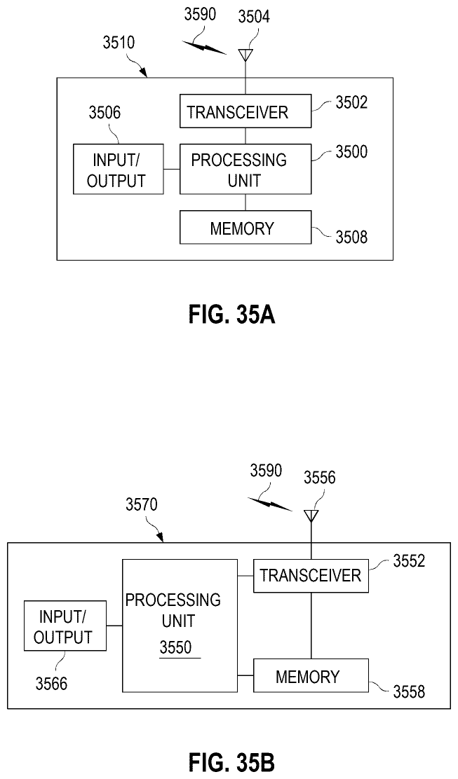

FIG. 8 is a signaling diagram of an example method 800 for transmitting SRSs with wideband frequency-hopping (outside of an active BWP of the RedCap UE 120a) according to an embodiment of the present disclosure. The method 800 illustrates operations performed by the AN 110 and the RedCap UE 120a. The method 800 may utilize similar mechanisms as discussed above with reference to FIGS. 3-7. In embodiments, the AN 110 may implement the operations of the method 800 using a computer system with components as shown in FIGS. 35B and/or 36, and the RedCap UE 120a may implement the operations of the method 800 using a computer system with components as shown in FIGS. 35A and/or 36. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At operation 802, the AN 110 configures or sets BWₜₒₜₐₗ and BW_{channel}. The AN 110 may set BWₜₒₜₐₗ based on a desired wideband for positioning and may set BW_{channel} based on a maximum bandwidth supported by the RedCap UE 120a. In an example, BWₜₒₜₐₗ may be 100 MHz and BW_{channel} may be 20 MHz.

At operation 804, the AN 110 configures IBW based on BWₜₒₜₐₗ and BW_{channel} configured for the RedCap UE 120a at operation 802. The IBW may be calculated according to Equation (5) discussed above.

At operation 806, the AN 110 calculates and configures the number of hops N for the RedCap UE 120a, for example, according to Equations (2)-(4) and/or (6) discussed above depending on whether non-overlapping frequency-hopping (e.g., the non-overlapping frequency-hopping pattern 310) or partial overlapping frequency-hopping (e.g., the partial overlapping frequency-hopping pattern 320) is used.

At operation 808, the AN 110 transmits, and the RedCap UE 120a receives the IBW and N configurations. These configurations can be radio resource control (RRC) configurations. The configurations may also include other frequency-hopping related information, for example, including but not limited to, starting frequency locations for the hops and corresponding IBWs, for example, as discussed above with reference to FIGS. 3-7.

In an embodiment, the AN 110 may configure the RedCap UE 120a with a sequence of hops and the number of PRBs to use for each hop. As an example, for the non-overlapping frequency-hopping pattern 310 of FIG. 3, the AN 110 may configure the RedCap UE 120a with a beginning hop 314a starting at CRB #0 and use an IBW of 106 PRBs (a smaller number may also be provided or configured); a next hop 314b starting at CRB #108 and use an IBW of 106 PRBs; and a last hop 314c starting at CRB #216 and use an IBW of 50 PRBs (for a 10 MHz channel as the last hop). As another example, for the partial overlapping frequency-hopping pattern 320 of FIG. 3, the AN 110 may configure the RedCap UE 120a with a beginning hop 324a starting at CRB #0 and use an IBW of 106 PRBs (a smaller number may also be provided or configured); a next hop 324b starting at CRB #80 and use an IBW of 106 PRBs; and a last hop 324c starting at CRB #164 and use an IBW of 106 PRBs. The configuration may include a hopping order, for example, indicated by {0, 108, 216} for frequency-hopping in an increasing frequency order or {216, 0, 108} for frequency-hopping in a decreasing frequency order. In general, the frequency hops in a frequency-hopping pattern can be arranged in any suitable order.

In another embodiment, the configuration may include a table including the starting frequency locations and corresponding bandwidths (e.g., the transmission bandwidth 306, the guard band 304, and/or the IBW 504) in PRBs for various RedCap channel bandwidths and wideband frequency-hopping bandwidths as a function of numerology. The AN 110 may configure the RedCap UE 120a to use a particular row in the table and be informed of the hopping pattern. For example, a row in the table may include 50-6-50-6-49-6-50-6-50. That is, the starting frequency locations 0, 56, 112, 167, 223 with IBWs of 50, 50, 49, 50, 50 PRBs for channels or hops 0, 1, 2, 3, and 4, respectively. The RedCap UE 120a can be configured to hop in the order of channels or hops 3, 2, 0, 4, and 1. Another RedCap UE can be configured to hop in the order of channels or hops 0, 3, 1, 2, and 4. One of the benefits of using such a lookup table is that the AN 110 (the network) can control the hopping (the size of the IBW) and the frequency resources instead of limited to the same IBW size for each hop.

In an embodiment, the AN 110 may transmit Downlink Control Information (DCI) to trigger or signal the RedCap UE 120a to hop. In another embodiment, the AN 110 may transmit a Medium Access Control-Control Element (MAC-CE) to indicate hopping configuration information to the RedCap UE 120a. In general, the AN 110 may signal hopping information for wideband positioning via any suitable higher layer signaling.

At operation 810, the AN 110 configures SRSp resource(s) for the RedCap UE 120a for positioning (e.g., using the configuration 500, 600, or 700 discussed above with reference to FIG. 5, 6, or 7, respectively).

At operation 812, the AN 110 transmits, and the RedCap UE 120a receives the SRSp resource configuration (e.g., including the c-SRS-r16 parameter).

In an example, the RedCap UE 120a may initially operate in an active BWP as configured by the AN 110. That is, the RedCap UE 120a may receive the IBW and N configurations at operation 808 and the SRSp resource configuration at operation 812 while the RedCap UE 120a operates in the active BWP. Accordingly, at operation 813, the RedCap UE 120a may hop from the active BWP to a frequency location of the starting frequency hop of the frequency-hopping pattern as configured by the IBW and N configurations.

At operation 814, the RedCap UE 120a transmits, and the AN 110 receives an SRS at a respective frequency hop according to the IBW and N configurations (at operation 808) the SRSp resource configuration (at operation 812).

At operation 816, the RedCap UE 120a determines whether the wideband frequency-hopping is completed (e.g., checking if the RedCap UE 120a has hopped through all the number of hops N indicated at 808). If the RedCap UE 120a determines that frequency-hopping is not completed, the RedCap UE 120a returns to operation 814 and transmits an SRS at a next hop (e.g., by frequency-hopping to the next hop). Otherwise, the RedCap UE 120a proceeds to operation 818. Stated differently, the RedCap UE 120a may determine whether to continue the SRS transmission at operation 814 based on whether the wideband frequency-hopping is completed. It should be noted that because the RedCap UE 120a is not operating within the RedCap UE 120a's active BWP while performing operations 814 and 816 (for SRS transmission with frequency-hopping), the RedCap UE 120a is unable to receive any signal from the AN 110 or transmit any signal to the AN 110 except for the SRSs.

At operation 818, the RedCap UE 120a frequency-hops back to the active BWP of the RedCap UE 120a.

At operation 820, the AN 110 may measure each SRS received at a respective hop at operation 814 for positioning the RedCap UE 120a. After the AN 110 receives SRSs from all the hops, the AN 110 may calculate a position of the UE based on the measurements (e.g., ToA and AoA).

While the method 800 is discussed in the context of SRS transmissions by the RedCap UE 120a, the hopping configurations discussed above at 802, 804, 806, and 808 are applicable to PRS reception at the RedCap UE 120a. That is, the AN 110 may configure the RedCap UE 120a with the same hopping configuration for SRS transmissions and PRS receptions.

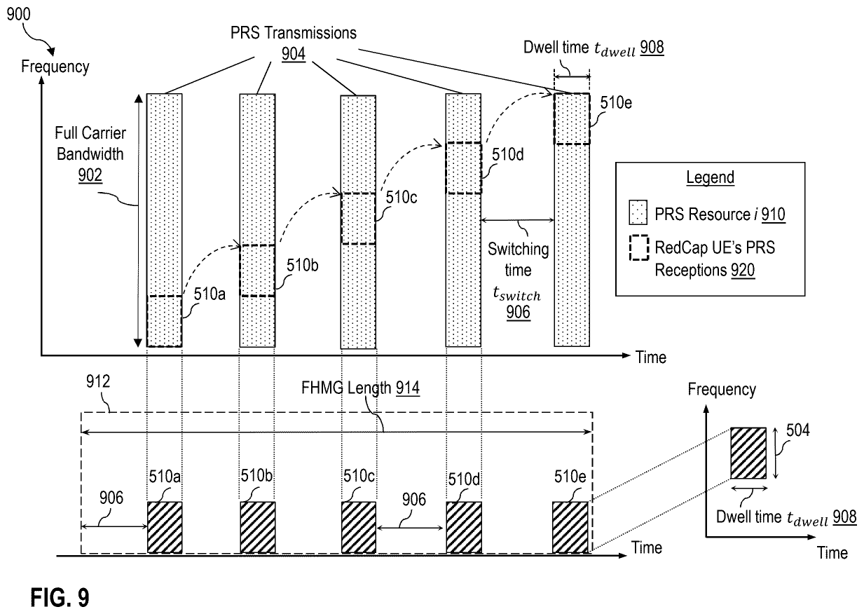

FIG. 9 illustrates an example PRS measurement configuration 900 for wideband frequency-hopping according to an embodiment of the present disclosure. The AN 110 may configure the RedCap UE 120a for PRS measurements using the PRS measurement configuration 900. In FIG. 9, the top portion illustrates PRS transmissions 904 by the AN 110 and PRS receptions 920 by the RedCap UE 120a, and the bottom portion illustrates a PRS measurement window or gap during which the PRS measurements are performed by the RedCap UE 120a. In FIG. 9, the vertical axis may represent frequency in some arbitrary units, and the horizontal axis may represent time in some arbitrary units. For simplicity, FIG. 9 is discussed using the same wideband frequency-hopping configuration as shown in FIG. 5 and may use the same reference numerals as in FIG. 5 to refer to the same elements.

As shown in FIG. 9, the AN 110 (e.g., gNodeB) transmits one downlink PRS resource 910 (e.g., PRS Resource i, which may be an ith configuration of PRS resources) at a fixed interval. The PRS resource 910 may be configured for one or more frequency-hopping RedCap devices (including the RedCap UE 120a), spanning the full carrier bandwidth 902 BWₜₒₜₐₗ, which is wider than the IBW of the RedCap UE 120a's receiver, for positioning. The hop switching time 906, denoted as denoted as t_{switch}, is defined as the RF retuning delay for the RedCap UE 120a's receiver to change from one carrier frequency to another carrier frequency. The instantaneous dwell time 908, denoted as t_{dwell}, corresponds to the duration of one PRS resource 910 in the time domain, which may be in terms of the number of OFDM symbols for a given numerology (or SCS). In an embodiment, the full carrier bandwidth 902, the hop switching time 906, and the instantaneous dwell time 908 may be the same as the total frequency-hopping bandwidth 502, the hop switching time 506, and the instantaneous dwell time 508, respectively. That is, the AN 110 may configure the same wideband frequency-hopping configuration for downlink PRS measurements and uplink SRS transmissions.

The AN 110 may configure the RedCap UE 120a with a frequency-hopping measurement gap (FHMG) 912 for PRS measurements. To perform wideband positioning measurements, the RedCap UE 120a's receiver hops within the FHMG 912 according to the hops 510a, 510b, 510c, 510d, and 510e as shown by the dashed arrows. At each of the hops 510a, 510b, 510c, 510d, and 510c, the RedCap UE 120a may receive a portion of a respective PRS transmission 904 in a respective hop 510 as shown by PRS receptions 920. The RedCap UE 120a may perform measurements (e.g., ToA, AoA, reference signal time difference (RSTD), etc.) on the PRS receptions 920. Because frequency-hopping is used where the RedCap UE 120a may switch a carrier frequency for each hop 510 (where the carrier frequency may be at about the center of each respective hop 510), the PRS receptions 920 at the RedCap UE 120a may simply be a PRS signal portion spanning a frequency corresponding to the IBW 504 and a duration corresponding to the dwell time 908 as shown in the bottom portion of FIG. 9.

The FHMG 912 may include all the hops 510 (including 510a, 510b, 510c, 510d, and 510e) in a single instance or multiple instances so that the RedCap UE 120a's measurements may cover the entire full carrier bandwidth 902. The FHMG length 914 (a duration of the FHMG 912), denoted as T_{FHMG}, is proportional to the number of hops 510, which can be determined using the same techniques as described above. For instance, the FHMG length 914 T_{FHMG} can be expressed as shown below:

$${T}_{FHMG} = N \times {t}_{switch} + N \times {t}_{dwell} , \qquad ( 7 )$$

where N is the number of frequency hops. Note Equation (7) includes an additional term t_{switch} to account for the RF retuning of the RedCap UE 120a's receiver on the left edge (the earliest time) of the FHMG 912 (or before the first frequency hop 510a commences, e.g., during which the RedCap UE 120a operates in an initial or active BWP of the RedCap UE 120a). Stated differently, the FHMG length 914 T_{FHMG} is dependent (or based) on a first time gap (e.g., t_{switch}) for frequency-hopping from one frequency location (e.g., one hop) to another frequency location (e.g., a next hop), a duration (e.g., t_{dwell}) of an individual reference signal transmission, a number of frequency hops (e.g., N) within a bandwidth for positioning (e.g., full carrier bandwidth 902), and a second time gap for frequency-hopping from the initial or active BWP to the earliest hop. In some instances, Equation (7) can be modified to include another switch time to account for the time to hop from the last frequency hop 510e to the active BWP. In some instances, Equation (7) can include a first value for the switch time between the active BWP and the first hop 510a and/or between the active BWP and the last hop 510e and a second value for the switch time between adjacent hops 510. The number of hops N can be computed using the same techniques as discussed above for the case of non-overlapping and overlapping frequency-hopping, for example, N=Nₘᵢₙ+Nₒᵥₑᵣₗₐₚ here Nₘᵢₙ is defined in Equations (2) or (6), and Nₒᵥₑᵣₗₐₚ is defined in Equation (3) or Equation (4).

An example of the FHMG length 914 based on the number of hops N, the channel bandwidth BW_{channel} (e.g., IBW 504), and the total bandwidth BWₜₒₜₐₗ (e.g., the full carrier bandwidth 902) is shown in Table 8, assuming t_{switch}=100 μs (e.g., the switching time 906) and t_{dwell}=1 OFDM symbols (e.g., the dwell time 908) which may depend on the SCS.

TABLE 8
Example of FHMGs

| SCS | BW_{channel} | BWₜₒₜₐₗ | N = Nₘᵢₙ | T_{FHMG} |
|---|---|---|---|---|
| 15 kHz | 5 MHz | 100 MHz | 20 | 3.5 ms |
| | 10 MHz | | 10 | 1.8 ms |
| | 15 MHz | | 7 | 1.2 ms |
| | 20 MHz | | 5 | 0.9 ms |
| 30 kHz | 5 MHz | 100 MHz | 20 | 2.7 ms |
| | 10 MHz | | 10 | 1.4 ms |
| | 15 MHz | | 7 | 0.7 ms |
| | 20 MHz | | 5 | 0.7 ms |
| 60 kHz | 10 MHz | 100 MHz | 10 | 1.2 ms |
| | 15 MHz | | 7 | 0.8 ms |
| | 20 MHz | | 5 | 0.6 ms |
| 120 kHz | 50 MHz | 400 MHz | 8 | 0.9 ms |
| | 100 MHz | | 4 | 0.4 ms |

Table 9 shows an example of FHMG configurations starting with the minimum and increasing with a step size of 0.5 ms. The step size is obtained from the smallest FHMG length 914 which is 0.4 ms in Table 8 and quantized to 0.5 ms. In another embodiment, the step size can be expressed in terms of an integer multiple of OFDM symbol duration. In one embodiment, the instantaneous dwell time 908 t_{dwell} is equal to one OFDM symbol.

TABLE 9
Example of FHMG Pattern Configurations

| FHMG Pattern | T_{FHMG} |
|---|---|
| 1 | 0.5 ms |
| 2 | 1.0 ms |
| 3 | 1.5 ms |
| 4 | 2.5 ms |
| 5 | 3.0 ms |
| 6 | 3.5 ms |

In one embodiment, the hop switching time 906 t_{switch} is expressed as an integer multiple of the OFDM symbol duration so that the instantaneous dwell time 908 is aligned with the OFDM symbol timing of the downlink frame. If the hop switching time 906 is not an integer multiple of the OFDM symbol duration, then the hop switching time 906 is rounded up the nearest number of OFDM symbols. In some examples, multiple instances of the FHMG 912 may be used if one instance cannot accommodate all the frequency hops 510 for a given wideband measurement.

In embodiments, the FHMG 912 is configured by the AN 110 (cellular base station) for a RedCap UE 120a depending on the RedCap UE 120a's capability. It may be desirable for the RedCap UE 120a to complete the frequency-hopping within the configured FHMG 912. If the positioning measurement delay is too long, then measurement samples may be outdated, which may degrade positioning accuracy. Thus, the maximum FHMG 912 may be specified by the AN 110. While the configuration 900 is designed for downlink PRS, such a configuration method is applicable to the SRS resource configuration for positioning. For instance, the RedCap UE 120a may be configured, via higher layer parameters, subject to UE capability, with an uplink time window (e.g., similar to the FHMG 912) where the UE is not expected to transmit any signals/channels aside from SRSs for positioning using frequency hopping.

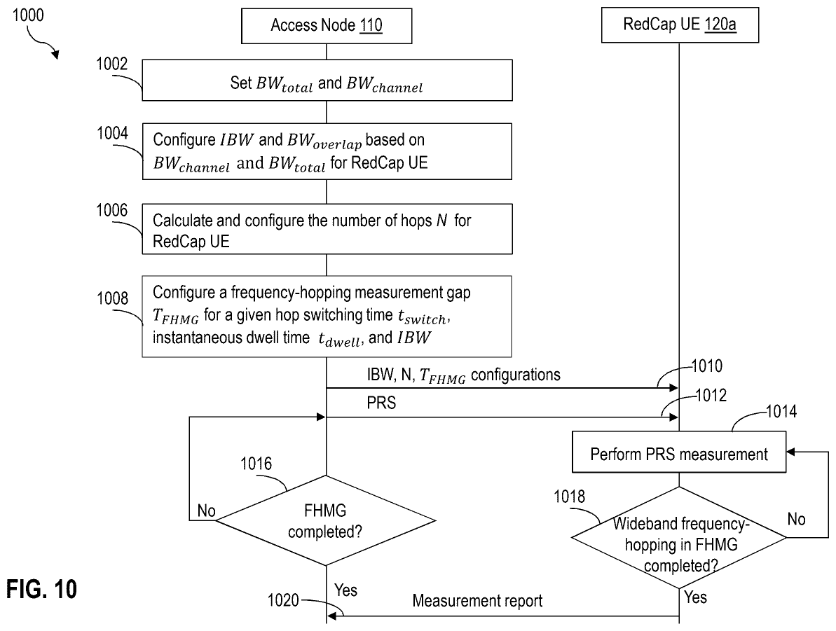

FIG. 10 is a signaling diagram of an example method 1000 for measuring PRSs with wideband frequency-hopping according to an embodiment of the present disclosure. The method 1000 illustrates operations performed by the AN 110 and the RedCap UE 120a. The method 1000 is discussed in connection to FIG. 9 and may utilize similar mechanisms as discussed above with reference to FIGS. 3-9. In embodiments, the AN 110 may implement the operations of the method 1000 using a computer system with components as shown in FIGS. 35B and/or 36, and the RedCap UE 120a may implement the operations of the method 1000 using a computer system with components as shown in FIGS. 35A and/or 36. As illustrated, FIG. 10 includes a number of enumerated operations, but embodiments of the operations in FIG. 10 may include additional operations before, after, and in between the enumerated operations. In some embodiments, one or more of the enumerated operations may be omitted or performed in a different order.

Generally speaking, the method 1000 includes features similar to method 800 in many respects. For example, operations 1002, 1004, and 1006 are similar to 802, 804, and 806, respectively. Accordingly, for brevity, details of those operations will not be repeated here.

At operation 1008, the AN 110 configures a FHMG 912 with a FHMG length 914 T_{FHMG} for a given hop switching time 906, instantaneous dwell time 908, and IBW (e.g., according to Equation (7)). In an embodiment, the hop switching time 906 may be provided by the RedCap UE 120a to the AN 110. For instance, the RedCap UE 120a may transmit an indication of a time gap (e.g., a RF tuning delay) for frequency-hopping from a first frequency location (of a first carrier frequency, e.g., associated with the hop 510a) to a second frequency location (of a second carrier frequency, e.g., associated with the hop 510b).

At operation 1010, the AN 110 transmits, and the RedCap UE 120a receives the configurations for the IBW, N, and T_{FHMG}. For example, the configurations may indicate a frequency-hopping pattern and a FHMG similar to the configuration 900 discussed above with reference to FIG. 9. The RedCap UE 120a may perform a frequency hop from the active BWP to the location of the first hop (the earliest hop in time).

At operation 1012, the AN 110 transmits a PRS (across the full carrier bandwidth 902), and the RedCap UE 120a receives a portion of the PRS in a respective hop according to the configurations at operation 1010.

At operation 1014, the RedCap UE 120a performs measurements (e.g., ToA, AoA, RSTD, etc.) on the received PRS portion.

At operation 1018, the RedCap UE 120a determines whether the wideband frequency-hopping in the configured FHMG is completed (e.g., checking if the RedCap UE 120a has hopped through all the number of hops N in the FHMG indicated at 1010). If the RedCap UE 120a determines that the wideband frequency-hopping is not completed, the RedCap UE 120a returns to operation 1014 and continues with PRS measurement for a next hop (e.g., by frequency-hopping to the next hop). Stated differently, the RedCap UE 120a may determine whether to continue the PRS measurement at operation 1018 based on whether the wideband frequency-hopping is completed.

At operation 1016, the AN 110 determines whether the FHMG is completed. If the AN 110 determines that the FHMG is not completed, the AN 110 returns to operation 1012 and transmits another PRS.

If the RedCap UE 120a determines that the frequency-hopping is completed at operation 1018, the RedCap UE 120a proceeds to operation 1020. The RedCap UE 120a may perform a frequency hop from location of the last hop to the active BWP. At operation 1020, the RedCap UE 120a transmits, and the RedCap UE 120a receives a measurement report. The measurement report may include the PRS measurements performed at operation 1014.

If the AN 110 determines that the FHMG is completed at operation 1016, the AN 110 proceeds to operation 1020 to receive the measurement report. Subsequently, the AN 110 may determine a geographical location of the RedCap UE 120a based on the measurements in the measurement report (e.g., using trilateration or triangulation techniques or any suitable techniques known in the art).

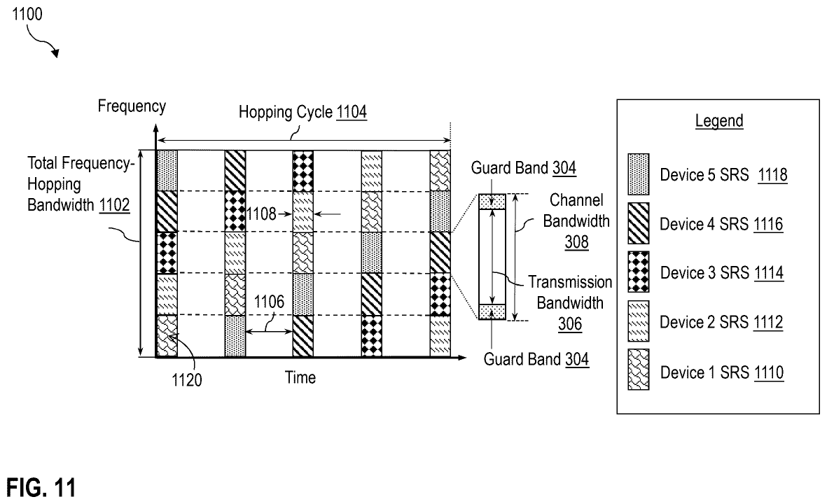

In embodiments, the AN 110 may multiplex several RedCap devices similar to the RedCap UE 120a for positioning or localization with wideband frequency-hopping in a non-overlapping staircase pattern as shown in FIGS. 11-13.

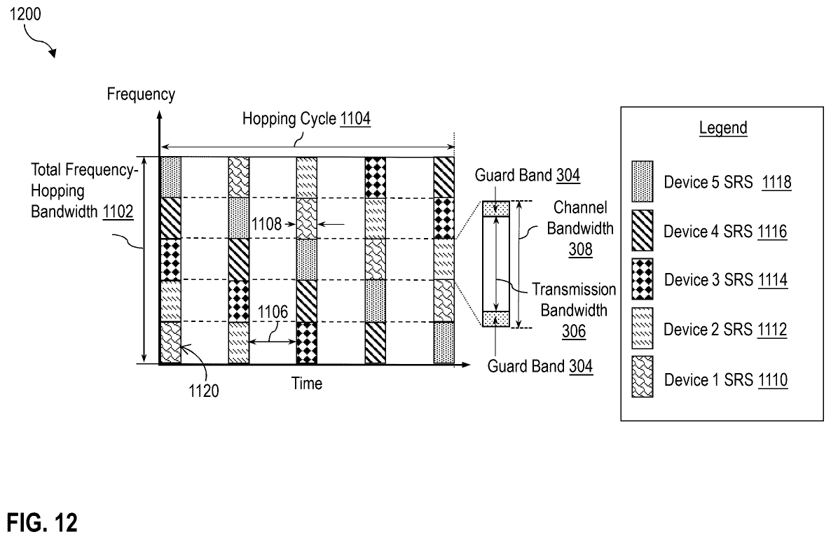

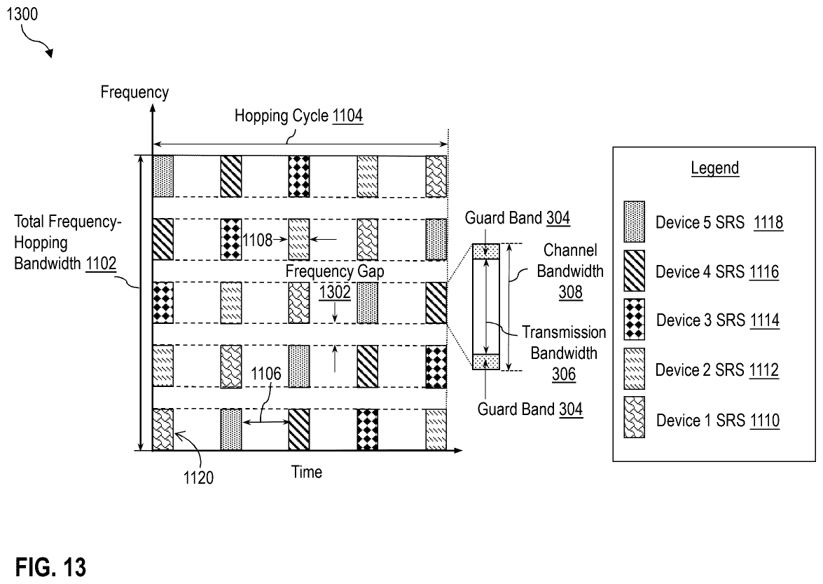

FIG. 11 illustrates an example multi-user configuration 1100 for non-overlapping staircase wideband frequency-hopping (in an increasing frequency order) according to an embodiment of the present disclosure. FIG. 12 illustrates an example multi-user configuration 1200 for non-overlapping staircase wideband frequency-hopping (in a decreasing frequency order) according to an embodiment of the present disclosure. FIG. 13 illustrates an example multi-user configuration 1300 for non-overlapping staircase wideband frequency-hopping with non-contiguous bandwidth allocation according to an embodiment of the present disclosure. In FIGS. 11-13, the vertical axes may represent frequency in some arbitrary units, and the horizontal axes may represent time in some arbitrary units. FIGS. 11-13 are discussed using the same channel structure as FIG. 3 and may use the same reference numerals as in FIG. 3 to refer to the same elements. Additionally, FIGS. 11-13 illustrate frequency multiplexing for five frequency-hopping RedCap devices (e.g., Device 1, Device 2, Device 3, Device 4, and Device 5). In an example, the RedCap UE 120a may correspond to one of the Device 1 to Device 5.

With the non-overlapping frequency-hopping method, each hopping occasion takes place in a different (or orthogonal) portion of the wide bandwidth of a frequency-hopping RedCap device. This means, there is no overlapping in frequency REs occupied by different hops within a frequency-hopping cycle.

As shown in FIG. 11, the configuration 1100 includes a non-overlapping frequency-hopping pattern for five frequency-hopping RedCap devices (Device 1 to Device 5) in a hopping cycle 1104. The SRS transmissions for positioning from the different devices are shown by different patterned boxes or blocks and labelled with different reference numerals. As shown, the SRS transmissions from Device 1, Device 2, Device 3, Device 4, and Device 5 are labelled with 1110, 1112, 1114, 1116, and 1118, respectively.

In the illustrated example of FIG. 11, the total frequency-hopping bandwidth 1102 for positioning is 100 MHz (e.g., for FR1), which is greater than the maximum channel bandwidth of 20 MHz supported by FR1 RedCap devices. The configuration 1100 may configure each device with the same IBW (the channel bandwidth 308) per hop, where the per-hop IBW is 20 MHz corresponding to the maximum channel bandwidth of FR1 RedCap devices. For the AN 110 (the network) to measure the 100 MHz total frequency-hopping bandwidth 1102 and the per-hop IBW being 20 MHz, the configuration 1100 includes five hops for each device. A positioning SRS transmission (from each device) may take place at a different time in each hop. The configuration 1100 also configures each device with the same hop switching time 1106 and same hop dwell time 1108. As such, five hops 1120 allow positioning SRS transmissions from five different RedCap devices (Device 1 to Device 5) to be frequency multiplexed within the total frequency-hopping bandwidth 1102 of 100 MHz, where each RedCap device is assigned with a disjoint portion (or block) of the total frequency-hopping bandwidth 1102 as illustrated in FIG. 11. For case of illustration, FIG. 11 only shows the reference numeral 1120 for the first hop of Device 1, the reference numeral 1106 for the hop switching time between the second and third hops, and the reference numeral 1108 for the hop dwell time for the third hop of Device 2. In an embodiment, the total frequency-hopping bandwidth 1102, the hop switching time 1106, and the hop dwell time 1108 may correspond to the total frequency-hopping bandwidth 502, the hop switching time 506, and the hop dwell time 508, respectively.

As can be observed in FIG. 11, the frequency-hopping pattern for Device 1 is a continuous ascending staircase in time while the frequency-hopping pattern for Device 2 to Device 5 is a wrapped ascending staircase in time. Stated differently, for frequency hops 1120 with an ascending staircase pattern in time, a frequency location of a first frequency hop 1120 of the frequency hops 1120 is higher than a frequency location of a previous (consecutive) adjacent frequency hop 1120 of the frequency hops 1120. For instance, in the first hop 1120 for Device 1, the index of the last PRB may be indicated as PP, and in the next hop 1120, the index of the first PRB is PP+1. Additionally, for frequency hops 1120 with a wrapped ascending staircase pattern in time, a frequency location of a highest-frequency frequency hop 1120 of the frequency hops 1120 is adjacent to and prior to a lowest-frequency frequency hop 1120 of the frequency hops 1120 in time.

FIG. 12 illustrates the configuration 1200, which may be substantially similar to the configuration 1100 of FIG. 11 and may use the same reference numerals as FIG. 11 to refer to the same elements. For instance, the configuration 1200 may have the same total frequency-hopping bandwidth 1102, the same number of hops 1120, and the same hopping bandwidth 308, the same hop switching time 1106, and the same hop dwell time 1108 as the configuration 1100. However, instead of an ascending staircase as in the configuration 1110, the configuration 1200 configures Device 1 to Device 5 with a staircase frequency-hopping pattern that is descending in time. As can be observed in FIG. 12, the frequency-hopping pattern for Device 5 is a continuous descending staircase while the frequency-hopping patterns for Devices 1 to Device 4 are wrapped descending staircases. Stated differently, for frequency hops 1120 with a descending staircase pattern in time, a frequency location of a first frequency hop 1120 of the frequency hops 1120 is lower than a frequency location of a previous adjacent frequency hop 1120 of the frequency hops 1120. For instance, in the first hop 1120 for Device 5, the index of the last PRB may be indicated as PP, and in the next hop 1120, the index of the first PRB is PP−1. Additionally, for frequency hops with a wrapped descending staircase pattern in time, a frequency location of a highest-frequency frequency hop 1120 of the frequency hops 1120 is adjacent to and subsequent to a lowest-frequency frequency hop 1120 of the frequency hops 1120 in time.

In FIGS. 11 and 12, the total frequency-hopping bandwidth 1102 allocated for wideband frequency-hopping RedCap devices is contiguous. In other words, there are no frequency gaps between adjacent hops 1120 in the frequency spectrum. In another embodiment, the non-overlapping frequency-hopping method can support such RedCap devices to hop over a non-contiguous wide bandwidth as shown in FIG. 13.

FIG. 13 illustrates the configuration 1300 having an ascending staircase frequency-hopping pattern, which may be substantially similar to the configuration 1100 of FIG. 11, and may use the same reference numerals as FIG. 11 to refer to the same elements. However, there is a frequency gap 1302 between adjacent hops 1120. For case of illustration, FIG. 13 only shows the reference numeral 1302 for one of frequency gaps. With a total of five hops 1120 across the total frequency-hopping bandwidth 1102, there are four frequency gaps 1302, which may or may not be equal. The other configuration parameters such as the number of hops 1120, the hopping bandwidth or channel bandwidth 308, the hop switching time 1106 and the hop dwell time 1108 of the wideband RedCap device be the same as the configuration 1100 of FIG. 11 and the configuration 1200 of FIG. 12. However, for the same total frequency-hopping bandwidth 1102, the guard bands 304 and the channel bandwidth 308 for each hop 1120 may be narrower in the configuration 1300 than in the configuration 1100 of FIG. 11 because of the frequency gaps 1302.

In FIG. 13, in the first hop 1120 for Device 1, the index of the last PRB can be indicated as P. In the next hop 1120, the index of the first PRB is P+1+g, where g represents the number of PRBs in the frequency gap 1302. With this notation, the value for g is 0 in the configuration 1100 of FIG. 11.

While FIG. 13 is illustrated for wideband frequency-hopping with an ascending staircase pattern, the configuration 1300 may also be applicable to wideband frequency-hopping with a descending staircase pattern similar to FIG. 12.

In FIGS. 11-13, the IBW (or the bandwidth 308 per hop 1120) is limited by the channel bandwidths of the RedCap devices (e.g., as shown above in Table 1 for FR1 and Table 2 for FR2). As discussed above with reference to FIG. 3, a given RedCap device's channel bandwidth 308 may include two parts, namely the transmission bandwidth 306 and the guard bands 304. The transmission bandwidth 306, which is utilized to carry SRS for positioning, is defined in terms of the number of PRBs, denoted as N_{RB}, (e.g., as shown above in Table 1 for FR1 and Table 2 for FR2) and the guard bands 304 are defined in kilohertz (e.g., as shown above in Table 3 for FR1 and Table 4 for FR2). Additionally, for a RedCap device to perform frequency-hopping over a wide bandwidth, the configured RedCap device's channel bandwidth 308 is to align with the configured total frequency-hopping bandwidth 1102 for positioning over a wideband.

In embodiments, the AN 110 may configure the RedCap UE 120a to perform wideband frequency-hopping for positioning with per hop channel bandwidth 308 aligned to a total frequency-hopping bandwidth 1102 as shown in FIGS. 14-16.

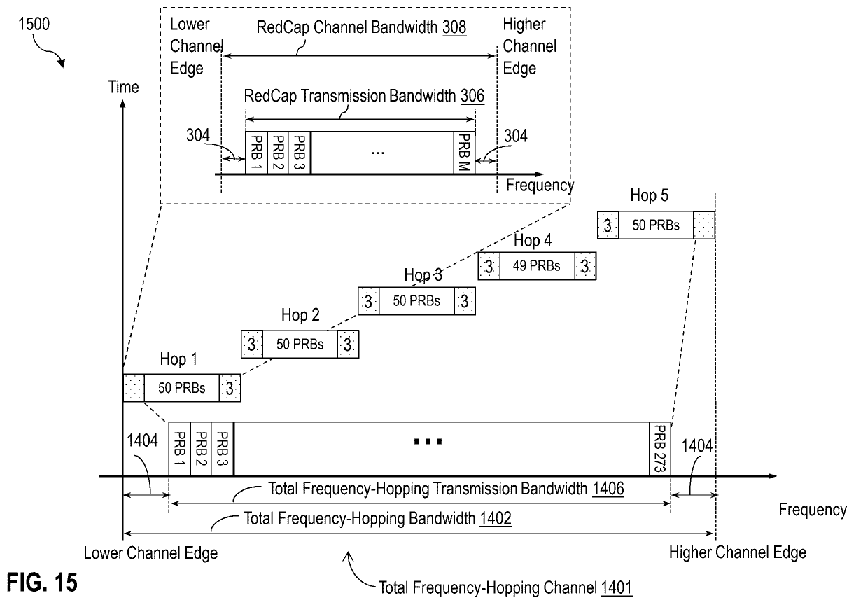

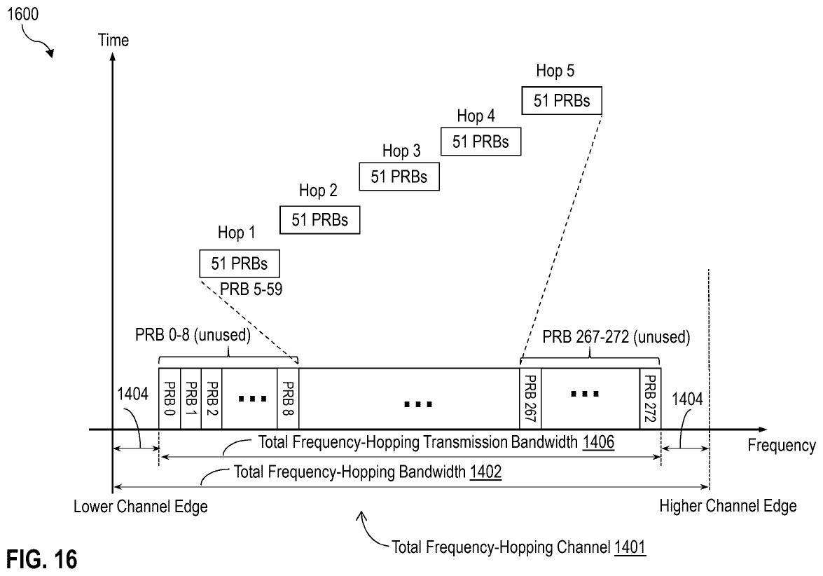

FIG. 14 illustrates an example configuration 1400 for aligning a RedCap device's channel bandwidth to a wideband frequency-hopping bandwidth according to an embodiment of the present disclosure. FIG. 15 illustrates an example configuration 1500 for aligning a RedCap device's channel bandwidth to a wideband frequency-hopping bandwidth according to an embodiment of the present disclosure. FIG. 16 illustrates an example configuration 1600 for aligning a RedCap device's channel bandwidth to a wideband frequency-hopping bandwidth according to an embodiment of the present disclosure. In FIGS. 14-16, the vertical axes may represent time in some arbitrary units, and the horizontal axes may represent frequency. As shown in FIGS. 14-16, a wideband channel may have a total frequency-hopping bandwidth 1402 including a total frequency-hopping transmission bandwidth 1406 and a guard band 1404 on each channel edge (the lower channel edge and the high channel edge). The total frequency-hopping transmission bandwidth 1406 is shown in units of PRBs. The PRB numbering can begin from 1 to N or from 0 to N-1. For instance, the PRBs in the total frequency-hopping transmission bandwidth 1406 are numbered from 1 to N in FIG. 14, from 1 to 273 in FIG. 15, and from 0 to 272 in FIG. 16. The guard bands 1404 may be in units of hertz. Additionally, FIGS. 14-15 illustrate the RedCap channel (per hop channel) using the same channel structure 1402. The frequency hops may be similar to the hops 314, 324, 510, and 1120. Each of the frequency hops may have a channel structure as discussed above with reference to FIGS. 3 and 4. For case of illustration, FIG. 14 only shows an expanded view of the channel structure for Hop 1. The lower channel edge of the first hop (Hop 1) coincides with the lower channel edge of the total frequency-hopping channel 1401. While FIG. 14 illustrates the first hop beginning at the first PRB of the total frequency-hopping channel, the first hop can begin at an offset (e.g., configured by the network) from the lower channel edge.

In this first approach (shown in FIG. 14), the total frequency-hopping bandwidth 1402 is restricted to one of the legacy non-RedCap channel bandwidths. This restriction can be a drawback if the total frequency-hopping bandwidth 1402 does not match any of the legacy non-RedCap channel bandwidths. For instance, a 100 MHz channel is not defined for the legacy non-RedCap channel bandwidth for the 15 kHz SCS, where the transmission bandwidth configuration is

$${N}_{RB}^{FH} = 273 PRBs$$

(See Table 10, which may be specified in 3GPP document TS 38.101-1). The RedCap device's bandwidth per hop is 20 MHz. For the 100 MHz channel, the guard band is 845 kHz (see Table 10) and 805 kHz (see Table 3) for the 100 MHz channel and the 20 MHz channel, respectively.

TABLE 10
Non-RedCap Device's Channel Bandwidth of 100 MHz

| | 100 MHz Non-RedCap Channel Bandwidth | |
|---|---|---|
| SCS (kHz) | $Transmission Bandwidth {N}_{R B}^{F H}$ | Guard Band |
| 30 | 273 PRBs | 845 kHz |

In a second approach, the first PRB (or PRB 1) of a non-RedCap channel may align with the first PRB (or PRB 1) of a first hop (e.g., Hop 1) of a RedCap channel as shown in FIG. 15.

FIG. 15 illustrates the configuration 1500 for alignment between a RedCap device's channel bandwidth and a 100 MHz non-RedCap channel (the total frequency-hopping channel 1401) with an SCS of 30 kHz. As shown in FIG. 15, the total frequency-hopping transmission bandwidth 1406 has 273 PRBs (shown as PRB 1 to PRB 273). To measure the 100 MHz channel bandwidth, the minimum number of hops is five since the RedCap device's bandwidth (the RedCap channel bandwidth 308) per hop is 20 MHz. The five hops are shown as Hop 1, Hop 2, Hop 3, Hop 4, and Hop 5 arranged in an ascending staircase pattern similar to the configuration 1400 of FIG. 14. The first PRB (or PRB 1) of the non-RedCap 100 MHz channel, which begins at 845 kHz from the lower channel edge, serves as a reference for the wideband frequency-hopping RedCap device. PRB 1 of the 100 MHz channel is aligned with PRB 1 of Hop 1 (the 20 MHz channel for the RedCap device), PRB 2 is aligned with PRB 2 of Hop 1, and so on until PRB 273 is aligned with the last PRB of Hop 5, resulting in the number of PRBs per hop as shown in FIG. 15. For Hop 1, the 805 kHz guard band of the 20 MHz channel overlaps with the 845 kHz guard band of the 100 MHz channel. The 273 PRBs of the non-RedCap 100 MHz channel is divided among the five hops including the guard bands 304 between any two consecutive hops except for the guard band 304 on the lower channel edge of Hop 1 and the guard band 304 on the upper channel edge of Hop 5. The guard band 304 between any two consecutive hops can be quantized to the nearest integer of PRBs as shown below:

$${N}_{RB}^{G} = ⌈ \frac{G}{{B}_{PRB}^{SCS}} ⌉ , \qquad ( 8 )$$

where G is the guard band (in hertz) for the RedCap device's channel bandwidth 308, and

$${B}_{PRB}^{SCS}$$

is the PRB bandwidth (in hertz) for a given SCS. For a 30 kHz SCS, G=805 KHZ, and

$${B}_{PRB}^{SCS} = 360 kHz ,$$

the guard band in PRBs, denoted as

$${N}_{PRB}^{G} ,$$

can be calculated

$${N}_{PRB}^{G} = ⌈ \frac{805 kHz}{360 kHz} ⌉ = 3 PRBs .$$

The sum of the number of PRBs over each hop is equal to 273 PRBs. As shown in FIG. 15, Hop 1 has a transmission bandwidth 306 of 50 PRBs and a guard band 304 of 3 PRBs at the higher channel edge (where the guard band 304 at the lower channel edge is not part of any PRBs), Hop 2 has a transmission bandwidth 306 of 50 PRBs and a guard band 304 of 3 PRBs at each channel edge, Hop 3 has a transmission bandwidth 306 of 50 PRBs and a guard band 304 of 3 PRBs at each channel edge, Hop 4 has a transmission bandwidth 306 of 49 PRBs and a guard band 304 of 3 PRBs at each channel edge, and Hop 5 has a transmission bandwidth 306 of 50 PRBs and a guard band 304 of 3 PRBs at the lower channel edge (where the guard band 304 at the higher channel edge is not part of any PRBs). In an example, the hopping transmission bandwidth configuration and guard band can be represented by the following format: 50-6-50-6-50-6-49-6-50.

The starting PRB (center frequency) of each hop can be determined from the aforementioned format, where PRB 1 is for Hop 1, PRB 57 for Hop 2, PRB 113 for Hop 3, PRB 169 for Hop 4, and PRB 224 for Hop 5. While FIG. 15 illustrates Hop 4 with the transmission bandwidth 306 of 49 PRB, the 49 PRB transmission bandwidth 306 can be assigned to any one of the five hops, e.g., 50-6-50-6-49-6-50-6-50. Although a 20 MHz channel can support 51 PRBs for 30 kHz SCS, the example illustrated in FIG. 15 shows fewer PRBs are used in a 20 MHz channel (e.g., 49, 50). Note the 50 PRB channelization can be reduced to 49 or even 48. For example, assuming a 48 PRB channel, the format can be 48-8-48-8-48-8-48-9-48. The benefit is that the same size transmission bandwidth 306 (with 48 PRBs) is used-which may simplify configuration. For example, the same SRS configuration can be used for the five hops. Another simplification is the format can be 8-8-8-9 (the number of PRBs used for the guard band) because the size of the transmission bandwidth 306 can be provided by the SRS configuration or signaled separately (e.g., by the AN 110). Note the size of the transmission bandwidth 306 can be smaller to facilitate implementation. For example, sizes can be factored into 2^{x}3^{y}5^{z} where x, y, and z are non-negative integers, such as 16, 48, 50, 64, can be used.

Table 11, 12, and 13A-B show frequency-hopping transmission bandwidth and guard band configurations for various non-RedCap channel bandwidths (e.g., the total frequency-hopping bandwidth 1402) and different instantaneous bandwidths (or bandwidths 308 per hop). In one embodiment, the same transmission bandwidth size is used for the same numerology. Although the embodiments show operations for a staircase pattern, other patterns can be used, including a random pattern. In this case, the AN 110 can indicate, via signaling, the starting location (or center frequency) for each hop. The RedCap UE 120a may use the list of starting locations for corresponding hops.

TABLE 11
Frequency-hopping transmission bandwidth configurations
for 20 MHz hopping bandwidth (RedCap bandwidth)

| SCS | Non-RedCap Channel Bandwidth | | | |
|---|---|---|---|---|
| (kHz) | 40 MHz | 60 MHz | 80 MHz | 100 MHz |
| 15 | 105-6-105 | N/A | N/A | N/A |
| 30 | 50-6-50 | 50-6-50-6-50 | 50-6-50-5-50-6-50 | 50-6-50-6-49- |
| | | | | 6-50-6-50 |
| 60 | 23-5-23 | 23-5-23-5-23 | 23-5-23-5-23-5-23 | 23-5-23-5-23- |
| | | | | 5-23-5-23 |

TABLE 12
Frequency-hopping transmission bandwidth configurations
for 15 MHz hopping bandwidth (RedCap bandwidth)

| SCS | Non-RedCap Channel Bandwidth | | | |
|---|---|---|---|---|
| (kHz) | 30 MHz | 45 MHz | 60 MHz | 90 MHz |
| 15 | 77-7-77 | 77-6-77-6-77 | N/A | N/A |
| 30 | 37-4-37 | 36-6-36-6-36 | 37-5-37-4-37-5-37 | 36-6-36-6-36-5- |
| | | | | 36-6-36-6-36 |
| 60 | 17-4-17 | 16-5-16-6-16 | 17-4-17-3-17-4-17 | 16-5-16-5-16-5- |
| | | | | 16-5-16-5-16 |

TABLE 13A
Frequency-hopping transmission bandwidth configurations
for 20 MHz hopping bandwidth (RedCap bandwidth)

| | |
|---|---|
| SCS | Non-RedCap Channel Bandwidth |

| (kHz) | 20 MHz | 30 MHz | 40 MHz |
|---|---|---|---|
| 15 | 51-4-51 | 50-6-50-5-50 | 50-5-50-6-50-6-50 |
| 30 | 23-5-23 | 23-5-23-4-23 | 23-5-23-4-23-5-23 |
| 60 | 10-4-10 | 10-4-10-4-10 | 9-5-9-4-9-5-9 |

TABLE 13B
Frequency-hopping transmission bandwidth configurations
for 20 MHz hopping bandwidth (RedCap bandwidth)

| | |
|---|---|
| SCS | Non-RedCap Channel Bandwidth |

| (kHz) | 50 MHz | 60 MHz |
|---|---|---|
| 15 | 49-7-49-7-49-7-49-7-49 | N/A |
| 30 | 22-6-22-6-22-6-22-6-22 | 23-5-23-5-23-4-23-5-23-5-23 |
| 60 | 10-4-10-4-10-3-10-4-10 | 9-5-9-5-9-5-9-5-9-5-9 |

In the case where there is a non-zero offset between the first PRB of the total frequency-hopping channel 1401 and the first PRB of a lowest-frequency hop, there may be two options: reduce the size of the transmission bandwidth 306 and/or reduce the size of the guard bands 304.

Unlike in the first approach (the configuration 1400), the second approach (the configuration 1500) calculates the total frequency-hopping transmission bandwidth in PRBs, denoted as,

$${N}_{RB}^{FH}$$

as follows:

$${N}_{RB}^{FH} = ⌈ \frac{{W}_{FH} - 2 \times G}{{B}_{PRB}^{SCS}} ⌉ , \qquad ( 9 )$$

where W_{FH} is the total frequency-hopping bandwidth 1402 (in hertz), G is the guard band 1404 (in hertz) for the RedCap device's channel bandwidth, and

$${B}_{PRB}^{SCS}$$

is the PRB bandwidth (in hertz) for a given SCS.

In an example, the total frequency-hopping bandwidth 1402 W_{FH}=100 MHz, the instantaneous bandwidth 306 per hop is 20 MHz, and

$${B}_{PRB}^{SCS} = 180 kHz$$

for the 15 kHz SCS. From Table 3, the guard band 304 G=452.5 Hz for the 15-kHz SCS. From Equation (9), the total frequency-hopping transmission bandwidth

$${N}_{RB}^{FH}$$

can be calculated as

$${N}_{RB}^{FH} = ⌈ \frac{100 , 00 \; 0 kHz - 2 \times 452.5 kHz}{180 kHz} ⌉ = 550 PRBs .$$

The first PRB (or PRB 1) starts at 452.5 kHz from the lower channel edge of Hop 1 and the PRB 550 corresponds to the last PRB in Hop 5. The 550 PRBs are distributed among the five hops including the guard band 304 between any two consecutive hops except for the guard band 304 on the lower channel edge of Hop 1 and the guard band 304 on the upper channel edge of Hop 5. The quantized guard band 304 is 3 PRBs. Following the same methodology as the first approach, the frequency-hopping transmission bandwidth configuration for the RedCap device can be expressed as 105-6-105-6-105-6-106-6-105. It should be noted that the 106 PRBs in Hop 4 can be assigned to any one of the five hops, e.g., 105-6-106-6-105-6-105-6-105.

In the third approach, the guard band 304 on either channel edge of each hop is not taken into account (i.e., the frequency gap 1302 g=0). The following is discussed using the same example as discussed above in the first approach (shown in FIG. 14) where the frequency-hopping bandwidth 1402 is 100 MHz for a 30 kHz SCS FR1 RedCap device. The total frequency-hopping transmission bandwidth 1406 for such a channel is

$${N}_{RB}^{FH} = 273 PRBs$$

(see Table 10). The RedCap device's bandwidth 306 per hop is 20 MHz corresponding to

$${N}_{RB}^{RC} = 51 PRBs$$

according to Table 1. If the RedCap UE 120a is configured with five hops, then there are several PRBs which are unused for SRS transmission since the total number of PRBs can be covered in five hops is 255. In such a case, the remaining unused 18 PRBs can be evenly distributed on either side of the non-RedCap channel edges as shown in FIG. 16.

FIG. 16 illustrates the configuration 1600 for alignment between a RedCap device's channel bandwidth and a 100 MHz non-RedCap channel (the total frequency-hopping channel 1401) with an SCS of 30 kHz. As shown in FIG. 16, the total frequency-hopping transmission bandwidth 1406 has 273 PRBs (shown as PRB 0 to PRB 272). The PRBs 0-8 on the lower channel edge and the PRBs 264-272 on the higher channel edge are unused for aligning to the RedCap device's channels (shown as Hop 1, Hop 2, Hop 3, Hop 4, and Hop 5). If the remaining number of unused PRBs is an odd number, then the PRB at the center of the total frequency-hopping transmission bandwidth 1406

$${N}_{RB}^{FH}$$

is not included in the hopping pattern, and any remaining PRBs are evenly distributed on either side of the non-RedCap channel edges as in the case when the remaining unused PRBs is an even number.

In some deployments, the PUCCH resources for non-RedCap devices are located on opposite sides (or channel edges) of the uplink BWP configured for the non-RedCap devices. By ensuring that the hops are not located at the non-RedCap channel edges, the network can minimize interference from SRS transmissions from RedCap devices (e.g., the RedCap UE 120a) and PUCCH transmissions from non-RedCap devices. In one example, a hopping configuration used by RedCap devices can include an offset (in PRBs), denoted as o, for the first hop. If a RedCap UE is configured with an index

$$j = o , … , ⌊ \frac{{N}_{RB}^{FH}}{{N}_{RB}^{RC}} ⌋ - 1 ,$$

the PRBs used in the first hop (assuming numbering begins at 0) is

$$o + j \times {N}_{RB}^{RC} .$$

For the kth hop, where

$$k = 1 , … , ⌊ \frac{{N}_{RB}^{FH}}{{N}_{RB}^{RC}} ⌋ ,$$

the starting PRB for the RedCap UE 120a with index j is expressed as shown below:

$$o + ( j \times {N}_{RB}^{RC} + s \times ( k - 1 ) \times {N}_{RB}^{RC} ) mod ( {N}_{RB}^{RC} \times ⌊ \frac{{N}_{RB}^{FH}}{{N}_{RB}^{RC}} ⌋ ) , \qquad ( 10 )$$

where s=1 for the ascending staircase pattern and s=−1 for the descending staircase pattern.

As shown in FIG. 16, the offset

$$o = 9 , s = 1 , ⌊ \frac{{N}_{RB}^{FH}}{{N}_{RB}^{RC}} ⌋ = 5 with {N}_{RB}^{FH} = 273 and {N}_{RB}^{RC} = 51 .$$

For j=0, the starting PRB of the 5 hops are 9, 60, 111, 162, 213. Note that instead of specifying the index j, the network can provide an additional offset, denoted as o2, such that Equation (10) can be reformulated as shown below:

$$o + ( o 2 + s \times ( k - 1 ) \times {N}_{RB}^{RC} ) mod ( {N}_{RB}^{RC} \times ⌊ \frac{{N}_{RB}^{FH}}{{N}_{RB}^{RC}} ⌋ ) . \qquad ( 11 )$$

In this example, o2 can be 0, 51, 102, and so on. Note that

$${N}_{R B}^{FH}$$

can be the bandwidth in PRBs of the channel (the total frequency-hopping channel), or a value smaller.

In another embodiment, the unused 18 PRBs (the 9 unused PRBs at the lower channel edge and the 9 unused PRBs at the higher channel edge) can be utilized by adding another hop to the configuration 1600.

In embodiments, the AN 110 may configure the RedCap UE 120a with timing information for wideband positioning with frequency-hopping. As discussed above with reference to FIGS. 5-16, the hop switching time (switch (e.g., the hop switching time 506, 906, 1106) is the RF retuning delay for the RedCap UE 120a to change or hop from one carrier frequency to another carrier frequency, and the dwell time t_{dwell} (e.g., the hop dwell time 508, 908, 1108) refers to the amount of time for the RedCap UE 120a to transmit a positioning SRS resource per hopping occasion. The latter is typically defined in terms of the number of OFDM symbols for a given numerology (or SCS). The hop switching time values specified by 3GPP for FR1 and FR2 are shown in Table 14. The hop switching time, which is specified in microseconds (μs), depends on the RedCap device capability. Since the frequency-hopping is to be time-synchronous with the OFDM symbol boundaries, the switching time values are rounded up (quantized) to the nearest number of symbols for each numerology (denoted by

$${N}_{symb}^{switch}$$

in Table 14). Furthermore, additional switching time may be added for the RedCap UE 120a to hop from the initial/active BWP to the first hop (denoted by tᵢₙᵢ) and from the last hop back to the initial/active BWP (denoted by t_{end}).

TABLE 14
Switching time between consecutive hops for wideband frequency-
hopping RedCap devices

| | Switching Time, t_{switch} | | | | | |
|---|---|---|---|---|---|---|
| | Frequency Range 1 | | | Frequency Range 2 | | |
| Numerology | 70 μs | 140 μs | 210 μs | 35 μs | 70 μs | 140 μs |
| (SCS) | ${N}_{s y m b}^{switch}$ | | | | | |
| 15 kHz | 1 OFDM | 2 OFDM | 3 OFDM | N/A | N/A | N/A |
| | symbol | symbols | symbols | | | |
| 30 kHz | 2 OFDM | 4 OFDM | 6 OFDM | N/A | N/A | N/A |
| | symbols | symbols | symbols | | | |
| 60 kHz | 4 OFDM | 8 OFDM | 12 OFDM | 2 OFDM | 4 OFDM | 8 OFDM |
| | symbols | symbols | symbols | symbols | symbols | symbols |
| 120 kHz | N/A | N/A | N/A | 4 OFDM | 8 OFDM | 16 OFDM |
| | | | | symbols | symbols | symbols |

The total number of OFDM symbols to complete one hopping cycle (e.g., hopping across all 5 hops) is shown below:

$${N}_{symb}^{FH} = {t}_{dwell} \times {N}_{hop} + {N}_{symb}^{switch} \times ( {N}_{hop} - 1 ) + {t}_{ini} + {t}_{end} , \qquad ( 12 )$$

where Nₕₒₚ is the number of hops for the RedCap UE 120a to sound the entire wide bandwidth (the total frequency-hopping bandwidths 502, 90, 1102, and 1402),

$${N}_{symb}^{switch}$$

(in the number of OFDM symbols) is the RF retuning delay for the RedCap UE 120a, t_{dwell} is the number of OFDM symbols allocated for SRS resource transmission per hopping occasion for the RedCap UE 120a, tᵢₙᵢ is the switching time (in seconds) from the initial/active BWP to the first hop for the RedCap device, which is quantized to the nearest number of symbols, t_{end} is the switching time (in seconds) between the last hop to the initial/active BWP for the RedCap device, which is quantized to the nearest number of symbols.

If

$${N}_{symb}^{FH} > ( {N}_{symb}^{slot} - {l}_{start} ) ,$$

then the frequency-hopping cycle may span multiple slots, where

$${N}_{symb}^{slot}$$

is the number of symbols per slot and lₛₜₐᵣₜ is the starting OFDM symbol location of the first hop (including the symbols for tᵢₙᵢ, i.e., the value lₛₜₐᵣₜ can incorporate lₛₜₐᵣₜ), and OFDM symbol index 0 is the first symbol of the slot. The number of slots to complete frequency-hopping in one cycle can be expressed as shown below:

$${N}_{slot}^{FH} = ⌈ \frac{{N}_{symb}^{FH}}{{N}_{symb}^{slot}} ⌉ . \qquad ( 13 )$$

In order to determine the number of hops, denoted by

$${N}_{hop}^{slot} ,$$

that can be accommodated in a slot, the following relationship can be utilized:

$$\begin{matrix}{N}_{symb}^{slot} - {l}_{start} = {t}_{dwell} \times {N}_{hop}^{slot} + {N}_{symb}^{switch} \times ( {N}_{hop}^{slot} - 1 ) + {t}_{ini} + {t}_{end} \\ = {t}_{dwell} \times {N}_{hop}^{slot} + {N}_{symb}^{switch} \times {N}_{hop}^{slot} - {N}_{symb}^{switch} + {t}_{ini} + {t}_{end} .\end{matrix} \qquad ( 14 )$$

Equation (14) can be rearranged as shown below:

$${N}_{hop}^{slot} = \frac{( {N}_{symb}^{slot} - {l}_{start} ) + {N}_{symb}^{switch} - {t}_{ini} - {t}_{end}}{{t}_{dwell} + {N}_{symb}^{switch}} \qquad ( 15 )$$

Table 15A shows the total number of symbols and the number of slots to complete one hopping cycle assuming

$${N}_{symb}^{slot} = 14$$

symbols, Nₕₒₚ=5 hops, t_{dwell}=1 symbol, lₛₜₐᵣₜ=2 and tᵢₙᵢ==t_{end}=1 symbol. Table 15B also shows the total number of symbols and the number of slots to complete one hopping cycle similar to the Table 15A, but for Nₕₒₚ=8 hops and tᵢₙᵢ=t_{end}=0 symbol, and the other parameters remain the same.

TABLE 15A
The total number of symbols per hopping cycle as a function of hop switching time
${N}_{hop} = 5 hops , {t}_{dwell} = 1 symbol , {l}_{start} = 2 , {N}_{s y m b}^{slot} = 14 symbols , {t}_{ini} = {t}_{end} = 1 symbol$

| ${N}_{s y m b}^{switch} ( from Table 14 )$ | ${N}_{s y m b}^{F H} ( Equation ( 12 ) )$ | ${N}_{slot}^{F H} ( Equation ( 13 ) )$ |
|---|---|---|
| 1 symbol | 11 symbols | 1 slot |
| 2 symbols | 15 symbols | 2 slots |
| 4 symbols | 23 symbols | 2 slots |
| 8 symbols | 39 symbols | 4 slots |
| 16 symbols | 71 symbols | 6 slots |

TABLE 15B
The total number of symbols per hopping cycle
as a function of hop switching time
${N}_{hop} = 8 hops , {t}_{dwell} = 1 symbol , {l}_{start} = 2 , {N}_{s y m b}^{slot} = 14 symbols , {t}_{ini} = {t}_{end} = 0 symbol$

| ${N}_{s y m b}^{switch} ( from Table 14 )$ | ${N}_{s y m b}^{F H} ( Equation ( 12 ) )$ | ${N}_{slot}^{F H} ( Equation ( 13 ) )$ |
|---|---|---|
| 1 symbol | 15 symbols | 2 slots |
| 2 symbols | 22 symbols | 2 slots |
| 4 symbols | 36 symbols | 3 slots |
| 8 symbols | 64 symbols | 5 slots |
| 16 symbols | 120 symbols | 9 slots |

Referring to Table 15A and Table 15B, the total number of symbols to complete a hopping cycle depends on the number of hops, the hop switching time, and the number of symbols to transmit a positioning SRS resource per hopping occasion and the switching from the initial/active BWP to the first hop and back to initial/active BWP from the last hop.

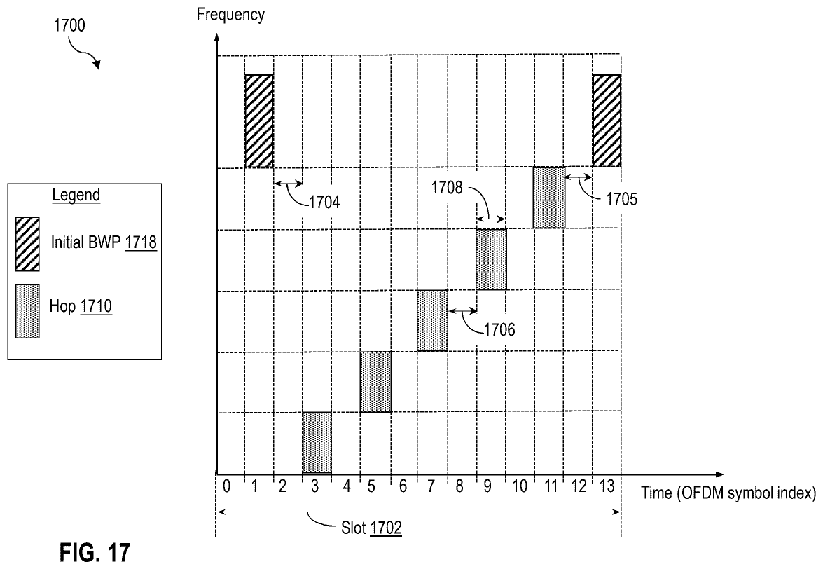

FIG. 17 illustrates an example intra-slot wideband frequency-hopping configuration 1700 for a RedCap device according to an embodiment of the present disclosure. In embodiments, the AN 110 may configure the RedCap UE 120a with the configuration 1700. In FIG. 17, the vertical axis may represent frequency in some arbitrary units, and the horizontal axis may represent time in OFDM symbols (OFDM symbol 0 to 13 in a slot 1702).

As shown in FIG. 17, the configuration 1700 may configure the RedCap UE 110a with an initial BWP 1718 and wideband frequency-hopping with hops 1710 for positioning. For Nₕₒₚ=5 hops, t_{dwell}=1 symbol, lₛₜₐᵣₜ=2,

$${N}_{symb}^{switch} = 1 symbol , {N}_{symb}^{slot} = 14 symbols ,$$

and tᵢₙᵢ=t_{end}=1 symbol, the wideband frequency-hopping is completed within one slot 1702. The parameter

$${N}_{symb}^{switch}$$

is shown by the hop switching time 1706 (e.g., similar to the hop switching time 506, 906, and 1106). The parameter t_{dwell} is shown by the hop dwell time 1708 (e.g., similar to the hop dwell time 508, 908, and 1108). The parameter tᵢₙᵢ is shown by the initial switching time 1704 from the initial BWP 1718 to the first hop 1710. The parameter t_{end} is shown by the switching time 1705 from last hop 1710 back to the initial BWP 1718. For ease of illustration, FIG. 17 only shows the reference numeral 1706 for the hop switching time between the third and fourth hops 1710 and only shows the reference numeral 1708 for the hop dwell time of the fourth hop 1710.

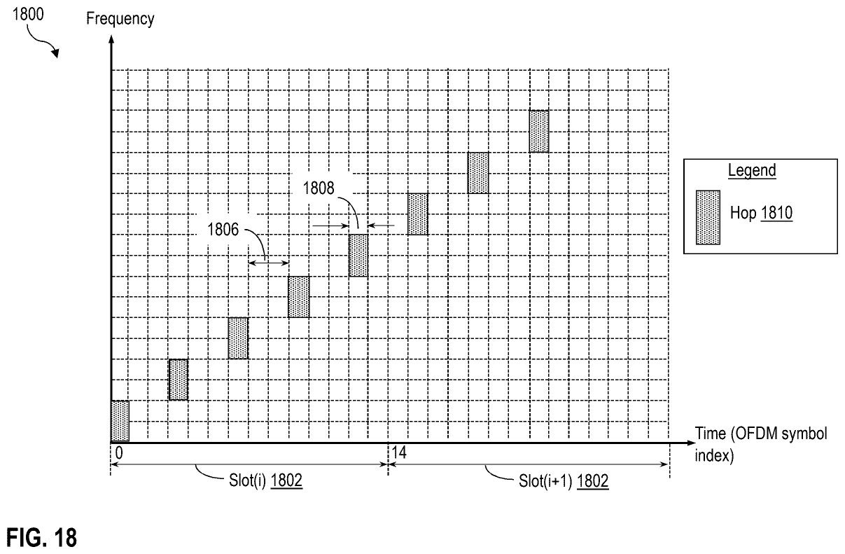

FIG. 18 illustrates an example multi-slot wideband frequency-hopping configuration 1800 for a RedCap device according to an embodiment of the present disclosure. In embodiments, the AN 110 may configure the RedCap UE 120a with the configuration 1800. In FIG. 18, the vertical axis may represent frequency in some arbitrary units, and the horizontal axis may represent time in OFDM symbols spanning two consecutive (or contiguous) slots 1802 (shown as slot(i) and slot(i+1)).

As shown in FIG. 18, the configuration 1800 may configure the RedCap UE 120a for wideband frequency-hopping with hops 1810 for positioning. Nₕₒₚ=8 hops, t_{dwell}=1 symbol, lₛₜₐᵣₜ=2,

$${N}_{symb}^{switch} = 1 symbol , {N}_{symb}^{slot} = 14 symbols ,$$

and tᵢₙᵢ=r_{end}=0 symbol, the wideband hopping is completed in two slots 1802. The parameter

$${N}_{symb}^{switch}$$

is shown by the hop switching time 1806 (e.g., the hop switching time 506, 906, 1106, and 1706). The parameter t_{dwell} is shown by the hop dwell time 1808 (e.g., the hop dwell time 508, 908, 1108, and 1708). For case of illustration, FIG. 18 only shows the reference numeral 1806 for the hop switching time between the third and fourth hops 1810 and only shows the reference numeral 1808 for the hop dwell time of the fourth hop 1810. In some examples, the parameters tᵢₙᵢ and t_{end} are set to 0 symbols when the active BWP of the RedCap UE 120a is part of the wideband frequency-hopping bandwidth. That is, one of the hops 1810 may correspond to the active BWP of the RedCap UE 120a.

In embodiments, the AN 110 may configure the UE 120a with periodic, semi-persistent or aperiodic transmission of an SRS resource for positioning for a wideband frequency-hopping RedCap including parameters, such as

$${N}_{slot}^{FH} ,$$

t_{dwell}, lₛₜₐᵣₜ, l_{hop j}, Sᵣₑₚ, and/or S_{offset}. The parameter

$${N}_{slot}^{FH} .$$

is the number of consecutive slots starting at Slot i based on Equation (13) in a hopping cycle. As an example,

$${N}_{slot}^{FH}$$

can be any one value in a set of values as shown by

$${N}_{slot}^{FH} ∈ \{ 1 , 2 , 3 , 4 , 5 , 6 , 7 , 8 , 9 , 10 , 12 , 14 , 16 , 18 , 20 , 30 , 40 \} .$$

The parameter, t_{dwell} is the number of consecutive OFDM symbols for each hopping occasion. As an example, t_{dwell} can be any one value in a set of values as shown by, t_{dwell}∈{1, 2, 4, 8, 10, 12, 14}. The parameter lₛₜₐᵣₜ is the starting OFDM symbol of tᵢₙᵢ prior to the first hop, where OFDM symbol index 0 is the first symbol of the slot. The parameter l_{hop j} is the first OFDM symbol of Hop j, where j∈{1, 2, . . . , Nₕₒₚ} and

$${l}_{hop j} = ( {l}_{start} + {t}_{ini} + ( j - 1 ) \times {t}_{dwell} + ( j - 1 ) \times {N}_{symb}^{switch} ) mod {N}_{symb}^{slot} .$$

The parameter Sᵣₑₚ is the slot repetition factor (in numbers of slots) that defines how many times the hopping cycle is repeated for a positioning SRS resource. As an example, Sᵣₑₚ can be any one value in a set of values as shown by Sᵣₑₚ∈{1,2,4,6,8, 16}. The parameter S_{offset} is the offset in numbers of slots between two repeated hopping cycles. In an embodiment, the configuration 1700 of FIG. 17 and the configuration 1800 of FIG. 18 may be configured using such a symbol and slot configuration for the RedCap UE 120a to perform wideband frequency-hopping. Note, in some examples, the AN 110 may not configure

$${N}_{symb}^{switch}$$

for the RedCap UE 120a because

$${N}_{symb}^{switch}$$

is a capability of the RedCap UE 120a. In some instances, the AN 110 may configure the same value

$${N}_{symb}^{switch}$$

for multiple RedCap UEs similar to the RedCap UE 120a to facilitate multiplexing for SRS transmission from multiple UEs. In examples, the

$${N}_{symb}^{switch}$$

for the multiple RedCap UE may be a value greater than a RedCap capability indicated by a RedCap UE.

In embodiments, the AN 110 may configure the RedCap UE 120a to perform wideband frequency-hopping for positioning in a TDD mode. For TDD operations, the AN 110 may provide at least a periodic configuration indicating which slots and which symbols of slots are configured for downlink and uplink transmissions.

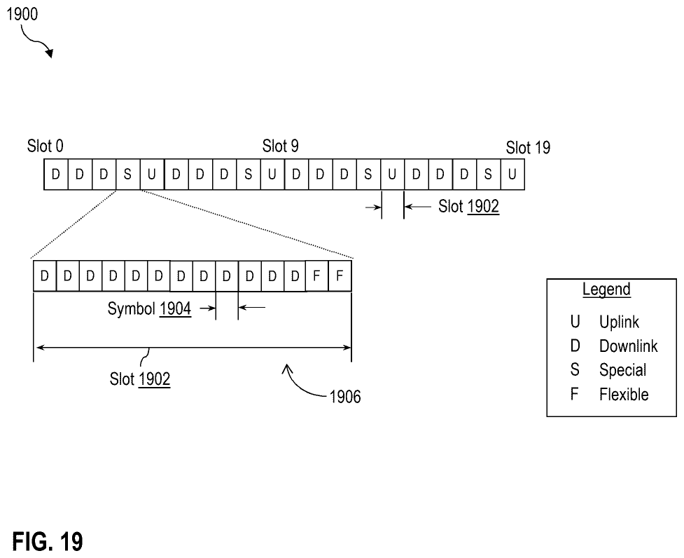

FIG. 19 illustrates an example slots and symbols configuration 1900 for a TDD deployment according to an embodiment of the present disclosure. As shown in FIG. 19, the configuration 1900 includes 20 slots 1902 (e.g., similar to the slots 1702 and 1802). As an example, one periodic configuration specifying the transmission directions for five consecutive slots can be represented by “3D1SIU”, where “D” indicates a downlink slot (i.e., all symbols of that slot are configured for downlink), “U” indicates an uplink slot (i.e., all symbols of that slot are configured for uplink), and “S” indicates a special/flexible slot in which some symbols can be for downlink, some symbols can be flexible/unspecified, and some symbols can be for uplink. In the illustrated example of FIG. 19, the 20 slots 1902 in the configuration 1900 includes four repetitions of “3D1SIU”. An example configuration for an S slot 1902 is “12D2F” as shown by the expanded view 1906, where the first 12 symbols 1904 are downlink and the last two symbols 1904 are flexible. The last two flexible symbols 1904 are generally used for timing advance and downlink-to-uplink switching of the RF chain. For ease of illustration, FIG. 19 only shows the reference numeral 1902 for one slot and the reference numeral 1904 for one symbol.

Generally, there are two types of TDD configurations, namely common and dedicated. The common TDD configuration is applicable to all UEs and the dedicated TDD configuration is targeted to one or more UEs. Typically, the network provides a common TDD configuration and then provides a dedicated TDD configuration for a subset of the slots in the common TDD configuration.

When operating in a TDD mode, the hopping pattern may be affected by the TDD configuration. For example, if a RedCap UE 120a cannot complete SRS transmissions (for wideband frequency-hopping) within one slot, the RedCap UE 120a may have to resume the SRS transmission in the next uplink slot.

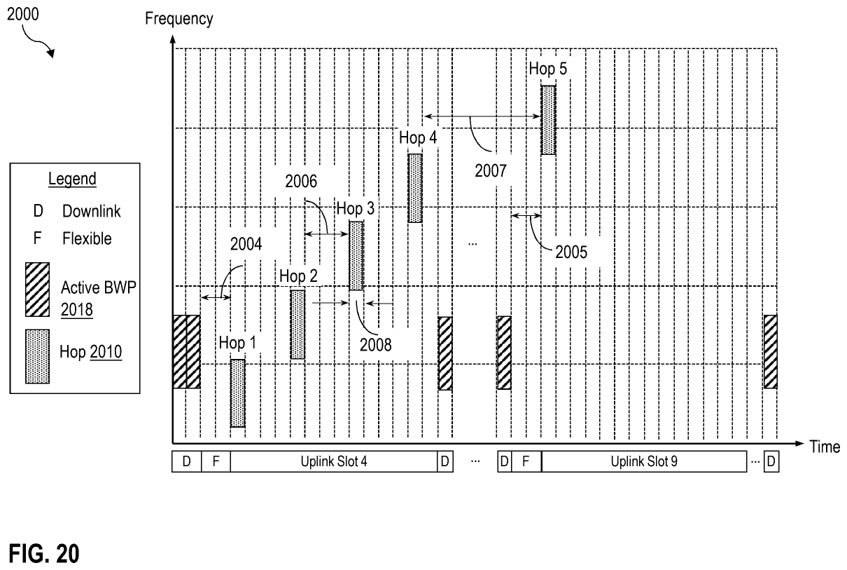

FIG. 20 illustrates an example TDD configuration 2000 for non-overlapping wideband frequency-hopping according to an embodiment of the present disclosure. In embodiments, the AN 110 may configure the RedCap UE 120a to perform wideband frequency-hopping for positioning as shown in the TDD configuration 2000. The configuration 2000 utilizes the slots and symbols configuration 1900 where slots are arranged in “3D1SIU” as discussed above with reference to FIG. 19 and may use the same reference numerals as in FIG. 19 to refer to the same elements. In FIG. 20, the vertical axis may represent frequency in some arbitrary units, and the horizontal axis may represent time in symbols (e.g., the symbols 1904) and slots (e.g., the slots 1702, 1802, and 1902). As shown in FIG. 20, the configuration 2000 includes 5 hops 2010 (shown as Hop 1, Hop 2, Hop 3, Hop 4, and Hop 5) non-overlapping in frequency, where the hop switching time 2006 is

$${N}_{symb}^{switch} = 3$$

symbols and the dwell time 2008 is t_{dwell}=1 symbol. The initial switching time 2004 from the active BWP 2018 to the first hop is tᵢₙᵢ=2 symbols. Note, for TDD the center frequencies of the active downlink BWP and the active uplink BWP are aligned. As further shown in FIG. 20, the uplink slot 4 can accommodate the first 4 hops 2010 (Hop 1 to Hop 4), but not the last hop 2010 (Hop 5). The next uplink slot is five slots later (a gap 2007) in uplink slot 9 in which the last hop 2010 (Hop 5) is located. Note in the uplink slot 9, there is another switching time 2005 (e.g., t_{end}=2 symbols) from the last hop 2010 (Hop 5) back to the active BWP 2018.

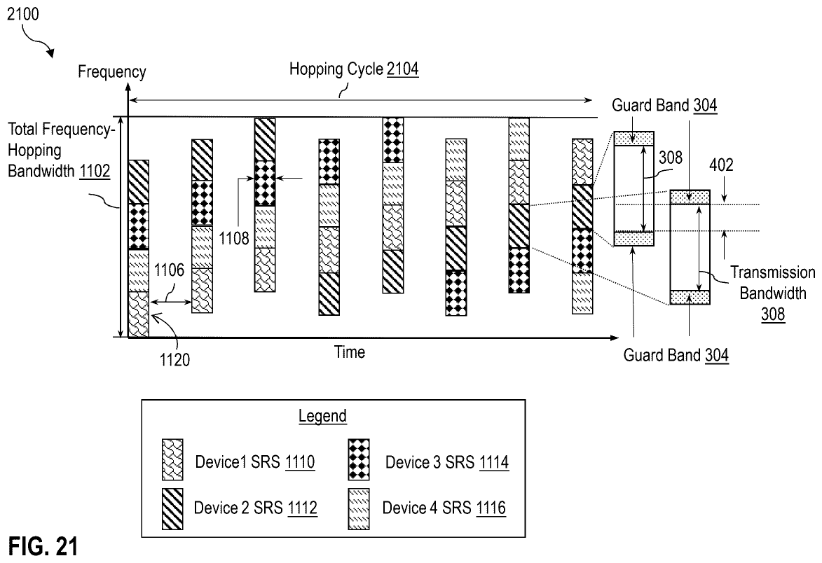

In embodiments, the AN 110 may multiplex several RedCap devices similar to the RedCap UE 120a for positioning or localization with wideband frequency-hopping in a partial staircase pattern as shown in FIGS. 21-23.

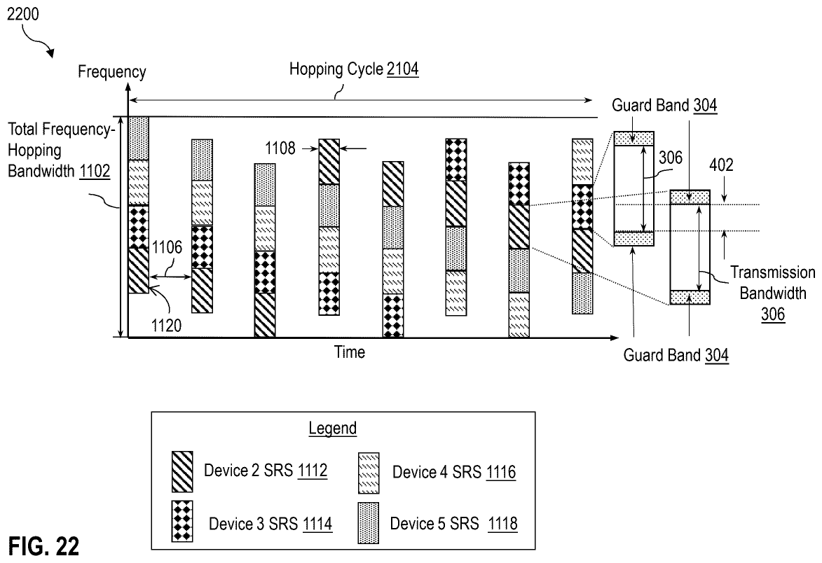

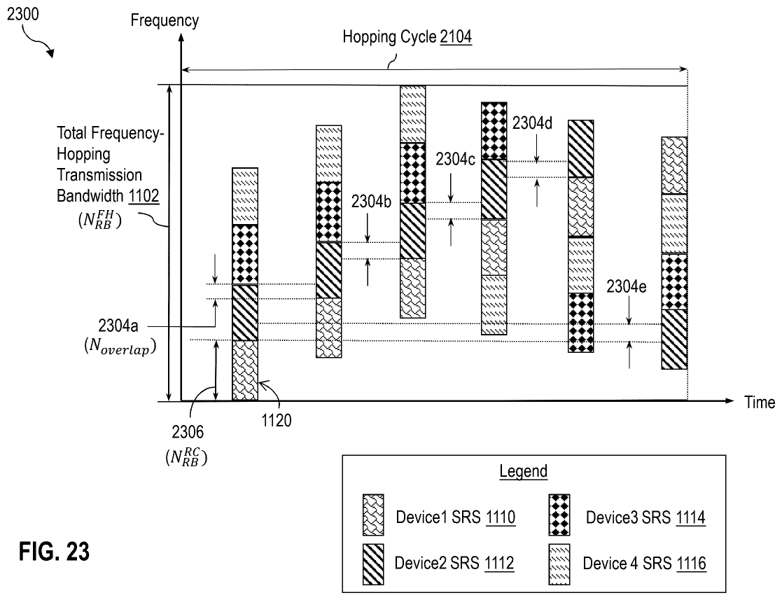

FIG. 21 illustrates an example multi-user configuration 2100 for partial overlapping staircase wideband frequency-hopping (in an increasing frequency order) according to an embodiment of the present disclosure. FIG. 22 illustrates an example multi-user configuration 2200 for partial overlapping staircase wideband frequency-hopping (in a decreasing frequency order) according to an embodiment of the present disclosure. FIG. 23 illustrates an example multi-user configuration 2300 for partial overlapping staircase wideband frequency-hopping according to an embodiment of the present disclosure. In FIGS. 21-23, the vertical axes may represent frequency in some arbitrary units, and the horizontal axes may represent time in some arbitrary units. FIGS. 21-23 are discussed using the same channel structure as FIG. 3 and the same hopping structure (e.g., the total frequency-hopping channel bandwidth 1102, the hop dwell time 1108, and the hop switching time 1106) as FIG. 11 and may use the same reference numerals as in FIGS. 3 and 11 to refer to the same elements. In comparison with the non-overlapping frequency-hopping pattern shown in FIGS. 11-13, there may be some differences. For instance, the frequency-domain multiplexing capability may be reduced (e.g., supporting multiplexing of 4 devices instead of 5 devices) due to the partial frequency overlap between adjacent hops 1120, and additional hop(s) 1120 (depending on the amount of overlap) may be added to measure the wide channel bandwidth (e.g., 100 MHz), leading to a longer frequency-hopping cycle 2104.

As shown in FIG. 21, the configuration 2100 has three additional hops 1120 compared to the configuration 1100 of FIG. 11. That is, instead of utilizing 5 hops 1120 to cover the entire total frequency-hopping bandwidth 1102, the configuration 2100 utilizes 8 hops 1120 to cover the entire total frequency-hopping bandwidth 1102. As such, the hopping cycle 2104 may have a duration longer than the hopping cycle 1104 when using the same hop switching time 1106 and hop dwell time 1108 as the configuration 1100. Additionally, a portion of the frequency resources located at either the top (the higher channel edge) or bottom (the lower channel edge) of the wide bandwidth 1102 may not be measured for each device. Further, the guard band 304 of one device can overlap with the transmission band of an adjacent device (e.g., as shown by 402 for the Device 2 SRS 1112).

As shown FIG. 21, the frequency-hopping pattern of Device 1 is a continuous ascending staircase in time while the frequency-hopping pattern of Device 2 to Device 4 is a wrapped ascending staircase in time. Stated differently, for frequency hops with an ascending staircase pattern in time, a frequency location of a first frequency hop 1120 of the frequency hops 1120 is higher than a frequency location of a previous adjacent frequency hop 1120 of the frequency hops 1120. Additionally, for frequency hops 1120 with a wrapped ascending staircase pattern in time, a frequency location of a highest-frequency frequency hop 1120 of the frequency hops 1120 is adjacent to and prior to a lowest-frequency frequency hop 1120 of the frequency hops 1120 in time.

As shown in FIG. 22, the configuration 2200 is substantially similar to the configuration 2100 of FIG. 21, but the hopping pattern in the configuration 2200 is descending in time instead of ascending in time. For instance, the frequency-hopping pattern of Device 5 is a continuous descending staircase in time while the frequency-hopping pattern of Device 2 to Device 4 is a wrapped descending staircase in time.

As mentioned previously, the frequency-division multiplexing capability of the partial overlapping wideband frequency-hopping is reduced, leading to a smaller number of RedCap channels that can be simultaneously supported. The number of RedCap channels can be expressed as shown below:

$${N}_{channel}^{RC} = ⌊ \frac{{N}_{RB}^{FH}}{{N}_{RB}^{RC}} ⌋ - 1 , \qquad ( 16 )$$

where

$${N}_{RB}^{FH}$$

is the total frequency-hopping transmission bandwidth in numbers of PRBs as discussed above with reference to FIGS. 14-16,

$${N}_{RB}^{RC}$$

is the narrowband Red Cap channel bandwidth 308 (or the bandwidth per hop 1120) in number of PRBs. The total frequency-hopping transmission bandwidth may refer to the total frequency-hopping bandwidth 1102 excluding guard bands at the lower-frequency channel edge and higher-frequency channel edge. The subtraction of 1 in Equation (16) is due to the wrap around. The number of hops 1120 for a RedCap UE 120a to sound the total frequency-hopping (or wide) transmission bandwidth

$${N}_{RB}^{FH}$$

is as shown below:

$${N}_{hop} = ⌊ \frac{{N}_{RB}^{FH}}{{N}_{RB}^{RC} - {N}_{RB}^{overlap}} ⌋ , \qquad ( 17 )$$

where

$${N}_{RB}^{overlap}$$

is the amount of overlapping transmission bandwidth 2304 (e.g., similar to the overlapping bandwidth 402) in number of PRBs. As shown in FIG. 23, the configuration 2300 is substantially similar to the configuration 2100. For instance, the frequency-hopping pattern of Device 1 is a continuous ascending staircase in time while the frequency-hopping pattern of Device 2 to Device 4 is a wrapped ascending staircase in time. FIG. 23 further illustrates the relation between the overlapping transmission bandwidth

$$2304 {N}_{RB}^{overlap}$$

(individually shown as 2304a, 2304b, 2304c, 2304e, and 2304e) between adjacent hops 1120 for Device 2, the narrowband RedCap channel bandwidth

$$2306 {N}_{RB}^{RC} ,$$

and the frequency-hopping transmission bandwidth

$${N}_{RB}^{FH}$$

in Equation (17). In an example, the overlapping transmission bandwidth 2304e between the first and last hops 1120 may be different than the overlapping transmission bandwidth 2304 between the first and second hops 1120. In general, the overlapping transmission bandwidths 2304 between one pair of adjacent hops 1120 and the overlapping transmission bandwidths 2304 between another pair of adjacent hops 1120 within a hopping cycle 2104 can be the same or different.

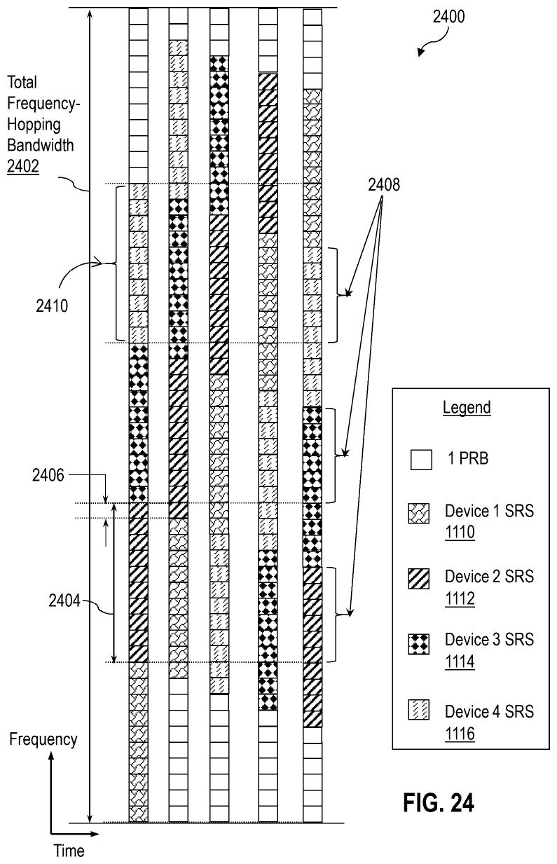

In embodiments, the AN 110 may configure the RedCap UE 120a to perform wideband frequency-hopping for positioning with overlapping transmission bandwidths (e.g., the overlapping transmission bandwidths 2304) as shown in FIGS. 24-26.

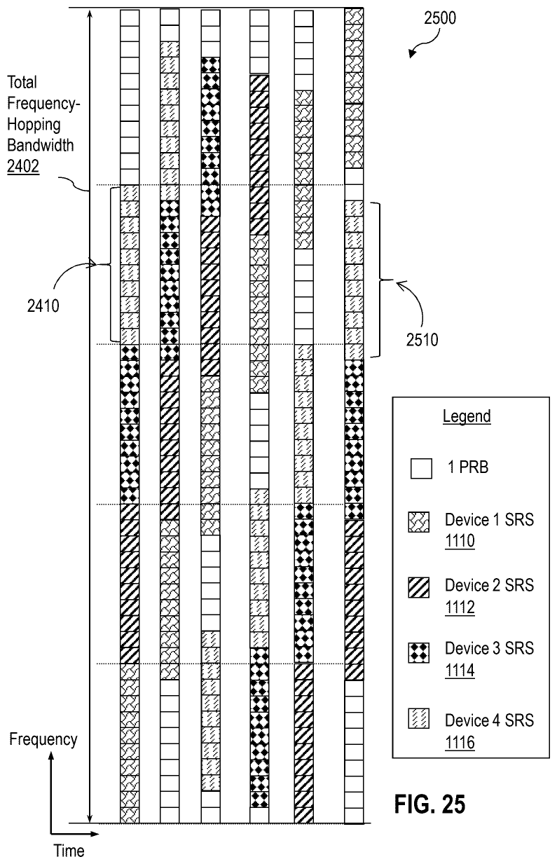

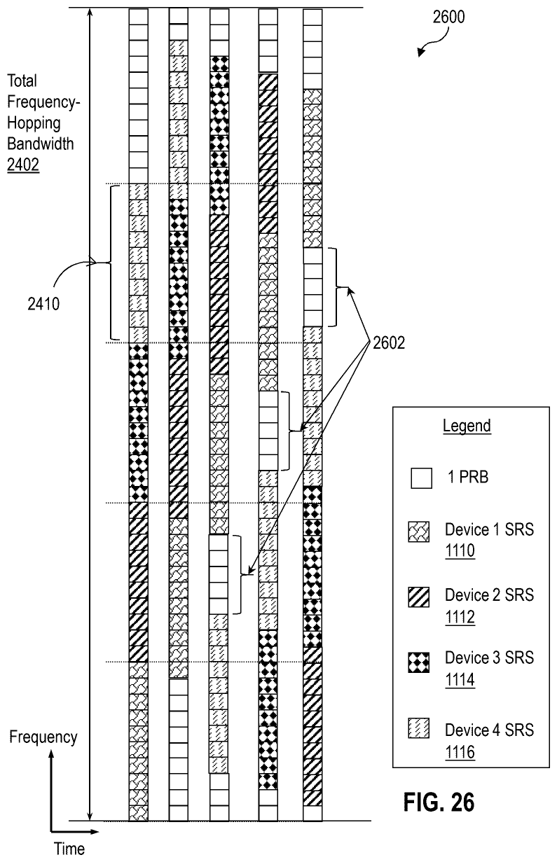

FIG. 24 illustrates an example transmission bandwidth configuration 2400 for wideband frequency-hopping with a minimum overlapping bandwidth according to an embodiment of the present disclosure. FIG. 25 illustrates an example transmission bandwidth configuration 2500 for wideband frequency-hopping with a minimum overlapping bandwidth and an additional hop according to an embodiment of the present disclosure. FIG. 26 illustrates an example transmission bandwidth configuration 2600 for wideband frequency-hopping with a fixed overlapping transmission bandwidth according to an embodiment of the present disclosure. In FIGS. 24-26, the vertical axes may represent frequency in PRBs, and the horizontal axes may represent time in some arbitrary units. FIGS. 24-26 are discussed using the same RedCap devices (Device 1 to Device 4) of FIGS. 11-13 and 21-23 and may use the same reference numerals as FIGS. 11-13 and 21-23 to refer to the same elements.

In an embodiment, the amount of frequency overlap between adjacent hops 1120 (consecutive in time) is set to a minimum value. To this end, the amount of overlap between adjacent hops 1120 may vary. The starting PRB (or center frequency) for the kth RedCap channel in Hop j is as shown below:

$${R}_{k} = ( {kN}_{RB}^{RC} + j ( {N}_{RB}^{RC} - {N}_{RB}^{overlap} ) ) mod ( {N}_{channel}^{RC} {N}_{RB}^{RC} ) , \qquad ( 18 )$$

$$where j = 0 , … , {N}_{hop} - 1 and k = 0 , … , {N}_{channel}^{RC} - 1.$$

Note the starting offset o is equal to 0 in Equation (18), and thus o is not shown in Equation (18). In other examples, a non-zero offset can be configured.

FIG. 24 illustrates the configuration 2400 utilizing the aforementioned minimum overlapping bandwidth configuration. In the illustrated example of FIG. 24, the minimum amount of overlapping bandwidth is

$${N}_{RB}^{overlap} = 1 PRB$$

(e.g., shown by 2406 for the first and second hops 1120 of Device 2),

$${N}_{RB}^{FH} = 51 PRBs$$

(shown by the frequency-hopping transmission bandwidth 2402),

$${N}_{RB}^{RC} = 10 PRBs$$

(shown by the Redcap channel bandwidth 2404), the number of hopping channels Nₕₒₚ=4 (for Device 1 to Device 4 where the first hop for Device 4 is shown by 2410), and the starting PRB (or center frequency) for each RedCap device (Device 1 to Device 4) is shown below in Table 16.

TABLE 16
Starting PRB with the minimum amount of the
overlapping bandwidth
$( {N}_{R B}^{o v e r l a p} = 1 PRB , {N}_{R B}^{F H} = 51 PRBs , {N}_{R B}^{R C} = 10 PRBs , and {N}_{h o p} = 4 )$

| | Hop j | | | | |
|---|---|---|---|---|---|
| ${N}_{c h a n n e l}^{R C}$ | 0 | 1 | 2 | 3 | 4 |
| | Rₖ | | | | |
| 0 | 0 | 9 | 18 | 27 | 36 |
| 1 | 10 | 19 | 28 | 37 | 6 |
| 2 | 20 | 29 | 38 | 7 | 16 |
| 3 | 30 | 39 | 8 | 17 | 26 |

As can be observed in FIG. 24, the overlapping bandwidth in the last hop is larger than Nₒᵥₑᵣₗₐₚ. For instance, the amount of overlapping bandwidth is 6 PRBs between the first and the last hops for Device 4 as shown by 2408. A similar observation can be made for Device 2 and Device 3 as shown by 2408.

As can be further observed in FIG. 24, there are unused or unsounded PRBs at the top (the higher channel portion) and/or bottom (the lower channel portion) of the frequency-hopping transmission bandwidth 2402 for each Device 1-4. To measure the unsounded PRBs, an additional hop can be added in the time domain as shown in FIG. 25.

FIG. 25 illustrates the configuration 2500 using the same configuration as the configuration 2400 of FIG. 24 and may use the same reference numerals as in FIG. 24 to refer to the same elements. The configuration 2500 further adds an additional hop for each device in the time domain with a varying number of overlapping PRBs exceeding the minimum of 1 PRB to sound the unused PRBs shown in FIG. 24. For instance, the additional hop for Device 4 is shown by 2510.

In contrast to the configuration 2400 of FIG. 24 and the configuration 2500 of FIG. 25, FIG. 26 illustrates the configuration 2600 with the amount of overlapping bandwidth set to a constant (a fixed value) between adjacent hops in the time domain. For the configuration 2600, the starting PRB (or center frequency) for the kth RedCap channel in Hop j is as shown below:

$${R}_{k} = ( k + j ) {N}_{RB}^{RC} - {jN}_{RB}^{overlap} - \{ \begin{matrix}0 , & ( k + j ) {N}_{RB}^{RC} - {jN}_{RB}^{overlap} < {N}_{channel}^{RC} {N}_{RB}^{RC} \\ ( {N}_{channel}^{RC} + 1 ) ( {N}_{RB}^{RC} - {N}_{RB}^{overlap} ) , & otherwise\end{matrix} , \qquad ( 19 )$$

$$where j = 0 , … , {N}_{hop} - 1 and k = 0 , … , {N}_{channel}^{RC} - 1.$$

The starting PRB for each RedCap device (Devices 1-4) is shown in Table 17.

TABLE 17
Starting PRB with a fixed amount of
overlapping bandwidth
$( {N}_{R B}^{o v e r l a p} = 1 PRB , {N}_{R B}^{F H} = 51 PRBs , {N}_{R B}^{R C} = 10 PRBs , and {N}_{h o p} = 4 )$

| | Hop j | | | | |
|---|---|---|---|---|---|
| ${N}_{c h a n n e l}^{R C}$ | 0 | 1 | 2 | 3 | 4 |
| | Rk | | | | |
| 0 | 0 | 9 | 18 | 27 | 36 |
| 1 | 10 | 19 | 28 | 37 | 1 |
| 2 | 20 | 29 | 38 | 2 | 11 |
| 3 | 30 | 39 | 8 | 12 | 21 |

As can be observed from FIG. 26, there may be frequency gaps (unused PRBs) between multiplexed devices in the third, fourth, and last hops, and the number of PRBs in the frequency gaps is 5 PRBs as shown by 2602. To measure the unsounded PRBs at either the top (high-frequency) portion or the bottom (low-frequency) portion of the wide frequency-hopping transmission bandwidth 2402, an additional hop can be added in the time domain. As the amount of overlapping PRBs is fixed to 1 PRB, the RedCap device may sound the remaining PRBs causing the RedCap transmission bandwidth to be less than the configured transmission bandwidth

$${N}_{RB}^{RC} = 10 PRBs .$$

In embodiments, the AN 110 may signal a set of starting locations for a RedCap UE (e.g., Device 1 to Device 4) to use for wideband frequency-hopping. For example, the AN 110 may send the first row of Table 17 to one UE and the second row of Table 17 to a different UE. In this way, a RedCap UE may know when to hop.

As can be observed in FIGS. 24-27, for the wrapped staircase pattern, the first hop can only overlap with the last hop in the frequency domain, which may degrade the performance of the wideband positioning measurement when individual SRS resources received in each hop are coherently combined. To alleviate the performance degradation, one embodiment is to ensure consecutive adjacent hops are overlapped in frequency. Consequently, a RedCap device is associated with an individual hopping cycle where the first hop begins from the lower channel edge of the frequency-hopping bandwidth instead of a common hopping cycle for all frequency multiplexed devices. Referring to FIG. 24 and FIG. 26, the hopping cycle for Device 2 may start in the fifth hop, the hopping cycle for Device 3 may start in the fourth hop for Device 3, and the hopping cycle for Device 4 may start in the third hop. In this way, the hopping pattern of Device 2, Device 3, and Device 4 may be transformed from a wrapped staircase to an ascending staircase. A wrapped descending staircase can also be transformed to a descending staircase in a similar manner.

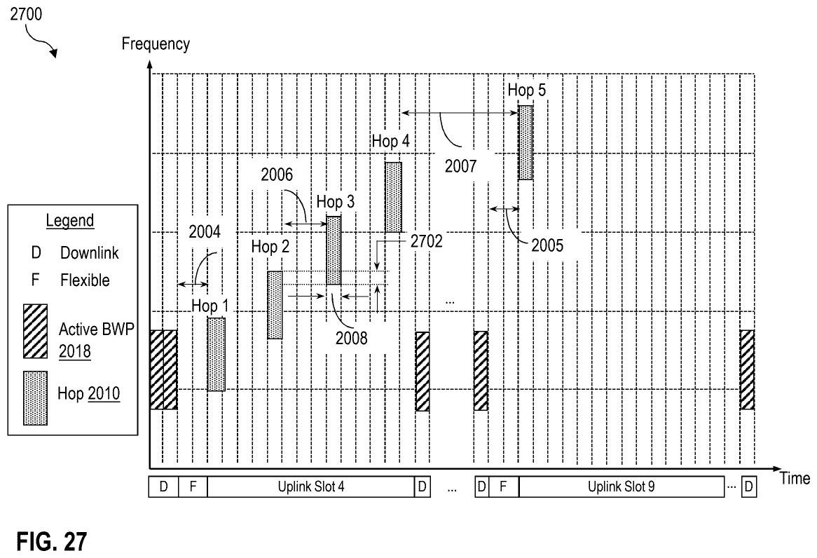

FIG. 27 illustrates an example TDD configuration 2700 for partial overlapping wideband frequency-hopping according to an embodiment of the present disclosure. In embodiments, the AN 110 may configure the RedCap UE 120a to perform wideband frequency-hopping for positioning as shown in the TDD configuration 2700. In FIG. 27, the vertical axis may represent frequency in some arbitrary units, and the horizontal axis may represent time in symbols and slots (e.g., the slots 1702, 1802, and 1902). The configuration 2700 utilizes the slots and symbols configuration 1900 where slots are arranged in repeating “3D1SIU” as discussed above with reference to FIG. 19. Further, the configuration 2700 utilizes the same hopping structure in time as the configuration 2000 discussed above with reference to FIG. 20 and may use the same reference numerals as in FIG. 20 to refer to the same elements. However, adjacent hops in FIG. 27 are partially overlapping in frequency. As shown in FIG. 27, configuration 2700 includes 5 hops 2010 (shown as Hop 1, Hop 2, Hop 3, Hop 4, and Hop 5) partially overlapping in frequency (e.g., by 2 PRBs). For case of illustration, FIG. 27 only shows the reference numeral 2702 for the overlapping bandwidth between Hop 2 and Hop 3. As discussed above, the uplink slot 4 can only accommodate four hops (Hop 1 to Hop 4), and thus the last hop is in the next uplink slot, which is slot 9.

In embodiments, the AN 1100 may configure the RedCap UE 120a to perform transmissions, receptions, and measurements with wideband frequency-hopping for positioning using any suitable combinations of configurations discussed above with reference to FIGS. 3-7, 9, and 11-27.

In an embodiment, the RedCap UE 120a may be configured, via higher layer parameters (e.g., m_{SRS,0}, m_{SRS,1}, LUT similar to Tables 6 and 7), subject to UE capability, to perform transmit frequency-hopping separate from an active BWP configuration and outside of the active BWP (e.g., as discussed above with reference to FIGS. 3, 17, 20, 27). The RedCap UE 120a transmit frequency-hopping may be configured within one SRS resource for positioning (e.g., as discussed above with reference to FIG. 5). The positioning may be configured with a bandwidth larger than the maximum bandwidth of the RedCap UE 120a as discussed above with reference to FIGS. 3-27.

In an embodiment, the RedCap UE 120a may be configured to measure and report, subject to UE capability, within a measurement gap, to perform receiver frequency-hopping (e.g., for PRS measurements as discussed above with reference to FIGS. 9 and 10). The RedCap UE 120a performing receiver frequency-hopping may be configured to report measurement(s) associated with the receiver frequency-hopping. The RedCap UE 120a may report measurement(s) of all hops of PRSs using receiver frequency-hopping.

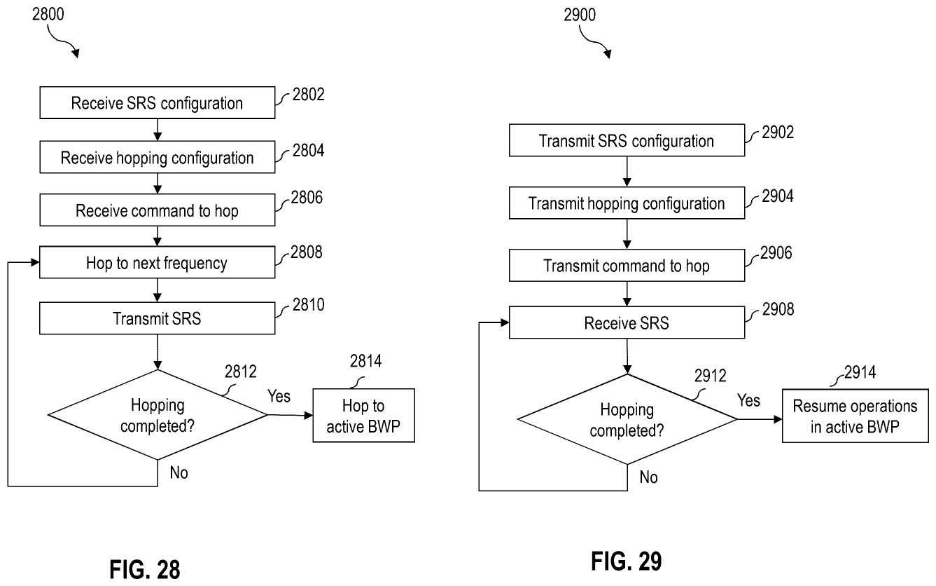

FIG. 28 is a flowchart of an example method 2800 for performing wideband positioning with frequency-hopping according to an embodiment of the present disclosure. The method 2800 may be implemented by a UE having reduced capabilities. In embodiments, the UE may correspond to the RedCap UE 120a or one of the Device 1 to Device 5 as discussed herein. In embodiments, the UE may implement the method 2800 using a computer system with components as shown in FIGS. 35B, and/or 36. The method 2800 may use similar mechanism as discussed above with reference to FIGS. 1-27. As illustrated, FIG. 28 includes a number of enumerated operations, but embodiments of the operations in FIG. 28 may include additional operations before, after, and in between the enumerated operations. In some embodiments, one or more of the enumerated operations may be omitted or performed in a different order.

After the UE provides capability signaling of the features that the UE supports, the UE receives configurations (e.g., from a network or AN similar to the AN 110). Some of the features include SRS capability, support of RedCap, and support of RedCap positioning.

As shown in FIG. 28, at operation 2802, the UE receives an SRS configuration. The SRS configuration can include comb pattern, bandwidth, seeds for scrambling initialization including identifiers, and number of symbols for an SRS resource. There may be one or more SRS configurations (e.g., as discussed above with reference to FIGS. 5-7).

At operation 2804, the UE receives a hopping configuration. The hopping configuration can include switching time between hops, wideband bandwidth, ascending/descending flag for the staircase pattern (e.g., to determine s), measurement gap duration (when the UE is unable to perform some cellular operations including receiving physical downlink control channel (PDCCH), receiving synchronization signal block (SSB)), parameters for the hop (e.g., overlap, non-overlap, number of cycles, bandwidth of hop), reference to the SRS configuration to use, starting index (e.g., j) for the first hop), and offset o. In an example, the switching time may be similar to the switching time 506, 906, 1106, 1706, 1806, and 2006, and the measurement gap duration may be similar to the FHMG length 914.

One benefit of a measurement gap is that a UE can operate outside the UE's active BWP without an expectation of receiving signals or transmitting signals within the active BWP for the duration of the measurement gap. Since the UE may be configured with an uplink active BWP and a downlink active BWP, it is possible to apply the measurement gap to one of the active BWPs. For the uplink, a measurement gap can be considered a time window where no uplink transmissions may occur except for the SRS transmission(s). This time window allows a UE to operate in the DL active BWP while hopping outside the uplink active BWP to transmit SRS(s). The UE may not transmit scheduled physical uplink shared channel (PUSCH) or PUCCH during that the time window. For example, in a frequency-division duplexing (FDD) deployment, a RedCap UE can receive in the downlink active BWP while transmitting SRS(s) outside the uplink active BWP. The UE is not expected to transmit any other uplink signal during that time window. In a TDD deployment, a RedCap UE alternates between transmit and receive phases. For the transmission of SRS(s), the UE operates outside the active bandwidth part. At the start of a receive phase, the UE may switch to the active BWP to receive transmissions. At the beginning of a transmit phase, the UE may switch outside the active BWP to operate at the next hop. In this case, a time window may cover the transmit phase. An example of such a scenario is shown in FIG. 27 between hop 4 and hop 5. Referring to FIG. 27, the RedCap UE 120a switches from a transmit phase during which the UE transmit SRS in a hop 2010 (e.g., hop 4) outside of the active BWP 2018 to a receive phase (e.g., the gap 2007) during which the RedCap UE 120a receives signals within the active BWP 2018, and further switches from the receive phase back to the transmit phase during which the RedCap UE 120a transmits SRS in a next hop 2010 (e.g., hop 5) outside of the active BWP 2018.

Returning to FIG. 28, at operation 2806, the UE receives a command to hop. In an example, the command may be a Medium Access Control (MAC) message. In another example, the command may be Downlink Control Information (DCI). In other embodiments, the UE can begin hopping after receiving the SRS configuration and the hopping configuration without an explicit command to hop.

At operation 2808, the UE hops to the next frequency hop according to the hopping configuration. If this is the first hop, the UE hops to the first location. If the first location is located within the active BWP of the UE, a delay may not be necessary. If this not the first hop, the UE waits for a delay (e.g., a hop switching time) before transmitting an SRS.

At operation 2810, after the delay, the UE transmits the SRS according to the SRS configuration.

At operation 2812, the UE determines whether hopping is completed (e.g., completing all hops in a hopping cycle). If the hopping is not completed, the UE proceeds to operation 2810 and continues with the hopping. Otherwise, the UE proceeds to operation 2814. At operation 2814, the UE hops back to the active BWP and resumes cellular operations (e.g., communications with the network).

FIG. 29 is a flowchart of an example method 2900 for performing wideband positioning with frequency-hopping according to an embodiment of the present disclosure. The method 2900 may be implemented by an AN. In embodiments, the AN may correspond to the AN 110 as discussed herein. In embodiments, the AN may implement the method 2900 using a computer system with components as shown in FIGS. 35B and/or 36. The method 2900 may use similar mechanism as discussed above with reference to FIGS. 1-27. As illustrated, FIG. 29 includes a number of enumerated operations, but embodiments of the operations in FIG. 29 may include additional operations before, after, and in between the enumerated operations. In some embodiments, one or more of the enumerated operations may be omitted or performed in a different order.

After the AN receives capability signaling of the features from a RedCap UE (e.g., the RedCap UE 120a), the AN transmits configurations. Some of the features include SRS capability, support of RedCap, and support of RedCap positioning.

As shown in FIG. 29, at operation 2902, the AN transmits an SRS configuration. The SRS configuration can include comb pattern, bandwidth, seeds for scrambling initialization including identifiers, and number of symbols for an SRS resource. There may be one or more SRS configurations (e.g., as discussed above with reference to FIGS. 5-7).

At operation 2904, the AN transmits a hopping configuration. The hopping configuration can include switching time between hops, wideband bandwidth, ascending/descending flag for the staircase pattern, measurement gap duration (when the UE is unable to perform some cellular operations including receiving PDCCH), parameters for the hop (e.g., overlap, non-overlap, number of cycles, bandwidth of hop), reference to the SRS configuration to use. In an example, the switching time may be similar to the switching time 506, 906, 1106, 1706, 1806, and 2006, and the measurement gap duration may be similar to the FHMG length 914.

Because the AN generally operates as a wideband receiver, the AN does not have to hop. The AN has to know when the UE may transmit and over which resources the UE may transmit. In examples, the AN can indicate to the UE when to begin hopping. For instance, at operation 2906, the AN transmits, to the UE, a command (e.g., a MAC message or DCI) to hop. The transmission of the command may also start a measurement gap (e.g., as discussed above with reference to FIGS. 9-10).

At operation 2908, after accounting for the hopping switch of the UE, the AN receives an SRS transmission of the UE in accordance with the SRS configuration. Depending on the hopping configuration, the AN may perform additional processing on the received SRS signal. For example, if there is an overlap between hops, the AN may attempt to resolve phase discontinuities and/or perform phase compensation. This process of waiting for the UE to switch (hop) frequencies and receive/process the SRS continues until the hopping cycle is completed. For instance, at operation 2912, the AN determines whether hopping (or hopping cycle) is completed for the UE. If the hopping is not completed, the AN may return to operation 2908 and wait to receive the next SRS. If the hopping is completed, the AN may wait for the UE to hop to the active BWP before resuming cellular operations with the UE at operation 2914. In examples, the AN may combine and send the processed SRS information as a report to a location server (that provides location services to the UE, for example).

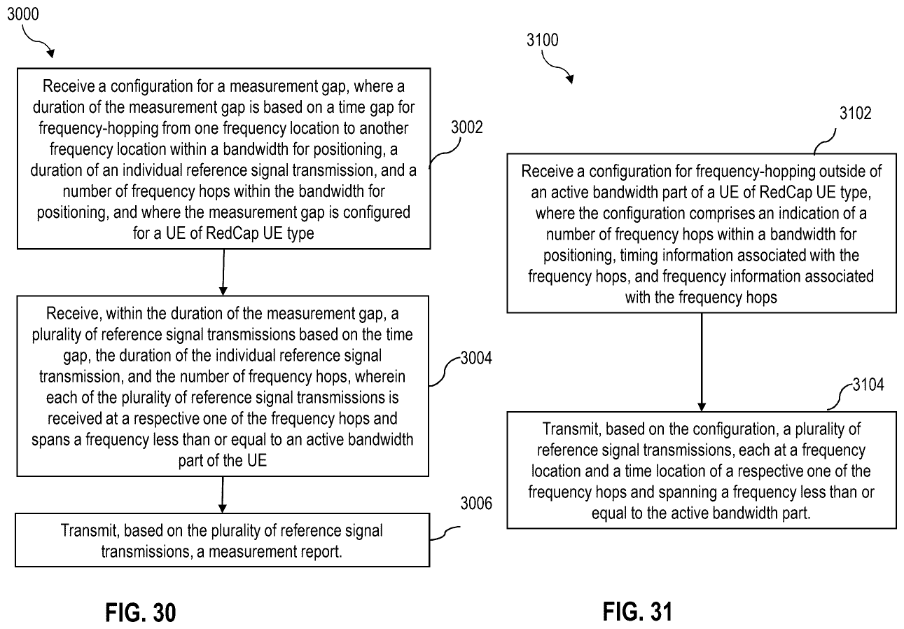

FIG. 30 is a flowchart of an example reference signal transmission method 3000 with wideband frequency-hopping for positioning according to an embodiment of the present disclosure. The method 3000 may be implemented by a UE having reduced capabilities. In embodiments, the UE may correspond to the RedCap UE 120a or one of the Device 1 to Device 5 as discussed herein. In embodiments, the UE may implement the method 3000 using a computer system with components as shown in FIGS. 33B, and/or 34. The method 3000 may use similar mechanism as discussed above with reference to FIGS. 1-29. As illustrated, FIG. 30 includes a number of enumerated operations, but embodiments of the operations in FIG. 30 may include additional operations before, after, and in between the enumerated operations. In some embodiments, one or more of the enumerated operations may be omitted or performed in a different order.

At operation 3002, the UE receives a configuration for a measurement gap. The configuration may be received from an AN similar to the AN 110, for example. A duration of the measurement gap is based on a time gap for frequency-hopping from one frequency location to another frequency location within a bandwidth for positioning, a duration of an individual reference signal transmission, and a number of frequency hops within the bandwidth for positioning. The measurement gap is configured for a reduced capability UE (e.g., the UE) that supports a bandwidth less than the bandwidth for positioning. In examples, the measurement gap may correspond to the FHMG 912. The duration of the measurement gap may correspond to the FHMG length 914 T_{FHMG}. The time gap may correspond to the hop switching time 506, 906, 1106, 1706, 1806, and/or 2006 t_{switch}. The duration of the individual signal transmission may correspond to the hop dwell time 508, 908, 1108, 1708, 1808, and/or 2008 t_{dwell}. The bandwidth for positioning may correspond to the bandwidths 502, 902, 1102, 1402, and/or 2402 BWₜₒₜₐₗ. The frequency hops may correspond to the hops 510, 1120, 1810, 2010, and/or 2410.

In an embodiment, the duration of the measurement gap is further based on a second time gap for frequency-hopping from a frequency location of the active BWP to a frequency location of an earliest frequency hop of the frequency hops in time. In examples, the active BWP may correspond to the initial BWP 1718 and/or the active BWP 2018, and the second time gap may correspond to the initial switching time 1704 and/or 2004 tᵢₙᵢ.

At 3004, the UE receives, within the duration of the measurement gap, a plurality of reference signal transmissions based on the time gap, the duration of the individual reference signal transmission, and the number of frequency hops. The plurality of reference signal transmission may be received from the AN, for example. Each of the plurality of reference signal transmissions is received at a respective one of the frequency hops and spans a frequency less than or equal to an active BWP of the UE. In an embodiment, as part of receiving the plurality of reference signal transmissions, the UE receives a PRS at a frequency location of a respective one of the frequency hops (e.g., as discussed above with reference to FIGS. 9 and 10).

At 3006, the UE transmits, based on the plurality of reference signal transmissions, a measurement report. The measurement report may be transmitted to the AN, for example.

In embodiments, the UE further receives a hopping configuration indicating information associated with frequency locations of the frequency hops. In an embodiment, the hopping configuration includes at least one of an indication of a common hop bandwidth (e.g., the IBW 504 and/or the channel bandwidth 308) for each of the frequency hops, an index to a LUT (e.g., Table 6 and Table 7) having a plurality of entries, each indicating a number of resource blocks in a hop bandwidth (e.g., m_{SRSp,0}, m_{SRSp,1}) of an individual frequency hop based on a respective one of a plurality of subcarrier spacings and a respective one of a plurality of channel bandwidths (e.g., BW_{channel}), an indication of a number of overlapping resource blocks (e.g., N_RB\hat{ }overlap) between adjacent frequency hops of the frequency hops, or an indication of the number of frequency hops (e.g., Nₕₒₚ) within the bandwidth for positioning. In an embodiment, the number of frequency hops within the bandwidth for positioning is based on the bandwidth for positioning, a common hop bandwidth for each of the frequency hops, and a number of overlapping frequency resources

$$( e . g . , {N}_{RB}^{overlap} )$$

between adjacent frequency hops of the frequency hops.

FIG. 31 is a flowchart of an example reference signal transmission method 3100 with wideband frequency-hopping for positioning according to an embodiment of the present disclosure. The method 3100 may be implemented by a UE having reduced capabilities. In embodiments, the UE may correspond to the RedCap UE 120a or one of the Device 1 to Device 5 as discussed herein. In embodiments, the UE may implement the method 3100 using a computer system with components as shown in FIGS. 33B, and/or 34. The method 3100 may use similar mechanism as discussed above with reference to FIGS. 1-29. As illustrated, FIG. 31 includes a number of enumerated operations, but embodiments of the operations in FIG. 31 may include additional operations before, after, and in between the enumerated operations. In some embodiments, one or more of the enumerated operations may be omitted or performed in a different order.

At operation 3102, the UE receives a configuration for frequency-hopping outside of an active BWP of a reduced capability UE (corresponding to the UE). The configuration may be received from an AN similar to the AN 110, for example. The configuration includes an indication of a number of frequency hops within a bandwidth for positioning, timing information associated with the frequency hops, and frequency information associated with the frequency hops. The UE is of a reduced capability UE type supporting a bandwidth less than the bandwidth for positioning and greater than or equal to the active BWP. In examples, the bandwidth for positioning may correspond to the bandwidths 502, 902, 1102, 1402, and/or 2402 BWₜₒₜₐₗ, and the frequency hops may correspond to the hops 510, 1120, 1810, 2010, and/or 2410.

In an embodiment, the configuration further includes at least one of an indication of a common hop bandwidth (e.g., the IBW 504 and/or the channel bandwidth 308) for each of the frequency hops, an index to a LUT (e.g., Table 6 and Table 7) having a plurality of entries, each indicating a number of PRBs in a hop bandwidth (e.g., m_{SRSp,0}, m_{SRSp,1}) of an individual frequency hop based on a respective one of a plurality of subcarrier spacings and a respective one of a plurality of channel bandwidths (e.g., BW_{channel}), an indication of a starting PRB for an earliest (or first) frequency hop of the frequency hops in time (e.g., as shown in Tables 16 and 17), or an indication of a number of overlapping resource blocks

$$( e . g . , {N}_{RB}^{overlap} )$$

between adjacent frequency hops of the frequency hops.

In an embodiment, the configuration further includes an indication of a starting slot offset (e.g., S_{offset}) and a starting symbol (e.g., l_{hop j}) for an earliest (or first) frequency hop of the frequency hops in time and a number of OFDM symbols (e.g., t_{dwell}) for an individual frequency hop of the frequency hops.

At operation 3104, the UE transmits, based on the configuration, a plurality of reference signal transmissions, each at a frequency location and a time location of a respective one of the frequency hops and spanning a frequency less than or equal to the active BWP (e.g., as discussed above with reference to FIG. 8). The time location of each of the frequency hops may refer to a symbol of a slot, and each frequency hop may span a number of symbols in time. The plurality of reference signal transmissions may be transmitted to the AN, for example. In an embodiment, the reference signal transmissions are SRSs for positioning.

In an embodiment, the UE further receives an indication of a reference signal resource to be used for the plurality of reference signal transmissions. The indication may be received from the AN, for example. In one embodiment, a frequency span of the reference signal resource spans a bandwidth of an individual frequency hop of the frequency hops (e.g., as discussed above with reference to FIG. 5). In another embodiment, the frequency span of the reference signal resource spans the bandwidth for positioning (e.g., as discussed above with FIG. 6).

In an embodiment, a frequency location of a current frequency hop of the frequency hops is higher than a frequency location of a previous adjacent frequency hop of the frequency hops in time (e.g., an ascending staircase frequency-hopping pattern as discussed above with reference to FIGS. 3, 5-7, 11, 13, 14-16, 17-18, 21, and 23-27).

In an embodiment, a frequency location of a current frequency hop of the frequency hops is lower than a frequency location of a previous adjacent frequency hop of the frequency hops in time (e.g., a descending staircase frequency-hopping pattern as discussed above with reference to FIGS. 12 and 22).

In an embodiment, a frequency location of a highest-frequency frequency hop of the frequency hops is adjacent and prior, in time, to a lowest-frequency frequency hop of the frequency hops (e.g., a wrapped ascending staircase frequency-hopping pattern as discussed above with reference to FIGS. 11, 13, 21, and 23-27). In an embodiment, a frequency location of a highest-frequency frequency hop of the frequency hops is adjacent and subsequent, in time, to a lowest-frequency frequency hop of the frequency hops (e.g., a wrapped descending staircase frequency-hopping pattern as discussed above with reference to FIGS. 12 and 22).

In an embodiment, the number of frequency hops within the bandwidth for positioning is based on the bandwidth for positioning, a common hop bandwidth for each of the frequency hops, and a number of overlapping frequency resources

$$( e . g . , {N}_{RB}^{overlap} )$$

between adjacent frequency hops of the frequency hops.

In an embodiment, the UE further receives a configuration for a time window. A duration of the time window is based on an individual reference signal transmission and the number of frequency hops within the bandwidth for positioning. The plurality of reference signal transmissions are transmitted within the duration of the time window.

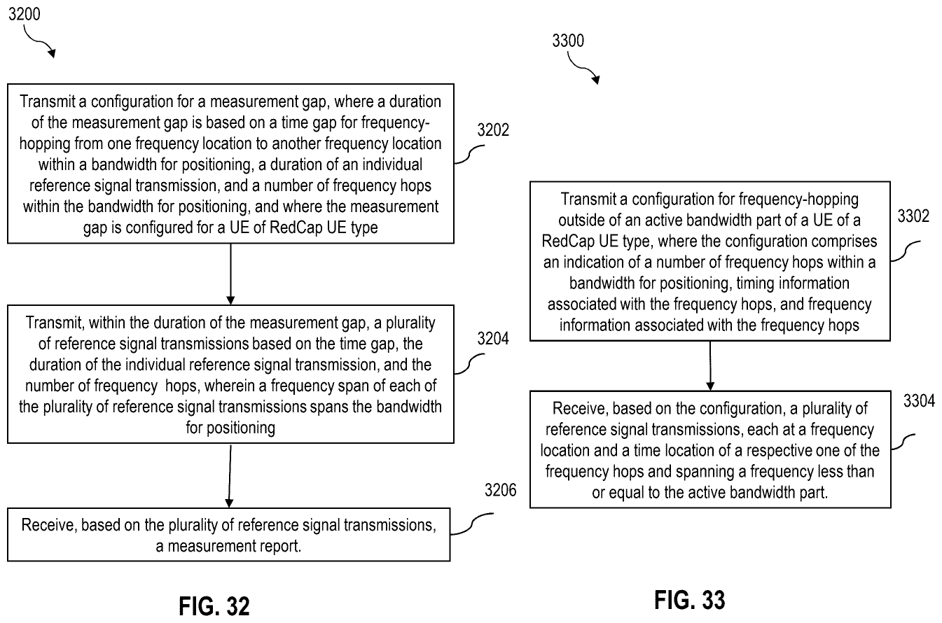

FIG. 32 is a flowchart of an example reference signal transmission method 3200 with wideband frequency-hopping for positioning according to an embodiment of the present disclosure. The method 3200 may be implemented by an AN. In embodiments, the AN may correspond to the AN 110. In embodiments, the AN may implement the method 3100 using a computer system with components as shown in FIGS. 35A and/or 36. The method 3100 may use similar mechanism as discussed above with reference to FIGS. 1-29. As illustrated, FIG. 32 includes a number of enumerated operations, but embodiments of the operations in FIG. 32 may include additional operations before, after, and in between the enumerated operations. In some embodiments, one or more of the enumerated operations may be omitted or performed in a different order.

At operation 3202, the AN transmits a configuration for a measurement gap. The configuration may be transmitted to a UE or more than one UEs similar to the RedCap UE 120a, for example. A duration of the measurement gap is based on a time gap for frequency-hopping from one frequency location to another frequency location within a bandwidth for positioning, a duration of an individual reference signal transmission, and a number of frequency hops within the bandwidth for positioning. The measurement gap is configured for a reduced capability UE (e.g., at least the UE) that supports a bandwidth less than the bandwidth for positioning. In examples, the measurement gap may correspond to the FHMG 912. In examples, the measurement gap may correspond to the FHMG 912. The duration of the measurement gap may correspond to the FHMG length 914 T_{FHMG}. The time gap may correspond to the hop switching time 506, 906, 1106, 1706, 1806, and/or 2006 t_{switch}. The duration of the individual signal transmission may correspond to the hop dwell time 508, 908, 1108, 1708, 1808, and/or 2008 t_{dwell}. The bandwidth for positioning may correspond to the bandwidths 502, 902, 1102, 1402, and/or 2402 BWₜₒₜₐₗ. The frequency hops may correspond to the hops 510, 1120, 1810, 2010, and/or 2410.

In an embodiment, the duration of the measurement gap is further based on a second time gap for frequency-hopping from a frequency location of an active BWP to a frequency location of an earliest frequency hop of the frequency hops in time. In examples, the active BWP may correspond to the initial BWP 1718 and/or the active BWP 2018, and the second time gap may correspond to the initial switching time 1704 and/or 2004 tᵢₙᵢ.

At 3204, the AN transmits, within the duration of the measurement gap, a plurality of reference signal transmissions based on the time gap, the duration of the individual reference signal transmission, and the number of frequency hops. The plurality of reference signal transmission may be transmitted to the UE, for example. In an embodiment, as part of transmitting the plurality of reference signal transmissions, the AN transmits a PRS, where a frequency span of the PRS spans the bandwidth for positioning (e.g., as discussed above with reference to FIGS. 9 and 10).

At 3206, the AN receives, based on the plurality of reference signal transmissions, a measurement report. The measurement report may be received from the UE, for example.

In embodiments, the AN further transmits a hopping configuration indicating information associated with frequency locations of the frequency hops. The hopping configuration may be transmitted to the UE, for example. In an embodiment, the hopping configuration includes at least one of an indication of a common hop bandwidth (e.g., the IBW 504 and/or the channel bandwidth 308) for each of the frequency hops, an index to a LUT (e.g., Table 6 and Table 7) having a plurality of entries, each indicating a number of resource blocks in a hop bandwidth (e.g., m_{SRSp,0}, m_{SRSp,1}) of an individual frequency hop based on a respective one of a plurality of subcarrier spacings and a respective one of a plurality of channel bandwidths (e.g., BW_{channel}), an indication of a number of overlapping resource blocks

$$( e . g . , {N}_{RB}^{overlap} )$$

between adjacent frequency hops of the frequency hops, or an indication of the number of frequency hops (e.g., Nₕₒₚ) within the bandwidth for positioning. In an embodiment, the number of frequency hops within the bandwidth for positioning is based on the bandwidth for positioning, a common hop bandwidth for each of the frequency hops, and a number of overlapping frequency resources

$$( e . g . , {N}_{RB}^{overlap} )$$

between adjacent frequency hops of the frequency hops.

FIG. 33 is a flowchart of an example reference signal transmission method 3300 with wideband frequency-hopping for positioning according to an embodiment of the present disclosure. The method 3300 may be implemented by an AN. In embodiments, the AN may correspond to the AN 110. In embodiments, the AN may implement the method 3200 using a computer system with components as shown in FIGS. 35A and/or 36. The method 3200 may use similar mechanism as discussed above with reference to FIGS. 1-29. As illustrated, FIG. 33 includes a number of enumerated operations, but embodiments of the operations in FIG. 33 may include additional operations before, after, and in between the enumerated operations. In some embodiments, one or more of the enumerated operations may be omitted or performed in a different order.

At operation 3302, the AN transmits a configuration for frequency-hopping outside of an active BWP of a UE (e.g., similar to the RedCap UE 120a). The configuration may be transmitted to the UE, for example. The configuration includes an indication of a number of frequency hops within the bandwidth for positioning, timing information associated with the frequency hops, and frequency information associated with the frequency hops. The UE is a reduced capability UE type supporting a bandwidth less than the bandwidth for positioning and greater than or equal to the active BWP. In examples, the bandwidth for positioning may correspond to the bandwidths 502, 902, 1102, 1402, and/or 2402 BWₜₒₜₐₗ, and the frequency hops may correspond to the hops 510, 1120, 1810, 2010, and/or 2410.

In an embodiment, the configuration further includes at least one of an indication of a common hop bandwidth (e.g., the IBW 504 and/or the channel bandwidth 308) for each of the frequency hops, an index to a LUT (e.g., Table 6 and Table 7) having a plurality of entries, each indicating a number of physical resource blocks in a hop bandwidth (e.g., m_{SRSp,0}, m_{SRSp,1}) of an individual frequency hop based on a respective one of a plurality of subcarrier spacings and a respective one of a plurality of channel bandwidths (e.g., BW_{channel}), an indication of a starting physical resource block for an earliest (or first) frequency hop of the frequency hops in time (e.g., as shown in Tables 16 and 17), or an indication of a number of overlapping resource blocks (e.g., N_RB\hat{ }overlap) between adjacent frequency hops of the frequency hops.

In an embodiment, the configuration further includes an indication of a starting slot offset (e.g., S_{offset}) and a starting symbol (e.g., l_{hop j}) for an earliest (or first) frequency hop of the frequency hops in time and a number of OFDM symbols (e.g., t_{dwell}) for an individual frequency hop of the frequency hops.

At operation 3304, the AN receives, based on the configuration, a plurality of reference signal transmissions, each at a frequency location and a time location of a respective one of the frequency hops and spanning a frequency less than or equal to the active BWP (e.g., as discussed above with reference to FIG. 8). The time location of each of the frequency hops may refer to a symbol of a slot, and each frequency hop may span a number of symbols in time. The plurality of reference signal transmission may be received from the UE, for example. In an embodiment, the reference signal transmissions are SRSs for positioning.

In an embodiment, the AN further transmits an indication of a reference signal resource to be used for the plurality of reference signal transmissions. The indication may be transmitted to the UE, for example. In one embodiment, a frequency span of the reference signal resource spans a bandwidth of an individual frequency hop of the frequency hops (e.g., as discussed above with reference to FIGS. 5 and 7). In another embodiment, the frequency span of the reference signal resource spans the bandwidth for positioning (as discussed above with FIG. 6).

In an embodiment, a frequency location of a current frequency hop of the frequency hops is higher than a frequency location of a previous adjacent frequency hop of the frequency hops in time (e.g., an ascending staircase frequency-hopping pattern as discussed above with reference to FIGS. 3-7, 11, 13, 14-16, 17-18, 21, and 23-27).

In an embodiment, a frequency location of a current frequency hop of the frequency hops is lower than a frequency location of a previous adjacent frequency hop of the frequency hops in time (e.g., a descending staircase frequency-hopping pattern as discussed above with reference to FIGS. 12 and 22).

In an embodiment, a frequency location of a highest-frequency frequency hop of the frequency hops is adjacent and prior, in time to a lowest-frequency frequency hop of the frequency hops (e.g., a wrapped ascending staircase frequency-hopping pattern as discussed above with reference to FIGS. 11, 13, 21, and 23-27). In an embodiment, a frequency location of a highest-frequency frequency hop of the frequency hops is adjacent and subsequent, in time, to a lowest-frequency frequency hop of the frequency hops (e.g., a wrapped descending staircase frequency-hopping pattern as discussed above with reference to FIGS. 12 and 22).

In an embodiment, the number of frequency hops within the bandwidth for positioning is based on the bandwidth for positioning, a common hop bandwidth for each of the frequency hops, and a number of overlapping frequency resources

$$( e . g . , {N}_{RB}^{overlap} )$$

between adjacent frequency hops of the frequency hops.

In an embodiment, the AN further transmits a configuration for a time window. A duration of the time window is based on an individual reference signal transmission and the number of frequency hops within the bandwidth for positioning. The plurality of reference signal transmissions are received within the duration of the time window.

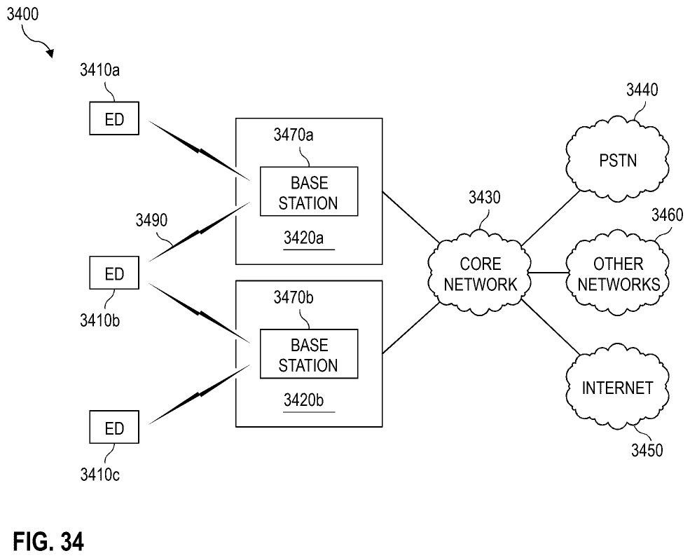

FIG. 34 illustrates an example communication system 3400. In general, the system 3400 enables multiple wireless or wired users to transmit and receive data and other content. The system 3400 may implement one or more channel access methods, such as CDMA, time-division multiple access (TDMA), frequency-division multiple access (FDMA), orthogonal FDMA (OFDMA), single-carrier FDMA (SC-FDMA), or non-orthogonal multiple access (NOMA).

In this example, the communication system 3400 includes electronic devices (ED) 3410a-2210c, radio access networks (RANs) 3420a-3420b, a core network 3430, a public switched telephone network (PSTN) 3440, the Internet 3450, and other networks 3460. While certain numbers of these components or elements are shown in FIG. 34, any number of these components or elements may be included in the system 3400.

The EDs 3410a-3410c are configured to operate or communicate in the system 3400. For example, the EDs 3410a-3410c are configured to transmit or receive via wireless or wired communication channels. Each ED 3410a-3410c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 3420a-3420b here include base stations 3470a-3470b, respectively. Each base station 3470a-3470b is configured to wirelessly interface with one or more of the EDs 3410a-3410c to enable access to the core network 3430, the PSTN 3440, the Internet 3450, or the other networks 3460. For example, the base stations 3470a-3470b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 3410a-3410c are configured to interface and communicate with the Internet 3450 and may access the core network 3430, the PSTN 3440, or the other networks 3460.

In the embodiment shown in FIG. 34, the base station 3470a forms part of the RAN 3420a, which may include other base stations, elements, or devices. Also, the base station 3470b forms part of the RAN 3420b, which may include other base stations, elements, or devices. Each base station 3470a-3470b operates to transmit or receive wireless signals within a particular geographic region or area, sometimes referred to as a “cell.” In some embodiments, multiple-input multiple-output (MIMO) technology may be employed having multiple transceivers for each cell.

The base stations 3470a-3470b communicate with one or more of the EDs 3410a-3410c over one or more air interfaces 3490 using wireless communication links. The air interfaces 3490 may utilize any suitable radio access technology.

It is contemplated that the system 3400 may use multiple channel access functionality, including such schemes as described above. In particular embodiments, the base stations and EDs implement 5G NR, LTE, LTE-A, or LTE-B. Of course, other multiple access schemes and wireless protocols may be utilized.

The RANs 3420a-3420b are in communication with the core network 3430 to provide the EDs 3410a-3410c with voice, data, application, Voice over Internet Protocol (VOIP), or other services. Understandably, the RANs 3420a-3420b or the core network 3430 may be in direct or indirect communication with one or more other RANs (not shown). The core network 3430 may also serve as a gateway access for other networks (such as the PSTN 3440, the Internet 3450, and the other networks 3460). In addition, some or all of the EDs 3410a-3410c may include functionality for communicating with different wireless networks over different wireless links using different wireless technologies or protocols. Instead of wireless communication (or in addition thereto), the EDs may communicate via wired communication channels to a service provider or switch (not shown), and to the Internet 3450.

Although FIG. 34 illustrates one example of a communication system, various changes may be made to FIG. 34. For example, the communication system 3400 could include any number of EDs, base stations, networks, or other components in any suitable configuration.

FIGS. 35A and 35B illustrate example devices that may implement the methods and teachings according to this disclosure. In particular, FIG. 35A illustrates an example ED 3510, and FIG. 35B illustrates an example base station 3570. These components could be used in the system 3400 or in any other suitable system.

As shown in FIG. 35A, the ED 3510 includes at least one processing unit 3500. The processing unit 3500 implements various processing operations of the ED 3510. For example, the processing unit 3500 could perform signal coding, data processing, power control, input/output processing, or any other functionality enabling the ED 3510 to operate in the system 100. The processing unit 3500 also supports the methods and teachings described in more detail above. Each processing unit 3500 includes any suitable processing or computing device configured to perform one or more operations. Each processing unit 3500 could, for example, include a microprocessor, microcontroller, digital signal processor, field-programmable gate array, or application specific integrated circuit.

The ED 3510 also includes at least one transceiver 3502. The transceiver 3502 is configured to modulate data or other content for transmission by at least one antenna 3504 or NIC (Network Interface Controller). The transceiver 3502 is also configured to demodulate data or other content received by the at least one antenna 3504. Each transceiver 3502 includes any suitable structure for generating signals for wireless or wired transmission or processing signals received wirelessly or by wire. Each antenna 3504 includes any suitable structure for transmitting or receiving wireless or wired signals. One or multiple transceivers 3502 could be used in the ED 3510, and one or multiple antennas 3504 could be used in the ED 3510. Although shown as a single functional unit, a transceiver 3502 could also be implemented using at least one transmitter and at least one separate receiver.

The ED 3510 further includes one or more input/output devices 3506 or interfaces (such as a wired interface to the Internet 3450). The input/output devices 3506 facilitate interaction with a user or other devices (network communications) in the network. Each input/output device 3506 includes any suitable structure for providing information to or receiving information from a user, such as a speaker, microphone, keypad, keyboard, display, or touch screen, including network interface communications.

In addition, the ED 3510 includes at least one memory 3508. The memory 3508 stores instructions and data used, generated, or collected by the ED 3510. For example, the memory 3508 could store software or firmware instructions executed by the processing unit(s) 3500 and data used to reduce or eliminate interference in incoming signals. Each memory 3508 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 35B, the base station 3570 includes at least one processing unit 3550, at least one transceiver 3552, which includes functionality for a transmitter and a receiver, one or more antennas 3556, at least one memory 3558, and one or more input/output devices or interfaces 3566. A scheduler, which would be understood by one skilled in the art, is coupled to the processing unit 3550. The scheduler could be included within or operated separately from the base station 3570. The processing unit 3550 implements various processing operations of the base station 3570, such as signal coding, data processing, power control, input/output processing, or any other functionality. The processing unit 3550 can also support the methods and teachings described in more detail above. Each processing unit 3550 includes any suitable processing or computing device configured to perform one or more operations. Each processing unit 3550 could, for example, include a microprocessor, microcontroller, digital signal processor, field-programmable gate array, or application specific integrated circuit.

Each transceiver 3552 includes any suitable structure for generating signals for wireless or wired transmission to one or more EDs or other devices. Each transceiver 3552 further includes any suitable structure for processing signals received wirelessly or by wire from one or more EDs or other devices. Although shown combined as a transceiver 3552, a transmitter and a receiver could be separate components. Each antenna 3556 includes any suitable structure for transmitting or receiving wireless or wired signals. While a common antenna 3556 is shown here as being coupled to the transceiver 3552, one or more antennas 3556 could be coupled to the transceiver(s) 3552, allowing separate antennas 3556 to be coupled to the transmitter and the receiver if equipped as separate components. Each memory 3558 includes any suitable volatile or non-volatile storage and retrieval device(s). Each input/output device 3566 facilitates interaction with a user or other devices (network communications) in the network. Each input/output device 3566 includes any suitable structure for providing information to or receiving/providing information from a user, including network interface communications.

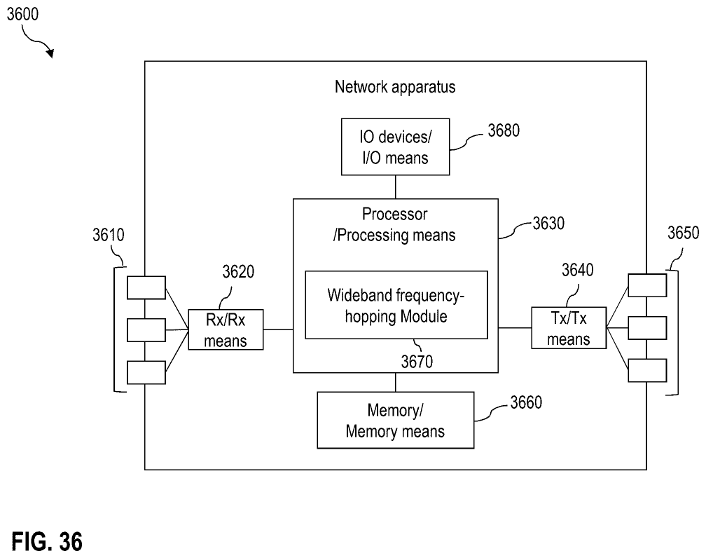

FIG. 36 is a schematic diagram of a computer apparatus 3600 (e.g., a network node, a base station, an AN, or UE, etc.). The computer apparatus 3600 is suitable for implementing the disclosed embodiments as described herein. The computer apparatus 3600 comprises ingress ports/ingress means 3610 (a.k.a., upstream ports) and receiver units (Rx)/receiving means 3620 for receiving data; a processor, logic unit, or central processing unit (CPU)/processing means 3630 to process the data; transmitter units (Tx)/transmitting means 3640 and egress ports/egress means 3650 (a.k.a., downstream ports) for transmitting the data; and a memory/memory means 3660 for storing the data. The computer apparatus 3600 may also comprise optical-to-electrical (OE) components and electrical-to-optical (EO) components coupled to the ingress ports/ingress means 3610, the receiver units/receiving means 3620, the transmitter units/transmitting means 3640, and the egress ports/egress means 3650 for egress or ingress of optical or electrical signals.

The processor/processing means 3630 is implemented by hardware and software. The processor/processing means 3630 may be implemented as one or more CPU chips, cores (e.g., as a multi-core processor), field-programmable gate arrays (FPGAs), application specific integrated circuits (ASICs), and digital signal processors (DSPs). The processor/processing means 3630 is in communication with the ingress ports/ingress means 3610, receiver units/receiving means 3620, transmitter units/transmitting means 3640, egress ports/egress means 3650, and memory/memory means 3660. The processor/processing means 3630 comprises a wideband frequency-hopping module 3670. The wideband frequency-hopping module 3670 is able to implement the methods disclosed herein. The inclusion of the wideband frequency-hopping module 3670 therefore provides a substantial improvement to the functionality of the computer apparatus 3600 and effects a transformation of the computer apparatus 3600 to a different state. Alternatively, the wideband frequency-hopping module 3670 is implemented as instructions stored in the memory/memory means 3660 and executed by the processor/processing means 3630.

The computer apparatus 3600 may also include input and/or output (I/O) devices or I/O means 3680 for communicating data to and from a user. The I/O devices or I/O means 3680 may include output devices such as a display for displaying video data, speakers for outputting audio data, etc. The I/O devices or I/O means 3680 may also include input devices, such as a keyboard, mouse, trackball, etc., and/or corresponding interfaces for interacting with such output devices.

The memory/memory means 3660 comprises one or more disks, tape drives, and solid-state drives and may be used as an over-flow data storage device, to store programs when such programs are selected for execution, and to store instructions and data that are read during program execution. The memory/memory means 3660 may be volatile and/or non-volatile and may be read-only memory (ROM), random access memory (RAM), ternary content-addressable memory (TCAM), and/or static random-access memory (SRAM).

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically. mechanically. or otherwise. Other examples of changes. substitutions, and alterations are ascertainable by one skilled in the art and could be made without departing from the spirit and scope disclosed herein.

What is claimed is:

1. A method for wireless communications, the method comprising:
receiving a configuration for frequency-hopping outside of an active bandwidth part of a user equipment (UE) of reduced capability (RedCap) UE type, wherein the configuration comprises an indication of a number of frequency hops within a bandwidth for positioning, timing information associated with the frequency hops, and frequency information associated with the frequency hops; and
transmitting, based on the configuration, a plurality of reference signal transmissions, each at a frequency location and a time location of a respective one of the frequency hops and spanning a frequency less than or equal to the active bandwidth part.

2. The method of claim 1, further comprising:
receiving an indication of a reference signal resource to be used for the plurality of reference signal transmissions, wherein a frequency span of the reference signal resource spans:
a bandwidth of an individual frequency hop of the frequency hops, or
the bandwidth for positioning.

3. The method of claim 1, wherein the configuration comprises at least one of:
an indication of a common hop bandwidth for each of the frequency hops;
an index to a lookup table (LUT) having a plurality of entries, each indicating a number of physical resource blocks in a hop bandwidth of an individual frequency hop based on a respective one of a plurality of subcarrier spacings and a respective one of a plurality of channel bandwidths;
an indication of a starting physical resource block for an earliest frequency hop of the frequency hops in time; or
an indication of a number of overlapping resource blocks between adjacent frequency hops of the frequency hops.

4. The method of claim 1, wherein the configuration comprises an indication of:
a starting slot offset and a starting symbol for an earliest frequency hop of the frequency hops in time; and
a number of orthogonal frequency-division multiplexing (OFDM) symbols for an individual frequency hop of the frequency hops.

5. The method of claim 1, wherein a frequency location of a current frequency hop of the frequency hops is higher than a frequency location of a previous adjacent frequency hop of the frequency hops in time.

6. The method of claim 1, wherein a frequency location of a highest-frequency frequency hop of the frequency hops is adjacent and prior, in time, to a lowest-frequency frequency hop of the frequency hops.

7. The method of claim 1, further comprising:
receiving a configuration for a time window, wherein a duration of the time window is based on an individual reference signal transmission and the number of frequency hops within the bandwidth for positioning,
wherein the plurality of reference signal transmissions are transmitted within the duration of the time window.

8. The method of claim 1, wherein the transmitting the plurality of reference signal transmissions comprises:
transmitting a sounding reference signal (SRS) for positioning.

9. A method for wireless communications, the method comprising:
receiving a configuration for a measurement gap, wherein a duration of the measurement gap is based on a duration of an individual reference signal transmission and a number of frequency hops spanning a frequency corresponding to a bandwidth for positioning, and wherein the measurement gap is configured for a user equipment (UE) of reduced capability (RedCap) UE type;
receiving, within the duration of the measurement gap, a plurality of reference signal transmissions based on the duration of the individual reference signal transmission and the number of hops, wherein each of the plurality of reference signal transmissions is received at a respective one of the frequency hops; and
transmitting, based on the plurality of reference signal transmissions, a measurement report.

10. The method of claim 9, wherein the receiving the plurality of reference signal transmissions comprises:
receiving a positioning reference signal (PRS) at a frequency location of a respective one of the frequency hops.

11. The method of claim 9, further comprising:
receiving a hopping configuration indicating information associated with frequency locations of the frequency hops.

12. The method of claim 11, wherein the hopping configuration comprises at least one of:
an indication of a common hop bandwidth for each of the frequency hops;
an index to a lookup table (LUT) having a plurality of entries, each indicating a number of resource blocks in a hop bandwidth of an individual frequency hop based on a respective one of a plurality of subcarrier spacings and a respective one of a plurality of channel bandwidths;
an indication of a number of overlapping resource blocks between adjacent frequency hops of the frequency hops; or
an indication of the number of frequency hops within the bandwidth for positioning.

13. A method for wireless communications, the method comprising:
transmitting a configuration for frequency-hopping outside of an active bandwidth part of a user equipment (UE) of reduced capability (RedCap) UE type, wherein the configuration comprises an indication of a number of frequency hops within a bandwidth for positioning, timing information associated with the frequency hops, and frequency information associated with the frequency hops; and
receiving based on the configuration, a plurality of reference signal transmissions, each at a frequency location and a time location of a respective one of the frequency hops and spanning a frequency less than or equal to the active bandwidth part.

14. The method of claim 13, further comprising:
transmitting an indication of a reference signal resource to be used for the plurality of reference signal transmissions, wherein a frequency span of the reference signal resource spans:
a bandwidth of an individual frequency hop of the frequency hops, or
the bandwidth for positioning.

15. The method of claim 13, wherein the configuration further comprises at least one of:
an indication of a common hop bandwidth for each of the frequency hops;
an index to a lookup table (LUT) having a plurality of entries, each indicating a number of physical resource blocks in a hop bandwidth of an individual frequency hop based on a respective one of a plurality of subcarrier spacings and a respective one of a plurality of channel bandwidths;
an indication of a starting physical resource block for an earliest frequency hop of the frequency hops in time; or
an indication of a number of overlapping resource blocks between adjacent frequency hops of the frequency hops.

16. The method of claim 13, wherein the configuration further comprises an indication of:
a starting slot offset and a starting symbol for an earliest frequency hop of the frequency hops in time; and
a number of orthogonal frequency-division multiplexing (OFDM) symbols for an individual frequency hop of the frequency hops.

17. The method of claim 13, wherein a frequency location of a current frequency hop of the frequency hops is higher than a frequency location of a previous adjacent frequency hop of the frequency hops in time.

18. The method of claim 13, wherein a frequency location of a highest-frequency frequency hop of the frequency hops is adjacent and prior, in time, to a lowest-frequency frequency hop of the frequency hops.

19. The method of claim 13, further comprising:
transmitting a configuration for a time window, wherein a duration of the time window is based on an individual reference signal transmission and the number of frequency hops within the bandwidth for positioning,
wherein the plurality of reference signal transmissions are received within the duration of the time window.

20. The method of claim 13, wherein the receiving the plurality of reference signal transmissions comprises:
receiving a sounding reference signal (SRS) for positioning.
